(19) United States
(12) Patent Application Publication
(10) Pub. No.: US 2026/0186215 A1
(43) Pub. Date: Jul. 2, 2026

(54) PLUG-IN SUBMOUNT ON OPTICAL INTERPOSER

(71) Applicant: POET Technologies, Inc., Petaluma, CA (US)

(72) Inventors: Yong Meng Lee, Petaluma, CA (US); Suresh Venkatesan, Los Gatos, CA (US)

(21) Appl. No.: 19/435,172

(22) Filed: Dec. 29, 2025

Related U.S. Application Data
(60) Provisional application No. 63/739,783, filed on Dec. 30, 2024.
(60) Provisional application No. 63/762,164, filed on Feb. 24, 2025.
(60) Provisional application No. 63/825,083, filed on Jun. 17, 2025.

(51) Int. Cl. G02B 6/42

(52) U.S. Cl. CPC G02B 6/4221

(57) ABSTRACT

An optical interposer assembly includes a plug-in submount and an optical interposer. Steps in the method of forming the optical interposer assembly comprise the forming of a first self-aligned alignment aid and patterned planar waveguide core on the submount, the forming of a second self-aligned alignment aid and patterned planar waveguide core on the optical interposer, the placing of the submount into a cavity receptive to the submount formed on the optical interposer, and the moving of the submount having the first self-aligned alignment aid into contact with the second self-aligned alignment aid of the optical interposer to align the patterned planar waveguide core of the submount with the patterned planar waveguide core of the optical interposer.

### CROSS REFERENCE TO RELATED APPLICATIONS

This application claims the benefit of priority to U.S. Provisional Application No. 63/739,783, entitled, “PLUG-IN SUBMOUNT ON OPTICAL INTERPOSER”, filed Dec. 30, 2024, the entirety of which is incorporated herein by reference. This application also claims the benefit of priority to U.S. Provisional Application No. 63/825,083, entitled, “FIBER MOUNTING COUPLER TO PIC”, filed Jun. 17, 2025, the entirety of which is incorporated herein by reference. This application also claims the benefit of priority to U.S. Provisional Application No. 63/762,164, entitled, “3D Printed Reflector Structure in Cavity”, filed Feb. 24, 2025, the entirety of which is incorporated herein by reference.

This application is related to U.S. Patent Applications having docket numbers, OPE-127, filed Dec. 29, 2025, entitled, “Coupler with v-grooves for interfacing an interposer and optical fibers”, OPE-128, filed Dec. 29, 2025, entitled, “Coupler with FAU for interfacing an interposer and optical fibers”, and OPE-129, filed Dec. 29, 2025, entitled, “Coupler with ferrule for interfacing an interposer and optical fibers”, all of which are hereby incorporated by reference in their entirety.

This application is related to U.S. Patent Applications 63/762,164 filed Feb. 24, 2025, entitled, “3D Printed Reflector Structure in Cavity”; Ser. No. 19/255,852, filed Jun. 30, 2025, entitled, “Self-Aligned Structure and Method on Interposer-based PIC”; Ser. No. 18/659,265, filed May 9, 2024, entitled, “Structures and Assemblies Having a Lens Array”; Ser. No. 17/242580, filed Aug. 5, 2021, entitled, “Loopback Waveguide”, all of which are hereby incorporated by reference in their entirety.

### BACKGROUND

The present invention relates to photonic integrated circuit assemblies and to the methods of formation and use of these assemblies.

Developments in methods of manufacturing of photonic integrated circuits (PICs) have enabled the fabrication and integration of electrical, optoelectrical, and optical devices on the same substrate. In some applications, pre-formed optoelectrical die are integrated within the PICs to provide functionality that may not be easily obtainable with similar devices formed directly on or within the substrate. Semiconductor lasers that emit signals at specific optical wavelengths suited for optical communications, for example, are readily fabricated from gallium arsenide and indium phosphide materials. The fabrication of devices that emit at these telecommunications wavelengths is not practical or achievable using silicon or insulating substrates, and thus requires the integration of prefabricated lasers into PIC mounting structures. The integration of optoelectrical devices, such as lasers into PICs, however, requires precise placement and subsequent alignment after placement of optical and electrical features on the die with optical and electrical features on the mounting substrate. Optical output from an integrated laser die, for example, must align with optical planar waveguides or other optical devices on the substrate to enable effective integration of the laser on the PIC substrate. Coupled with potential variation in the optical power output, wavelength, and stability, among other properties, for example, from the manufacturing of the laser dies, the variations resulting from the integration of a laser die into a photonic circuit assembly can lead to significant variations in the resulting performance of photonic integrated circuit assemblies.

The formation of subassemblies that can be reliably and repeatably assembled to form photonic integrated circuits can enable preliminary testing and characterization of the critical components used in the subassemblies and in the coupling of these critical components to other structures, such as waveguides for example, in the photonic integrated circuit. Pre-testing and pre-characterization of subassemblies prior to integration limits the observed variation to the subassemblies prior to further integration into larger assemblies and thus enables the integration of these characterized subassemblies at reduced risk of loss to underperforming photonic integrated circuit assemblies that include these subassemblies.

Thus, a need in the art exists for structures and methods that enable the formation of subassemblies having optical components that enable the testing and characterization of these subassemblies prior to integration into larger photonic integrated circuit assemblies. Further economic benefits can be achieved with the use of wafer level processing and methods that utilize passive alignment structures and techniques.

### BRIEF DESCRIPTION OF THE FIGURES

FIG. 1A shows a top view schematic drawing of an embodiment of a submount assembly comprising a submount and an optical device mounted on the submount.

FIG. 1B shows a top view schematic drawing of an embodiment of an optical interposer having a cavity receptive to the submount of FIG. 1A.

FIG. 1C shows a top view schematic drawing of an embodiment of an optical interposer assembly comprising the submount of FIG. 1A and the optical interposer of FIG. 1B.

FIG. 1D shows Section A-A′ of the embodiment of the optical interposer assembly shown in FIG. 1C.

FIG. 1E shows Section B-B′ of the embodiment of the optical interposer assembly shown in FIG. 1C.

FIG. 1F shows a flowchart for a method of formation of embodiments of an optical interposer assembly comprising a submount having an alignment aid and a patterned planar waveguide core and an optical interposer having an alignment aid and a patterned planar waveguide core wherein the lateral distance between the alignment aid and the patterned planar waveguide core on the submount is the same as the lateral distance between the alignment aid and the patterned planar waveguide core on the optical interposer.

FIG. 1G shows a portion of an embodiment of an exploded top view of an optical interposer assembly wherein the contact points a & b of the lateral alignment aid on the submount are shown in contact with corresponding contact points a′ & b′ of the lateral alignment aid on the optical interposer.

FIG. 1H shows a portion of an embodiment of an exploded top view of an optical interposer assembly wherein the contact points a and b of a first lateral alignment aid on the submount are shown in contact with corresponding contact points a′ and b′ of the first lateral alignment aid on the optical interposer and wherein the contact points c and d of a second lateral alignment aid on the submount are shown in contact with corresponding contact points c′ and d′ of the second lateral alignment aid on the optical interposer.

FIG. 1I shows a portion of an embodiment of an exploded top view of an optical interposer assembly wherein the contact point b of a first lateral alignment aid on the submount is shown in contact with contact point b′ of a first lateral alignment aid on the optical interposer and a contact point c of a second lateral alignment aid on the submount is shown in contact with contact point c′ of the second lateral alignment aid on the optical interposer.

FIG. 1J shows a schematic cross-sectional view of a submount prior to positioning into cavity 150 of optical interposer 101 as in step 178-2 of method 178.

FIG. 1K a schematic cross-sectional view of a submount assembly as in step 178-3 of method 178.

FIG. 1L shows a top view of the optical interposer assembly of FIG. 1H wherein the contact points a, b, c, and d of the submount are in contact with the contact points a′, b′, c′, and d′ of the optical interposer at locations A, B, C, and D, respectively.

FIG. 2A shows a flowchart for a method of formation of embodiments of an optical interposer assembly comprising a submount assembly and an optical interposer wherein a patterned planar waveguide core of the submount is aligned with a patterned planar waveguide core of the optical interposer using tongue and groove lateral alignment features.

FIG. 2B shows a flowchart for a method of formation of embodiments of a submount assembly having a submount and a mounted device wherein the method of formation further includes a measurement step.

FIG. 2C shows a flowchart for a method of formation of an optical interposer having alignment features formed self-aligned with a patterned planar waveguide core of the optical interposer.

FIG. 3A shows a schematic perspective drawing of an optical device wafer comprising a plurality of optical devices.

FIG. 3B shows a schematic perspective drawing of a submount wafer comprising a plurality of submounts.

FIG. 3C shows a schematic perspective drawing of an optical interposer wafer comprising a plurality of optical interposers.

FIG. 3D shows a schematic perspective drawing of the submount wafer of FIG. 3B after mounting of optical devices from the optical device wafer of FIG. 3A into device mounting cavities of the plurality of submounts.

FIG. 3E shows a schematic perspective drawing of the optical interposer wafer of FIG. 3C after mounting of the submounts from the submount wafer of FIG. 3D into cavities of the plurality of optical interposers.

FIG. 4A shows a top view schematic drawing of a portion of a submount wafer as shown, for example, in FIG. 3B comprising a submount and further comprising an upturned mirror structure wherein the portion of the submount wafer further shows singulation trenches that may be used to singulate the submount wafer.

FIG. 4B shows a top view schematic drawing of the submount shown in FIG. 4A after singulation and isolation wherein the submount comprises self-aligned features that include a patterned planar waveguide core, alignment pillars formed in a device mounting cavity, fiducials, and tongue-shaped lateral alignment aids that form a portion of a tongue and groove lateral alignment feature.

FIG. 5A shows a summary view of a flowchart for a method of forming an embodiment of a submount having tongue-shaped lateral alignment aids formed self-aligned with a patterned planar waveguide core and further having self-aligned alignment pillars formed in the device mounting cavity.

FIG. 5B shows an expanded flowchart for a method of forming an embodiment of a submount having tongue-shaped lateral alignment aids formed self-aligned with a patterned planar waveguide core and further having self-aligned alignment pillars formed in the device mounting cavity.

FIG. 6A1-6J1 show a sequence of cross-sectional drawings from Section A-A′ of the embodiment of the submount shown in FIG. 4A that illustrate steps in the formation of embodiments of the submount having self-aligned features comprising a patterned planar waveguide, alignment pillars formed in the cavity, fiducials, and tongue-shaped lateral alignment aids that form a first portion of a tongue and groove lateral alignment feature (singulation trenches of FIG. 4A are not shown).

FIG. 6A2-6J2 show a sequence of cross-sectional drawings from Section B-B′ of the embodiment of the submount shown in FIG. 4A that illustrate steps in the formation of embodiments of the submount having self-aligned features comprising a patterned planar waveguide, alignment pillars formed in the cavity, fiducials, and tongue-shaped lateral alignment aids that form a first portion of a tongue and groove lateral alignment feature (singulation trenches of FIG. 4A are not shown).

FIG. 7A shows a flowchart for a method of forming embodiments of submount assemblies as shown, for example, in FIG. 6J1 and 6J2, wherein one or more of one or more of an electrical and an optical property of one or more of the submount assemblies of the plurality of submount assemblies on the submount wafer is measured prior to singulation of the submount wafer.

FIG. 7B shows a flowchart for another method of forming embodiments of a submount assembly as shown, for example, in FIG. 6J1 and 6J2, wherein the optical device of the submount assembly is a laser device, and one or more of one or more of an electrical and an optical property of the submount assembly is measured in the process of forming the submount assembly.

FIG. 8A1 shows the cross-sectional schematic drawings from Section A-A′ of FIG. 4A that shows an embodiment of a submount assembly comprising the submount of FIG. 4A and an optical device.

FIG. 8A2 shows the cross-sectional schematic drawings from Section B-B′ of FIG. 4A that shows an embodiment of a submount assembly comprising the submount of FIG. 4A and an optical device mounted in the optical device mounting cavity of the submount, wherein the path of an example optical signal is shown from the optical device mounted in the cavity, through the patterned planar waveguide core of the submount, and further incident on the upturned mirror in the embodiment is shown.

FIG. 9 shows a flowchart for a method of forming an embodiment of a submount having backside alignment features.

FIG. 10A1-10B1 show cross-section schematic drawings that illustrate some steps in the formation of an embodiment of a submount having backside alignment features wherein the cross-sections correspond to Section A-A′ of FIG. 4A prior to the formation of the singulation trenches.

FIG. 10A2-10B2 show cross-section schematic drawings that illustrate some steps in the formation of an embodiment of a submount having backside alignment features wherein the cross-sections correspond to Section B-B′ of FIG. 4A prior to the formation of the singulation trenches.

FIG. 11A shows a top view schematic drawing of an embodiment of a submount assembly wherein the submount of the submount assembly is configured having backside alignment slot features that are complementary to the alignment rail features of the cavity formed in the optical interposer shown in FIG. 11B.

FIG. 11B shows a top view schematic drawing of an embodiment of an optical interposer receptive to the embodiment of the submount of the submount assembly shown in FIG. 11A.

FIG. 12 shows a flowchart for a method of forming embodiments of an optical interposer receptive to the embodiment of the submount shown in FIG. 11A.

FIG. 13A1-13E1 show a sequence of cross-sectional drawings that illustrate steps in the formation of an embodiment of the optical interposer of FIG. 11B receptive to the embodiment of the submount of the submount assembly shown in FIG. 11A wherein the sequence of cross-sectional drawings corresponds to Section A-A′ of FIG. 11B.

FIG. 13A2-13E2 show a sequence of cross-sectional drawings that illustrate steps in the formation of an embodiment of an optical interposer of FIG. 11B receptive to the embodiment of the submount of the submount assembly shown in FIG. 11A wherein the sequence of cross-sectional drawings corresponds to Section B-B′ of FIG. 11B.

FIG. 14A shows a flowchart for the formation of a laser device wafer comprising a plurality of laser devices, a submount wafer comprising a plurality of submounts, and an optical interposer wafer comprising a plurality of optical interposers.

FIG. 14B shows a flowchart for the formation of some embodiments of an optical interposer assembly on an optical interposer wafer comprising an optical interposer and a submount assembly wherein the submount assembly further comprises a submount and a mounted device, and wherein at least an optical or electrical characteristic of the submount assembly is measured prior to mounting of the submount assembly onto the optical interposer.

FIG. 15 shows a flowchart for a method of formation of a plurality of optical interposer assemblies on an optical interposer wafer.

FIG. 16A shows a top view schematic drawing of an embodiment of an optical interposer assembly comprising an optical interposer and a submount assembly.

FIG. 16B shows a cross-sectional schematic drawing through Section A-A′ of FIG. 16A.

FIG. 16C shows a cross-sectional schematic drawing through Section B-B′ of FIG. 16A.

FIG. 17 shows a top view schematic drawing of an embodiment of an optical interposer assembly comprising an optical interposer and a submount assembly wherein the submount assembly further comprises a submount and a plurality of mounted devices.

FIG. 18 shows a top view schematic drawing of an embodiment of an optical interposer assembly comprising an optical interposer and a plurality of submount assemblies wherein each of the submount assemblies further comprises a submount and a mounted device.

FIG. 19 shows a top view schematic drawing of an embodiment of an optical interposer assembly comprising an optical interposer and a plurality of submount assemblies wherein each of the submount assemblies further comprises a submount and a plurality of optical devices.

FIG. 20A shows a top view schematic drawing of an embodiment of a submount assembly comprising a submount and an optical device and further comprising a driver, a spot size converter, a lens, and an isolator.

FIG. 20B shows a top view schematic drawing of an embodiment of a submount assembly comprising a submount and an optical device wherein the optical device is coupled to a patterned planar waveguide core on the submount using a photonic wirebond.

FIG. 21 shows a portion of an embodiment of a submount wafer after formation of the singulation trenches wherein the submount is configured having an upturned mirror and wherein the upturned mirror is configured to test a neighboring submount assembly.

FIG. 22A shows a portion of an embodiment of an optical interposer assembly having differently shaped first and second portions of the tongue and groove lateral alignment features wherein the leading curved first portion of the tongue-shaped lateral alignment aid of the submount forms a single point of contact with the linear edge of the second portion of the tongue and groove lateral alignment feature in the cavity of the optical interposer.

FIG. 22B shows a portion of an embodiment of an optical interposer assembly having differently shaped first and second portions of the tongue and groove lateral alignment features wherein the first portion of the tongue and groove-shaped lateral alignment aid on the submount is a groove-shaped lateral alignment aid and the second portion of the tongue and groove-shaped lateral alignment aid in the cavity of the optical interposer is a tongue-shaped lateral alignment aid.

FIG. 22C shows a portion of another embodiment of an optical interposer assembly having differently shaped first and second portions of the tongue and groove lateral alignment features wherein one first portion of the tongue and groove-shaped lateral alignment aid on the submount is a tongue-shaped lateral alignment aid and the second portion of the tongue and groove-shaped lateral alignment aid in the cavity of the optical interposer is a groove-shaped lateral alignment aid and wherein one first portion of the tongue and groove-shaped lateral alignment aid on the submount is a groove-shaped lateral alignment aid and the second portion of the tongue and groove-shaped lateral alignment aid in the cavity of the optical interposer is a tongue-shaped lateral alignment aid.

FIGS. 23A and 23B show portions of an embodiment of an optical interposer assembly having similarly shaped first and second portions of the tongue and groove lateral alignment features.

FIGS. 23C and 23D show portions of an embodiment of an optical interposer assembly having similarly shaped first and second portions of the tongue and groove lateral alignment features wherein the contacting area of the first portion is reduced in comparison to the embodiments shown in FIGS. 23A and 23B.

FIGS. 24A-24D show portions of an embodiment of a submount having a tongue-shaped lateral alignment aid formed self-aligned with a patterned planar waveguide core on the submount.

FIG. 24A shows a portion of an embodiment of a submount having a tongue-shaped lateral alignment aid configured having two contact points.

FIG. 24B shows a portion of an embodiment of a submount having a tongue-shaped lateral alignment aid configured having two straight-line contacting edges.

FIG. 24C shows a portion of an embodiment of a submount having a tongue-shaped lateral alignment aid configured having two curved line contacting edges.

FIG. 24D shows a portion of another embodiment of a submount having a tongue-shaped lateral alignment aid configured having two curved line contacting edges.

FIGS. 25A-25D show portions of an embodiment of an optical interposer having a groove-shaped lateral alignment aid formed self-aligned with a patterned planar waveguide core on the optical interposer.

FIG. 25A shows a portion of an embodiment of an optical interposer having a groove-shaped lateral alignment aid configured having two contact points.

FIG. 25B shows a portion of an embodiment of an optical interposer having a groove-shaped lateral alignment aid configured having two straight-line contacting edges.

FIG. 25C shows a portion of an embodiment of an optical interposer having a groove-shaped lateral alignment aid configured having two curved line contacting edges.

FIG. 25D shows a portion of an embodiment of an optical interposer having a groove-shaped lateral alignment aid configured having two curved line contacting edges.

FIGS. 26A-26B show portions of an embodiment of a submount having tongue-shaped lateral alignment aids configured having two contacting point wherein the tongue-shaped lateral alignment aids are formed self-aligned with a patterned planar waveguide core on the submount.

FIG. 26C shows a portion of an embodiment of an optical interposer assembly comprising a submount and an optical interposer wherein the tongue-shaped lateral alignment aid on the submount is configured having two contacting points and the groove-shaped lateral alignment aid on the optical interposer is configured having two straight-line contacting edges.

FIG. 26D shows a portion of an embodiment of an optical interposer assembly comprising a submount and an optical interposer wherein the tongue-shaped lateral alignment aid on the submount is configured having two contacting points and the groove-shaped lateral alignment aid on the optical interposer is configured having two curved-line contacting edges.

FIG. 26E shows a portion of another embodiment of an optical interposer assembly comprising a submount and an optical interposer wherein the tongue-shaped lateral alignment aid on the submount is configured having two contacting points and the groove-shaped lateral alignment aid on the optical interposer is configured having two curved-line contacting edges.

FIGS. 27A-27B show portions of an embodiment of an optical interposer having groove-shaped lateral alignment aids configured having two contacting points wherein the groove-shaped lateral alignment aids are formed self-aligned with a patterned planar waveguide core on the optical interposer.

FIG. 27C shows a portion of an embodiment of an optical interposer assembly comprising a submount and an optical interposer wherein the groove-shaped lateral alignment aid on the optical interposer is configured having two contacting points and the tongue-shaped lateral alignment aid on the submount is configured having two contacting straight-line edges.

FIG. 27D shows a portion of an embodiment of an optical interposer assembly comprising a submount and an optical interposer wherein the groove-shaped lateral alignment aid on the optical interposer is configured having two contacting points and the tongue-shaped lateral alignment aid on the submount is configured having two contacting curved-line edges.

FIG. 27E shows a portion of another embodiment of an optical interposer assembly comprising a submount and an optical interposer wherein the groove-shaped lateral alignment aid on the optical interposer is configured having two contacting points and the tongue-shaped lateral alignment aid on the submount is configured having two curved-line contacting edges.

FIGS. 28A-28B show portions of an embodiment of a submount having tongue-shaped lateral alignment aids configured having two straight-line contacting edges wherein the tongue-shaped lateral alignment aids are formed self-aligned with a patterned planar waveguide core on the submount.

FIG. 28C shows a portion of an embodiment of an optical interposer assembly comprising a submount and an optical interposer wherein the tongue-shaped lateral alignment aid on the submount is configured having two straight-line contacting edges and the groove-shaped lateral alignment aid on the optical interposer is configured having two contacting points.

FIG. 28D shows a portion of an embodiment of an optical interposer assembly comprising a submount and an optical interposer wherein the tongue-shaped lateral alignment aid on the submount is configured having two straight-line contacting edges and the groove-shaped lateral alignment aid on the optical interposer is configured having two straight-line contacting edges.

FIG. 28E shows a portion of an embodiment of an optical interposer assembly comprising a submount and an optical interposer wherein the tongue-shaped lateral alignment aid on the submount is configured having two straight-line contacting edges and the groove-shaped lateral alignment aid on the optical interposer is configured having two curved-line contacting edges.

FIGS. 29A-29B show portions of an embodiment of an optical interposer having groove-shaped lateral alignment aids configured having two straight-line contacting edges wherein the groove-shaped lateral alignment aids are formed self-aligned with a patterned planar waveguide core on the optical interposer.

FIG. 29C shows a portion of an embodiment of an optical interposer assembly comprising a submount and an optical interposer wherein the groove-shaped lateral alignment aid on the optical interposer is configured having two straight-line contacting edges and the tongue-shaped lateral alignment aid on the submount is configured having two contacting points.

FIG. 29D shows a portion of an embodiment of an optical interposer assembly comprising a submount and an optical interposer wherein the groove-shaped lateral alignment aid on the optical interposer is configured having two straight-line contacting edges and the tongue-shaped lateral alignment aid on the submount is configured having two straight-line contacting edges.

FIG. 29E shows a portion of an embodiment of an optical interposer assembly comprising a submount and an optical interposer wherein the groove-shaped lateral alignment aid on the optical interposer is configured having two straight-line contacting edges and the tongue-shaped lateral alignment aid on the submount is configured having two curved-line contacting edges.

FIGS. 30A-30B show portions of an embodiment of a submount having tongue-shaped lateral alignment aids configured having two curved line edges wherein the tongue-shaped lateral alignment aids are formed self-aligned with a patterned planar waveguide core on the submount.

FIG. 30C shows a portion of an embodiment of an optical interposer assembly comprising a submount and an optical interposer wherein the tongue-shaped lateral alignment aid on the submount is configured having two curved-line contacting edges and the groove-shaped lateral alignment aid on the optical interposer is configured having two contacting points.

FIG. 30D shows a portion of an embodiment of an optical interposer assembly comprising a submount and an optical interposer wherein the tongue-shaped lateral alignment aid on the submount is configured having two curved-line contacting edges and the groove-shaped lateral alignment aid on the optical interposer is configured having two contacting straight-line edges.

FIG. 30E shows a portion of an embodiment of an optical interposer assembly comprising a submount and an optical interposer wherein the tongue-shaped lateral alignment aid on the submount is configured having two curved-line contacting edges and the groove-shaped lateral alignment aid on the optical interposer is configured having two contacting curved-line edges.

FIG. 30F shows a portion of another embodiment of an optical interposer assembly comprising a submount and an optical interposer wherein the tongue-shaped lateral alignment aid on the submount is configured having two curved-line contacting edges and the groove-shaped lateral alignment aid on the optical interposer is configured having two contacting curved-line edges.

FIGS. 31A-31B show portions of an embodiment of an optical interposer having groove-shaped lateral alignment aids configured having two-curved line edges wherein the groove-shaped lateral alignment aids are formed self-aligned with a patterned planar waveguide core on the optical interposer.

FIG. 31C shows a portion of an embodiment of an optical interposer assembly comprising a submount and an optical interposer wherein the groove-shaped lateral alignment aid on the optical interposer is configured having two curved-line contacting edges and the tongue-shaped lateral alignment aid on the submount is configured having two contacting points.

FIG. 31D shows a portion of an embodiment of an optical interposer assembly comprising a submount and an optical interposer wherein the groove-shaped lateral alignment aid on the optical interposer is configured having two curved-line contacting edges and the tongue-shaped lateral alignment aid on the submount is configured having two contacting curved-line edges.

FIGS. 32A-32B show portions of an embodiment of a submount having tongue-shaped lateral alignment aids configured having two curved line edges wherein the tongue-shaped lateral alignment aids are formed self-aligned with a patterned planar waveguide core on the submount.

FIG. 32C shows a portion of an embodiment of an optical interposer assembly comprising a submount and an optical interposer wherein the tongue-shaped lateral alignment aid on the submount is configured having two curved-line contacting edges and the groove-shaped lateral alignment aid on the optical interposer is configured having two contacting points.

FIG. 32D shows a portion of an embodiment of an optical interposer assembly comprising a submount and an optical interposer wherein the tongue-shaped lateral alignment aid on the submount is configured having two curved-line contacting edges and the groove-shaped lateral alignment aid on the optical interposer is configured having two curved-line contacting edges.

FIGS. 33A-33B show portions of another embodiment of an optical interposer having groove-shaped lateral alignment aids configured having two-curved line edges wherein the groove-shaped lateral alignment aids are formed self-aligned with a patterned planar waveguide core on the optical interposer.

FIG. 33C shows a portion of an embodiment of an optical interposer assembly comprising a submount and an optical interposer wherein the groove-shaped lateral alignment aid on the optical interposer is configured having two curved-line contacting edges and the tongue-shaped lateral alignment aid on the submount is configured having two contacting points.

FIG. 33D shows a portion of an embodiment of an optical interposer assembly comprising a submount and an optical interposer wherein the groove-shaped lateral alignment aid on the optical interposer is configured having two curved-line contacting edges and the tongue-shaped lateral alignment aid on the submount is configured having two straight-line contacting edges.

FIG. 33E shows a portion of an embodiment of an optical interposer assembly comprising a submount and an optical interposer wherein the groove-shaped lateral alignment aid on the optical interposer is configured having two curved-line contacting edges and the tongue-shaped lateral alignment aid on the submount is configured having two curved-line contacting edges.

FIG. 33E shows a portion of another embodiment of an optical interposer assembly comprising a submount and an optical interposer wherein the groove-shaped lateral alignment aid on the optical interposer is configured having two curved-line contacting edges and the tongue-shaped lateral alignment aid on the submount is configured having two contacting curved-line edges.

FIG. 34 shows an embodiment of an optical interposer assembly comprising a submount and an optical interposer wherein an etch stop layer is provided in the film structure.

Other aspects and features of embodiments will become apparent to those skilled in the art upon review of the following detailed description in conjunction with the accompanying figures.

### DETAILED DESCRIPTION OF EMBODIMENTS

Embodiments disclosed herein pertain to the formation of photonic integrated circuit assemblies comprising planar waveguides coupled to one or more mounted or otherwise integrated optical devices.

In an embodiment of an optical interposer assembly, a first portion of a photonic integrated circuit assembly comprises a submount assembly wherein the submount assembly further comprises a submount and an optical device mounted in a cavity formed in the submount. The submount in this first portion of the photonic integrated circuit assembly comprises a patterned planar waveguide, the cavity configured for mounting the optical device, and a first portion of a tongue and groove lateral alignment feature. In the embodiment, a second portion of the photonic integrated circuit assembly comprises an optical interposer. The optical interposer in this second portion of the photonic integrated circuit further comprises a patterned planar waveguide and a cavity receptive to the submount of the first portion of the photonic integrated circuit assembly, wherein the cavity intersects the patterned planar waveguide and wherein a second portion of a tongue and groove lateral alignment feature is formed in the wall of the cavity in the optical interposer. An optical interposer, as described herein, is an interposer structure comprising a planar waveguide layer formed on a base structure wherein the base structure further comprises an optional electrical interconnect layer formed on a substrate.

In embodiments of the optical interposer assembly disclosed herein, the patterned planar waveguide core of the patterned planar waveguide formed on the submount and the first portion of the mating lateral alignment aid pair formed on the submount are formed self-aligned using a same patterned mask layer with one or more optional fiducial and one or more optional alignment features formed in the cavity of the submount.

In embodiments of the optical interposer assembly disclosed herein, the patterned planar waveguide core of the patterned planar waveguide formed on the optical interposer and the second portion of the mating lateral alignment aid pair formed on the optical interposer are formed self-aligned using a same patterned mask layer with one or more optional fiducial. Other alignment features may also be optionally formed on the optical interposer using the same patterned mask layer.

In forming the optical interposer assembly, the first portion of the mating lateral alignment aid pair on the submount having the first portion of the photonic integrated circuit assembly, and the second portion of the mating lateral alignment aid pair on the optical interposer having the second portion of the photonic integrated circuit assembly, are brought into contact to align the self-aligned patterned planar waveguide core of the submount with the self-aligned patterned planar waveguide core of the optical interposer.

In embodiments of the optical interposer assembly, the submount assembly comprising an optical device and a submount, one or more of one or more of an optical and electrical property of the submount assembly may be measured to evaluate the performance of the submount assembly. Evaluation of the performance of a submount assembly may enable, for example, the selection of the submount assemblies from a plurality of measured submount assemblies for use in forming optical interposer assemblies having specific properties. The performance of submount assemblies may, in some embodiments, be dependent on the properties of an optical device mounted on the submount and may be dependent on the coupling efficiency, for example, between the optical device mounted on the submount and a planar waveguide formed on the submount. Use of measurable submount assemblies enables the prequalification of submount assemblies and enables a measurement of the performance of the subassembly comprising the submount and the optical device mounted on the submount prior to combining the first portion of the photonic integrated circuit with the second portion of the photonic integrated circuit to form the optical interposer assembly. Use of the first portion of the mating lateral alignment aid pair, formed self-aligned with the patterned planar waveguide core of the submount, and the second portion of the mating lateral alignment aid pair, formed self-aligned with the patterned planar waveguide core of the optical interposer enables the alignment of the patterned planar waveguide core of the submount with the patterned planar waveguide core of the optical interposer in forming the optical interposer assembly.

Described herein are embodiments of the submount assembly comprising the first portion of the mating lateral alignment aid pair on the submount and the methods of forming the first portion of the mating lateral alignment aid pair on the submount in self-alignment with the patterned planar waveguide core of the submount. Optionally, the first portion of the mating lateral alignment aid pair on the submount and the patterned planar waveguide core of the submount may further be formed in self-alignment with one or more fiducial, one or more lateral alignment pillar formed in the cavity on the submount, and one or more lateral alignment aids formed on the submount.

Also, described herein are embodiments of the optical interposer assembly comprising the second portion of the mating lateral alignment aid pair in the cavity of the optical interposer and the methods of forming the second portion of the mating lateral alignment aid pair on the optical interposer in self-alignment with the patterned planar waveguide core of the optical interposer. Optionally, the second portion of the mating lateral alignment aid pair on the optical interposer and the patterned planar waveguide core of the optical interposer may further be formed in self-alignment with one or more fiducial and one or more lateral alignment aids formed on the optical interposer.

Embodiments are disclosed herein that pertain to optical interposer structures and assemblies, and methods of formation of these structures and assemblies wherein the structures comprise alignment features formed from all or a portion of a planar waveguide layer in self-alignment with patterned planar waveguide cores formed from the same planar waveguide layer. In methods disclosed herein, the alignment features and the patterned planar waveguide cores are formed using a single lithographic patterned mask layer that is maintained throughout the process of formation of embodiments.

Alignment is achieved in embodiments, with the formation of lateral alignment pillars that are formed using a same lithographic and patterning process that is used to pattern one or more patterned planar waveguide cores of a submount or an optical interposer structure that may be used, for example, in the formation of optical assemblies and photonic integrated circuits. Upon patterning of the alignment pillars and patterned planar waveguide cores, the patterned mask layer used in the patterning is removed from the patterned planar waveguide cores, but not removed from the lateral alignment aids and features. The still-patterned alignment aids and mask-free patterned planar waveguide cores are then buried in a dielectric layer allowing completion of the upper layers of the planar waveguide layer including an upper cladding layer. Lateral registration of the alignment pillars is enabled with the use of the same patterned mask layer. Laterally aligned alignment pillars may optionally be used for vertical alignment of mounted device in addition to the lateral alignment of mounted devices.

In embodiments, a patterned mask layer formed on the planar waveguide layer, coupled with a suitable etch process, enables the formation of cavities in the planar waveguide layer within which the already patterned mask layer buried within the dielectric layer is re-exposed to enable the formation of the alignment pillars in self-alignment with the patterned planar waveguide cores. The patterned mask layer used in the formation of the cavities is positioned on the planar waveguide layer, in embodiments, such that upon formation, a wall of the cavity intersects a patterned planar waveguide core enabling the coupling of optical signals between the patterned planar waveguide core and an optical device mounted on the alignment pillars within the cavity.

Self-alignment, in general, refers to a technique used in semiconductor processing wherein a feature of a device is used as a mask to define another feature, ensuring precise alignment between the feature used as the mask and the other feature. Self-alignment, as used herein, refers to the use of a single patterned mask layer in the patterning of two or more patterned features in a lithography process that is then used in a subsequent etch or patterning process to define the collection of alignment features. A single patterned mask layer is used in embodiments, to pattern a collection of features that includes fiducials, lateral alignment aids, alignment pillars, and patterned planar waveguide cores for which the lithographic registration in alignment of the collection is maintained throughout the fabrication process. Methods of maintaining the lithographic registration in subsequent patterning steps are disclosed herein in the embodiments.

Alignment features include lateral reference structures that facilitate the registration and alignment of optical structures formed from the planar waveguide layer of an optical interposer structure and to the alignment of optical devices and components that are mounted onto the submount or optical interposer. Such alignment features provide improvements in the manufacturability of photonic integrated circuits (PICs) that use mounted optical components and that require alignment with the patterned planar waveguide cores on an optical interposer structure that includes a planar waveguide layer. In some embodiments, alignment pillars formed in a cavity in self-alignment with patterned planar waveguide cores facilitate vertical and lateral alignment of the optical axis of an optical device placed in the cavity with the optical axis of the patterned planar waveguide cores intersecting a cavity wall. Optical devices may be, in embodiments, emitting devices, receiving devices, waveguides, and transforming devices, for example, among other devices.

In embodiments, an optical interposer structure comprises a planar waveguide layer formed on a base structure, wherein the base structure further comprises an electrical interconnect layer formed on a substrate. The planar waveguide layer is a layer comprising one or more patterned planar waveguide cores, and one or more of a top, side, and bottom cladding layer surrounding the patterned planar waveguide cores, and may further comprise one or more other layers including one or more spacer layers, patterned mask layers, buffer layers, and planarization layers, for example, among other layers. The core layer in some embodiments, is a single waveguide layer. In other embodiments, the core layer may be a layered structure of one or more layers that together form a core layer.

In some embodiments, the alignment features formed in one or more cavities include fiducials and alignment pillars wherein the alignment pillars may be one or more of lateral alignment pillars and vertical alignment pillars formed in self-alignment with one or more patterned planar waveguide cores of a submount. Fiducials, formed self-aligned with the alignment pillars, facilitate accurate placement of mountable devices onto the alignment pillars, for example, using automated pick-and-place apparatus. These fiducials are formed in the cavities with the alignment pillars and have the same depth of focus to facilitate high accuracy positioning and placement. Precise lateral registration between features is achieved, in embodiments, using a methodology in which a same patterned mask layer is used to pattern all features requiring alignment. The subsequent burial and re-exposure of the patterned mask layer in subsequent processing steps ensures that the precise feature registration provided by the use of the same patterned mask layer is maintained throughout the formation of the submount and the alignment structures provided thereon. The precise lateral registration provided in embodiments is in contrast to methodologies that utilize multiple masking layers in multilayer structures that require re-registration at each masking layer. Multiple masking layers can lead to significant registration error in overlapped patterns that can lead to the formation of defects and to the creation of excessive variation in the relative alignment of patterns formed on successive layers. The requirement for multilevel registration is eliminated in critical patterning layers within the multilayer planar waveguide layer in embodiments of structures, assemblies, and methods disclosed herein.

Various embodiments are described herein with reference to the accompanying drawings that are intended to convey the scope of the invention to those skilled in the art. Accordingly, features and components described in the examples of embodiments described herein may be combined with features and components of other embodiments. The present invention is not limited to the relative sizes and spacings illustrated in the accompanying figures. It should be understood that a “layer” as referenced herein may include a single material layer or a plurality of layers. For example, an “insulating layer” may include a single layer of a specific dielectric material such as silicon dioxide, or may include a plurality of layers such as one or more layers of silicon dioxide and one or more other layers such as silicon nitride, aluminum nitride, among others. The term “insulating layer” in this example, refers to the functional characteristic layer provided for the purpose of providing the insulation property, and is not limited as such to a single layer of a specific material. Similarly, an electrical interconnect layer, as used herein, refers to a composite layer that includes both the electrically conductive materials for transmitting electrical signals and the intermetal and other layers required to insulate the electrically conductive materials. An electrical interconnect layer, as described herein may therefore include a patterned layer of electrically conducting material such as copper or aluminum as well as the intermetal dielectric material such as silicon dioxide, and spacer layers above and below the electrically conductive materials, for example, among other layers. Additionally, references herein to a layer formed “on” a substrate or other layer may refer to the layer formed directly on the substrate or other layer or on an intervening layer or layers formed on the substrate or other layer. References to the term “optical” devices, as used herein, may refer to a purely optical device such as a waveguide that does not have an electrical feature and to an optoelectrical device that has both an optical feature and an electrical feature, unless specified otherwise. An optical device, as used herein, is a device such as a waveguide, an arrayed waveguide, a spot size converter, a lens, a grating, among others, and an optoelectrical device is a device such as a laser or a photodetector that includes an optical feature and an electrical feature. In embodiments described herein, the use of the term “optical device” may include both optical devices and optoelectrical devices particularly in the context of the alignment of optical features of optical die that pertains to devices with or without an electrical feature. The term “die”, as used herein, refers to a substrate containing one or more devices. The term “optical die”, as used herein, refers to a substrate containing one or more optical devices.

The acronym “WG”, as used herein, refers to “waveguide”. The acronym “PWG”, as used herein, refers to “planar waveguide”. The acronym “PIC”, as used herein, refers to “photonic integrated circuit”. Other acronyms may also be used as noted herein.

Embodiments of assemblies disclosed herein may be used in the formation of PICs and thus the term “PIC” may be used interchangeably with “assembly” in reference to assemblies that utilize embodiments disclosed herein.

In some embodiments, the present invention discloses self-alignment features for aligning an interposer, e.g., a first substrate or first component, with a submount, e.g., a second substrate or second component. The self-alignment features include a first alignment feature formed on the interposer and a second alignment feature formed on the submount. The self-alignment features are characterized by that when the first and second alignment features are aligned, first and second waveguides carrying optical signals in the interposer and the submount, respectively, are automatically aligned. An advantage of the self-alignment features is the ease of alignment, since the self-alignment features can be designed for easy alignment, especially in comparison with the alignment of the first and second waveguides.

In theory, to accomplish the self-alignment objective, a first distance or a first orientation between the first alignment feature and the first waveguide in the interposer is exactly related to a second distance or a second orientation between the second alignment feature and the second waveguide in the submount. The relationship between the first and second distances or orientations is defined in the design of the interposer and the submount. For example, the first and second waveguides can be separated at a same distance from the first and second alignment features in the interposer and the submount, respectively. The first and second waveguides can also be oriented at a same orientation of 90 degrees with respect to the first and second alignment features in the interposer and the submount, e.g., the first and second waveguides are perpendicular to the first and second alignment features with the same separation distances, respectively.

In practice, the distances and orientations have variations or deviations from a design specification.

In some embodiments, the present invention discloses the self-alignment features with low variations or deviations by patterning the alignment feature and the waveguide at a same time using a same mask. As such, the variations or deviations have a lithography accuracy, e.g., the distance and orientation between an alignment feature and a waveguide, e.g., in an interposer or in a submount, has an accuracy defined by the lithography process, which can be equal or less than 200 nm, equal or less than 100 nm, equal or less than 80 nm, equal or less than 60 nm, equal or less than 40 nm, or equal or less than 20 nm.

In some embodiments, a first distance or a first orientation between a first alignment aid and a first waveguide in an interposer can be within a difference to a design value of equal or less than 200 nm, equal or less than 100 nm, equal or less than 80 nm, equal or less than 60 nm, equal or less than 40 nm, or equal or less than 20 nm.

A second distance or a second orientation between a second alignment aid and a second waveguide in a submount can be within a difference to a design value of equal or less than 200 nm, equal or less than 100 nm, equal or less than 80 nm, equal or less than 60 nm, equal or less than 40 nm, or equal or less than 20 nm.

A difference between the first and second distances or the first and second orientations can be within a difference to a design value of equal or less than 200 nm, equal or less than 100 nm, equal or less than 80 nm, equal or less than 60 nm, equal or less than 40 nm, or equal or less than 20 nm.

In some embodiments, the alignment feature can be characterized by a contact point on the alignment feature. Thus, a distance or an orientation between an alignment aid and a waveguide can be interpreted as a distance or an orientation between a contact point on an alignment aid and a waveguide.

In some embodiments, the waveguide can be characterized by a core of the waveguide, a position or a point on the waveguide, a position or a point on the core of the waveguide, a facet of the waveguide, a position or a point on the facet of the waveguide.

In some embodiments, the waveguide can be characterized by a direction of an optical signal, such as the optical direction of the optical signal in the waveguide or in the waveguide core. With a waveguide, the optical direction can be the direction of the waveguide or can be the waveguide. Without a waveguide, the optical direction can be the direction of the optical signal, such as the optical direction in the free space with the optical signal generated from a laser, for example.

Thus, a distance or an orientation between an alignment aid and a waveguide can be interpreted as a distance or an orientation between a contact point on an alignment aid and a core of the waveguide, a position or a point on the waveguide, a position or a point on the core of the waveguide, a facet of the waveguide, a position or a point on the facet of the waveguide, or an optical direction of an optical signal.

In some embodiments, the present invention discloses the self-alignment features with an alignment accuracy of low optical loss between the first and second waveguides by patterning the alignment feature and the waveguide at a same time using a same mask. As such, the alignment accuracy value can be defined or characterized by an optical loss of equal or less than 20%, equal or less than 15%, equal or less than 10%, equal or less than 5%, equal or less than 3%, equal or less than 2%, equal or less than 1%, or by an optical loss of equal or less than 5 dB, equal or less than 3 dB, equal or less than 2 dB, equal or less than 1 dB, equal or less than 0.8 dB, equal or less than 0.5 dB.

### Embodiments of Optical Interposer Assemblies

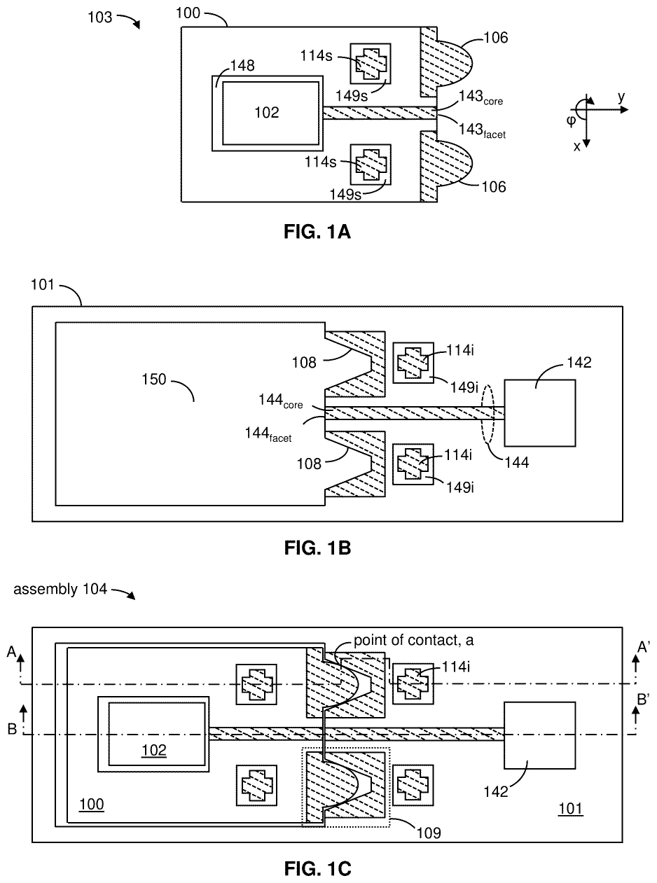

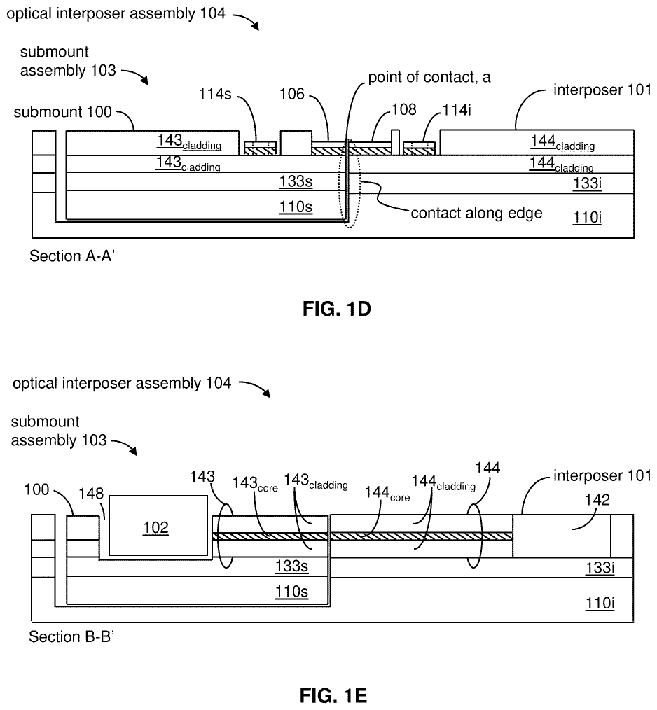

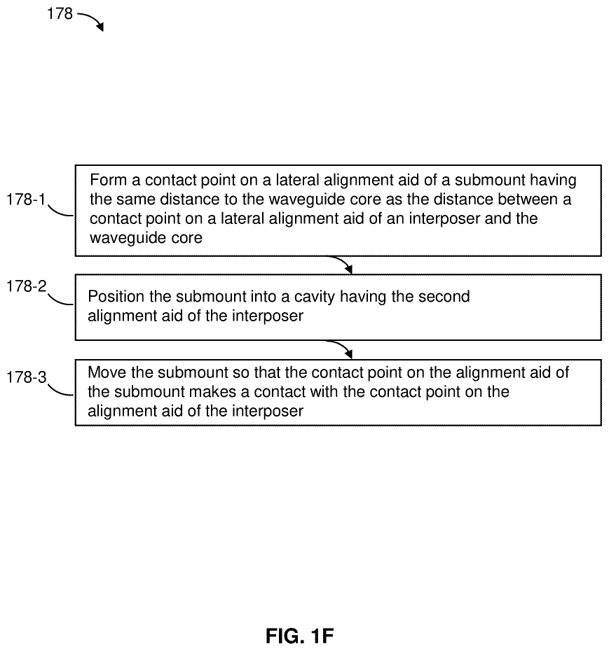

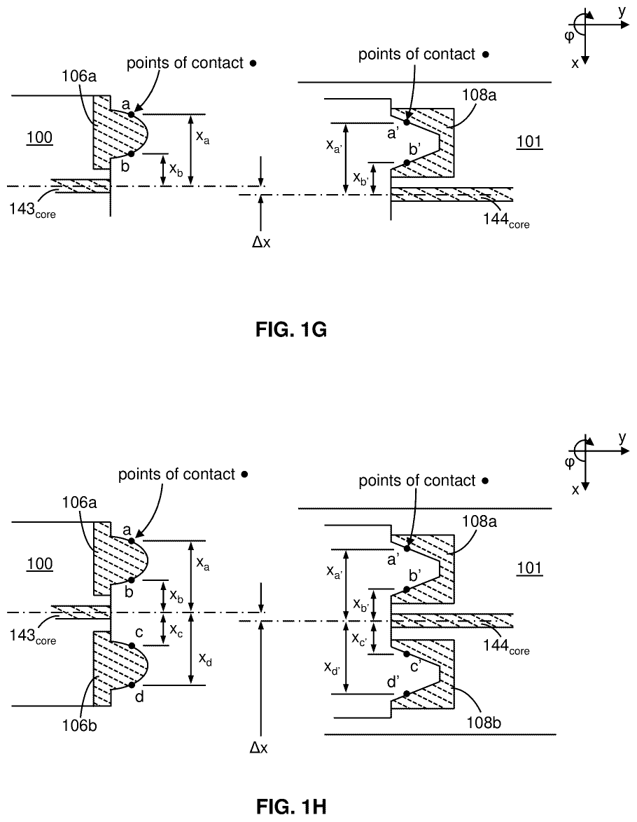

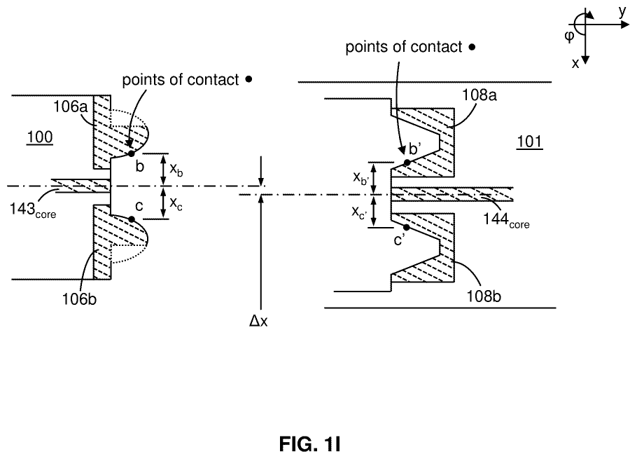

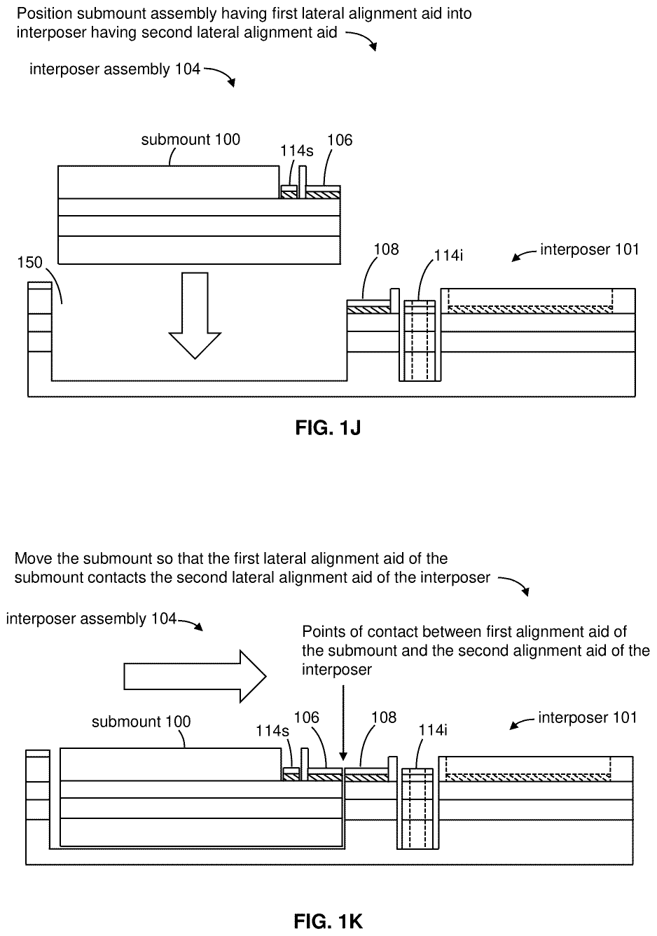

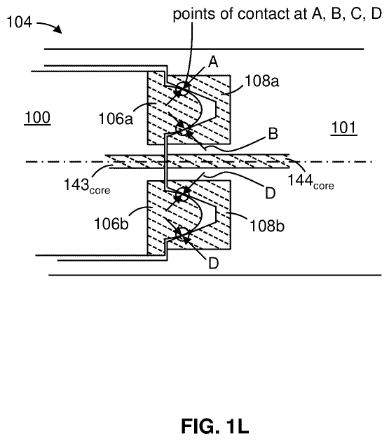

FIG. 1A shows a top view schematic drawing of an embodiment of a submount assembly 103 comprising a submount 100 and a mounted device 102. Submount 100 comprises a patterned planar waveguide 143 wherein the patterned planar waveguide core 143_{core} of the patterned planar waveguide 143 is formed self-aligned with fiducials 114s and tongue-shaped lateral alignment aids 106 (hatched portions are self-aligned features). Self-alignment is achieved with the use of a single patterned mask layer, as further described herein, to pattern two or more features for which the positional relationship is maintained throughout the formation of the structure within which the self-aligned features are formed. In the embodiment of submount 100 shown in FIG. 1A, the features having the hatched shading are formed in self-alignment from a same patterned mask layer to ensure that the spatial positioning between the patterned planar waveguide core 143_{core} and the tongue-shaped lateral alignment features 106 is maintained through the formation of the submount 100 so that lateral alignment of the patterned planar waveguide core 143_{core} can be achieved with the alignment of the tongue-shaped lateral alignment aid 106 and a complementary feature formed on another structure to which the submount 100 may be coupled.

The reference coordinate system shown at the right of FIG. 1A shows coordinates x, y, and φ. The “x” and “y” coordinates are lateral coordinates that can be used to describe the lateral positioning of all or a portion of the submount in relation to, for example, an optical interposer upon which the submount is mounted. The angle phi, “φ”, as used herein, is a rotational coordinate that can be used to describe the rotational positioning of all or a portion of the submount in relation to, for example, and optical interposer upon which the submount is mounted.

FIG. 1B shows a top view schematic drawing of an embodiment of optical interposer 101 having a cavity 150 receptive to submount 100 of FIG. 1A. In the embodiment shown, optical interposer 101 comprises a patterned planar waveguide 144 and cavity 150 wherein the patterned planar waveguide core 144_{core} of the patterned planar waveguide 144 is formed self-aligned with fiducials 114i and groove-shaped lateral alignment aids 108 formed in the wall of the cavity 150, and wherein the groove-shaped lateral alignment aids 108 are receptive to the tongue-shaped lateral alignment aids 106 formed on the embodiment of submount 100 of FIG. 1A. Facet 144_{facet} is formed at the intersection of cavity 150 and patterned planar waveguide 144. Patterned planar waveguide 144 comprises the patterned planar waveguide core 144_{core} and all or a portion of the encapsulating cladding layers 144_{cladding} surrounding the patterned planar waveguide core 144_{core}. Hatched features shown in FIG. 1B that include the groove-shaped lateral alignment aids 108, fiducials 114i, and the patterned planar waveguide core 144_{core} are formed using a same patterned mask layer to ensure self-alignment of these features. Fiducials 114i are formed, in the embodiment, in cavities 149 to enable focusing using optical pattern recognition, for example, at the same elevation as the groove-shaped lateral alignment aids 108, to facilitate the use of automated pick-and-place apparatus. Use of fiducials formed at the same elevation as the groove-shaped lateral alignment aids 108 provides the same focal distance and enables improved resolution for placement of submount 100 having tongue-shaped lateral alignment aids 106, for example, within the focal plane that includes having the fiducials 114i and the groove-shaped lateral alignment aids 108. Fiducials 114i are shown in cavities 149i for the embodiment of the optical interposer 101 of FIG. 1B. In other embodiments, fiducials 114i may be formed within cavity 150.

The embodiment of optical interposer 101 shown in FIG. 1B is configured having PIC 142. PIC 142 may be, for example, one or more optical devices coupled to patterned planar waveguide core 144_{core} of patterned planar waveguide 144. PIC 142, in some embodiments, may be an optical device such as a photodiode, a lens, an isolator, a modulator, a grating device, among other optical devices. In some embodiments, PIC 142 may be an emitting device. In other embodiments, PIC 142 may be a receiving device. In some embodiments, PIC 142 may be an arrayed waveguide. In some embodiments, PIC 142 may be a multiplexing device. In some embodiments, PIC 142 may be one or more of an optical device such as a photodiode, a lens, an isolator, a modulator, a grating device, among other optical devices. In some embodiments, PIC 142 may be an emitting device. In some embodiments, PIC 142 may be all or a portion of a photonic integrated circuit coupled to the patterned planar waveguide core 144_{core} formed self-aligned to the groove-shaped lateral alignment aids 108 of the optical interposer 101.

FIG. 1C shows a top view schematic drawing of an embodiment of an optical interposer assembly 104 comprising the submount 100 of FIG. 1A and the optical interposer 101 of FIG. 1B wherein the tongue-shaped lateral alignment aids 106 of the submount 100 are coupled to the groove-shaped lateral alignment aids 108 of the optical interposer 101 to enable alignment of the patterned planar waveguide core 143_{core} of the submount 100 with the patterned planar waveguide core 144_{core} of the optical interposer 101. In the embodiment, tongue-shaped lateral alignment aid 106 is couple to groove-shaped lateral alignment aid 108 to form tongue and groove lateral alignment feature 109, as shown enclosed in the dotted line enclosure labeled “109”. Self-aligned fiducials 114i may be used, for example, in conjunction with pick-and-place apparatus to facilitate placement of the submount 100 having tongue-shaped lateral alignment aids 106 into cavity 150 of optical interposer 101 having groove-shaped lateral alignment aids 108. After placement of the submount 100 into cavity 150 of optical interposer 101, suitable methods of alignment may be used to bring the tongue-shaped lateral alignment aids 106 of the submount 100 into contact with the groove-shaped lateral alignment aids 108 of the optical interposer 101 that cause the patterned planar waveguide core 143_{core} of the submount 100 to be brought into alignment with the patterned planar waveguide core 144_{core} of the optical interposer 101.

FIG. 1D shows Section A-A′ of the embodiment of the optical interposer assembly 104 shown in FIG. 1C. In FIG. 1D, the a “point of contact, a” is shown at which a tongue-shaped lateral alignment aid 106 of the submount 100 is brought into contact with a groove-shaped lateral alignment aid 108 of the optical interposer 101. The point of contact, a, as labeled in FIG. 1C, shows a point of contact made between the submount 100 and the interposer 101 as viewed from the top-down perspective of FIG. 1C. Actual physical points of contact may be made along the vertical sidewall created in the formation of the tongue-shaped lateral alignment aid 106 of the submount 100, in the embodiment, and along the corresponding vertical sidewall in the cavity 150 of the interposer 101. FIG. 1D shows a dotted line enclosure labeled, “contact along edge” to illustrate the vertical edges of the submount 100 and the interposer 101 along Section A-A′ of FIG. 1C along which physical contact can be made as the tongue-shaped lateral alignment aid 106 of the submount 100 is brought into contact with the groove-shaped lateral alignment aid 108 of the interposer 101 in the embodiment.

Submount assembly 103 comprises the submount 100 and mounted device 102 in the embodiment shown. Submount 100 further comprises the planar waveguide layer comprising the patterned planar waveguide core 143_{core} and surrounding cladding layers 143_{cladding}. The planar waveguide layer shown in FIGS. 1D and 1E are formed on optional electrical interconnect layer 133s on submount substrate 110s. Submount substrate 110s may be a semiconductor such as silicon, among other semiconductor substrates such as germanium, compound semiconductors, SiC, among others. Insulating substrates may also be used. Optional electrical interconnect layer 133s is a layer comprising one or more patterned conductive layers enveloped in insulating layers such as silicon dioxide, silicon oxynitride, aluminum nitride, silicon nitride, among other insulating layers. The high thermal conductivity of aluminum nitride and alloys of aluminum nitride enable its use as a thermal conductor for the removal of heat generated, for example, by devices 102 mounted in cavity 148.

Optical interposer 101 further comprises the planar waveguide layer comprising the patterned planar waveguide core 144_{core} and surrounding cladding layers 144_{cladding}. The planar waveguide layer shown in FIGS. 1D and 1E are formed on optional electrical interconnect layer 133i on optical interposer substrate 110i. Optical interposer substrate 110i may be a semiconductor such as silicon, among other semiconductor substrates such as germanium, compound semiconductors, SiC, among others. Insulating substrates may also be used. Optional electrical interconnect layer 133i is a layer comprising one or more patterned conductive layers enveloped in insulating layers such as silicon dioxide, silicon oxynitride, aluminum nitride, silicon nitride, among other insulating layers. The high thermal conductivity of aluminum nitride and alloys of aluminum nitride enable its use as a thermal conductor for the removal of heat generated, for example, by devices 102 mounted in cavity 148 on submount 100.

FIG. 1E shows Section B-B′ of the embodiment of the optical interposer assembly 104 shown in FIG. 1C. In FIG. 1E, the patterned planar waveguide core 143_{core} of the submount 100 and the patterned planar waveguide core 144_{core} optical interposer 101 are shown. Patterned planar waveguide core 143_{core}, in combination with planar waveguide cladding layers 143_{cladding}, form the patterned planar waveguide 143 of the submount 100. In embodiments, planar waveguide cladding layer 143_{cladding} may be patterned. In other embodiments, planar waveguide cladding layer 143_{cladding} may not be patterned, for example, in proximity to the patterned planar waveguide core 143_{core}. Some patterning of the cladding layers may be required, for example, for the formation of cavity 148. Localized patterning of the planar waveguide cladding layers 143_{cladding} in proximity to the patterned planar waveguide core 143_{core} may be optional.

Patterned planar waveguide core 144_{core}, in combination with planar waveguide cladding layers 144_{cladding}, form the patterned planar waveguide 144 of the optical interposer 101. In embodiments, planar waveguide cladding layer 144_{cladding} may be patterned. In other embodiments, planar waveguide cladding layer 144_{cladding} may not be patterned, for example, in proximity to the patterned planar waveguide core 144_{core}. Some patterning of the cladding layers is required, for example, for the formation of cavity 150. Localized patterning of the planar waveguide cladding layers 144_{cladding} in proximity to the patterned planar waveguide core 144_{core} is optional.

FIG. 1F shows a flowchart for a method 178 of formation of embodiments of an optical interposer assembly 104 comprising a submount 100 of submount assembly 103 having a tongue-shaped lateral alignment aid 106 and a patterned planar waveguide core 143_{core} and an optical interposer 101 having a groove-shaped lateral alignment aid 108 and a patterned planar waveguide core 144_{core} wherein the lateral distance between the tongue-shaped lateral alignment aid 106 and the patterned planar waveguide core 143_{core} on the submount 100 is the same as the lateral distance between the groove-shaped lateral alignment aid 108 and the patterned planar waveguide core 144_{core} on the optical interposer 101. Steps in the method 178 are further described in conjunction with FIGS. 1G-1L.

Step 178-1 of method 178 is a forming step in which one or more contact points on one or more lateral alignment aids of a submount 100 are formed having the same distance to a patterned planar waveguide core 143_{core} of the submount 100 as the distance between the patterned planar waveguide core 144_{core} of an optical interposer 101 and one or more contact points on one or more alignment aids of the optical interposer 101. Embodiments having two contact points are shown in FIGS. 1G and 1I and an embodiment having four contact points is shown in FIG. 1H. Other embodiments having two or more contact points are described herein.

FIG. 1G shows a portion of an embodiment of a submount 100 wherein a tongue-shaped lateral alignment aid 106a of the submount 100 is configured having two contact points, namely contact points a and b, wherein contact points a and b are formed having approximately the same distance, xₐ and x_{b}, to the centerline of patterned planar waveguide core 143_{core} as the distances xₐ′ and x_{b}', respectively, between corresponding contact points, a′ and b′, on groove-shaped lateral alignment aid 108a of optical interposer 101 to the centerline of patterned planar waveguide core 144_{core} on the optical interposer 101. In an embodiment configured as in FIG. 1G, one alignment aid is configured having two points of contact.

Contact points a and b having approximately the same distance xₐ and x_{b} to the centerline of patterned planar waveguide core 143_{core} as distance xₐ′ and x_{b}′ to the centerline of patterned planar waveguide core 144_{core} refers to distances xₐ and x_{b} such that the tongue-shaped lateral alignment aid 106a coupled to the groove-shaped lateral alignment aid 108a provides an alignment of the centerline of the terminal end of the patterned planar waveguide core 143_{core} of the submount with the centerline of the terminal end of the patterned planar waveguide core 144_{core} of the optical interposer 101. “In alignment”, as used herein in reference to the alignment of the centerline of the terminal end of the patterned planar waveguide core 143_{core} and the centerline of the terminal end of the patterned planar waveguide core 144_{core}, refers to distances within, for example, 10% of the width of the smaller of the width of the patterned planar waveguide core 143_{core} of the submount 100 and the width of the patterned planar waveguide core 144_{core} of the optical interposer 101. For example, a patterned planar waveguide 143 of the submount 100 having a patterned planar waveguide core 143_{core} of 5 microns, may be considered in some embodiments to be “in alignment” for assemblies having the centerlines of the patterned planar waveguide core 143_{core} of the submount 100 being within 0.5 microns of the centerline of the patterned planar waveguide core 144_{core} of the optical interposer 101. Misalignment of the centerlines of the patterned planar waveguide core 143_{core} of the submount 100 and the centerline of the patterned planar waveguide core 144_{core} of the optical interposer 101 is indicated by the “Δx” measure shown in FIG. 1G.

In other embodiments, “in alignment”, as used herein in reference to the alignment of the centerline of the terminal end of the patterned planar waveguide core 143_{core} and the centerline of the terminal end of the patterned planar waveguide core 144_{core}, refers to distances within 20% of the width of the smaller of the width of the patterned planar waveguide core 143_{core} of the submount 100 and the width of the patterned planar waveguide core 144_{core} of the optical interposer 101. In these embodiments, the patterned planar waveguide 143 of the submount 100, having a patterned planar waveguide core 143_{core} of 4 microns, may be considered to be “in alignment” for assemblies having the centerlines of the patterned planar waveguide core 143_{core} of the submount 100 being within 0.8 microns of the centerline of the patterned planar waveguide core 144_{core} of the optical interposer 101. In practice, having the centerline of the terminal end of the patterned planar waveguide core 143_{core} of the submount 100 in close alignment, within 0.1-0.2 micron. In some embodiments,

FIG. 1H shows a portion of another embodiment of submount 100 and optical interposer 101 where the submount 100 and the optical interposer 101 are configured having two points of contact on each of two lateral alignment aids.

FIG. 1H shows a portion of an embodiment of submount 100 wherein a first tongue-shaped lateral alignment aid 106a of submount 100 is configured having two contact points, namely contact points a and b, and a second tongue-shaped lateral alignment aid 106b is configured having two contact points, namely contact points c and d, wherein contact points a and b are formed having approximately the same distance, xₐ and x_{b}, to the centerline of patterned planar waveguide core 143_{core} as the distances xₐ′ and x_{b}′, respectively, between corresponding contact points, a′ and b′, on a first groove-shaped lateral alignment aid 108a of optical interposer 101 to the centerline of patterned planar waveguide core 144_{core} on the optical interposer 101 and contact points c and d are formed having approximately the same distance, x_{c} and x_{d}, to the centerline of patterned planar waveguide core 143_{core} as the distances x_{c}′ and x_{d}′, respectively, between corresponding contact points c′ and d′, on a second groove-shaped lateral alignment aid 108b of optical interposer 101 to the centerline of patterned planar waveguide core 144_{core} on the optical interposer 101. In an embodiment configured as in FIG. 1H, two alignment aids are configured each having two points of contact.

FIG. 1I shows a portion of yet another embodiment of submount 100 and optical interposer 101 wherein the submount 100 and the optical interposer 101 are configured having one point of contact on each of two lateral alignment aids. FIG. 1I shows a portion of an embodiment of submount 100 wherein a first tongue-shaped lateral alignment aid 106a of submount 100 is configured having a contact point, namely contact point b, and a second tongue-shaped lateral alignment aid 106b is configured having a contact point, namely contact point c, wherein contact point b is formed having the same distance, x_{b} to the centerline of patterned planar waveguide core 143_{core} as the distances x_{b}′ between corresponding contact point b′ on a first groove-shaped lateral alignment aid 108a of optical interposer 101 to the centerline of patterned planar waveguide core 144_{core} on the optical interposer 101, and contact point c is formed having the same distance, x_{c}, to the centerline of patterned planar waveguide core 143_{core} as the distances x_{c}′, between corresponding contact point c′ on a second groove-shaped lateral alignment aid 108b of optical interposer 101 to the centerline of patterned planar waveguide core 144_{core} on the optical interposer 101. In an embodiment configured as in FIG. 1H, two alignment aids are configured each having one point of contact.

In forming step 178-1 of method 178, one or more contact points on one or more lateral alignment aids of a submount 100 are formed having the same distance to a patterned planar waveguide core 143_{core} of the submount 100 as the distance between the patterned planar waveguide core 144_{core} of an optical interposer 101 and one or more contact points on one or more alignment aids of the optical interposer 101. Some embodiments having two or more contact points are shown in FIGS. 1G-1I. Other embodiments are further described herein.

Step 178-2 of method 178 is a positioning step in which the submount 100 having one or more first lateral alignment aids is positioned into a cavity on an optical interposer having one or more second lateral alignment aids. FIG. 1J shows submount 100 of submount assembly 103 being positioned into cavity 150 of optical interposer 101. In the embodiment, the open arrow shows the direction of movement of the submount 100 as it is being positioned into cavity 150 of the optical interposer 101. Submount 100 may be positioned in optical interposer 101 using automated pick-and-place apparatus guided by the self-aligned fiducials 114i of the optical interposer 101 and the self-aligned fiducials 114s of the submount 100. Manual pick-and-place apparatus may also be used to position submount 100 into cavity 150 of the optical interposer 101.

Step 178-3 of method 178 is a moving step in which the submount 100 having one or more first lateral alignment aids is moved such that the one or more first lateral alignment aids of the submount contact the one or more second lateral alignment aids of the cavity 150 of the optical interposer 101. FIG. 1K shows the submount 100 after moving in the direction of the open arrow such that the tongue-shaped lateral alignment aid 106 of the submount 100 shown in the cross-section in FIG. 1K forms a contact with the groove-shaped lateral alignment aid 108 of the cavity 150 of the optical interposer 101. Movement of the one or more first lateral alignment aids of the submount 100 into contact with the one or more second lateral alignment aids of the cavity 150 of the optical interposer 101 brings into alignment the patterned planar waveguide core 143_{core} of the submount 100 with the patterned planar waveguide core 144_{core} of the optical interposer 101 as shown in the top view of the optical interposer assembly 104 in FIG. 1L for the embodiment of the exploded top view shown in FIG. 1H having two contact points on each of two alignment aids on the submount 100 and the optical interposer 101.

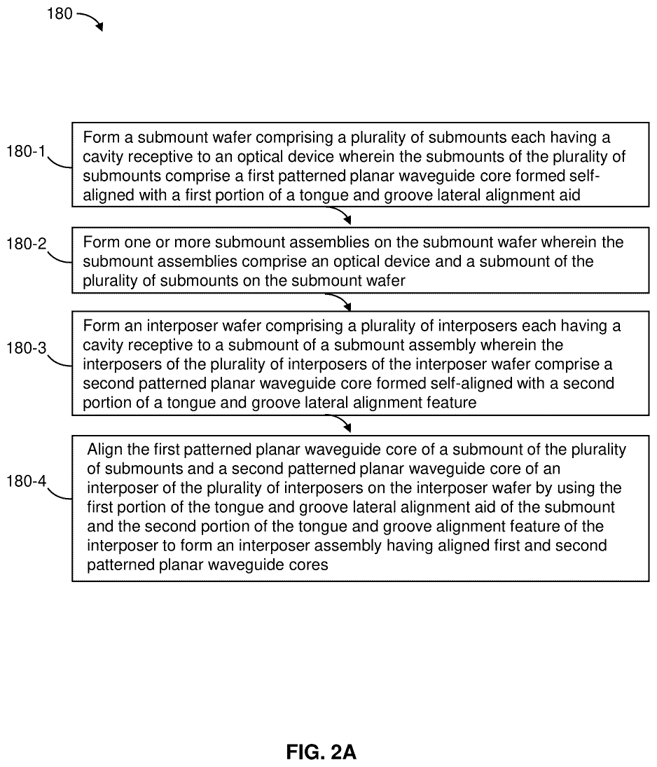

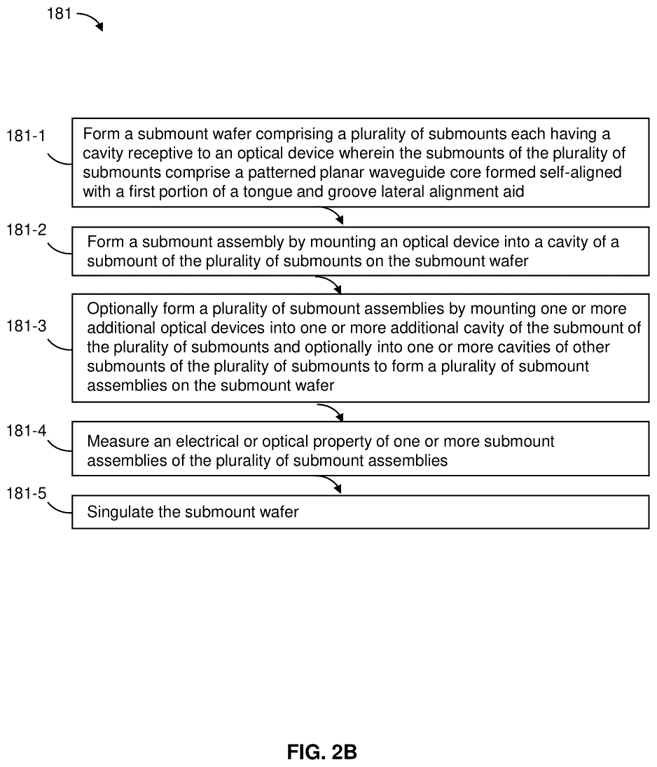

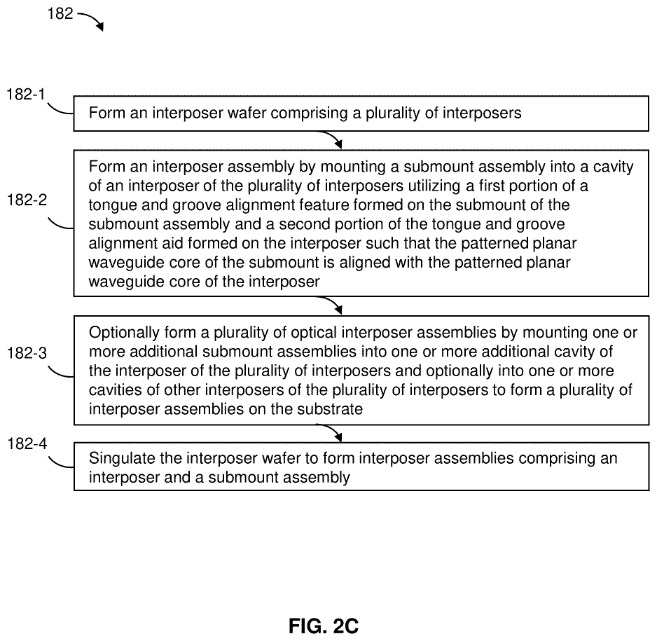

FIG. 2A shows a flowchart for a method 180 of formation of embodiments of optical interposer assembly 104 comprising submount assembly 103 and optical interposer 101 wherein the patterned planar waveguide core 143_{core} of submount 100 is aligned with patterned planar waveguide core 144_{core} of the optical interposer 101 using tongue and groove lateral alignment features.

Step 180-1 of method 180 is a forming step in which a submount wafer 112s comprising a plurality of submounts 100 is formed each having at least a cavity 148 receptive to an optical device 102 wherein the submounts 100 of the plurality of submounts 100 on the submount wafer 112s comprise a first patterned planar waveguide core 143_{core} formed self-aligned with a first portion of a tongue and groove lateral alignment feature. The tongue-shaped lateral alignment aid 106 configured in the submount 100 shown in FIG. 1A is an example of a first portion of a tongue and groove lateral alignment feature.

Step 180-2 of method 180 is a forming step in which a submount assembly 103 is formed comprising an optical device 102 and a submount 100.

Step 180-3 of method 180 is a forming step in which a substrate 112i comprising a plurality of optical interposers 101 is formed each having at least a cavity 150 receptive to a submount 100 wherein the optical interposers 101 of the plurality of optical interposers 101 comprise a second patterned planar waveguide core 144_{core} formed self-aligned with a second portion of a tongue and groove lateral alignment feature. The groove-shaped lateral alignment aid 108 configured in optical interposer 101 shown in FIG. 1B is an example of a second portion of a tongue and groove lateral alignment feature compatible with the tongue-shaped first portion of the tongue and groove lateral alignment feature 109 of the submount 100 shown in FIG. 1A.

Step 180-4 of method 180 is an aligning step in which a first patterned planar waveguide core 143_{core} of submount 100 and the second patterned planar waveguide core 144_{core} of optical interposer 101 are brought into alignment using the first portion of the tongue and groove lateral alignment feature of the submount 100 and the second portion of the tongue and groove lateral alignment feature of the optical interposer 101 to form an optical interposer assembly 104 having aligned first and second patterned planar waveguide cores.

In the embodiment of optical interposer assembly 104 of FIG. 1C comprising submount assembly 103 and optical interposer 101, for example, the submount 100 of submount assembly 103 is configured having a first portion of a tongue and groove lateral alignment feature that is a tongue-shaped lateral alignment aid 106 as in FIG. 1A, and the optical interposer 101 is configured having a second portion of a tongue and groove lateral alignment feature that is a groove-shaped lateral alignment aid 108 as in FIG. 1B. Coupling of the tongue-shaped lateral alignment aid 106 and the groove-shaped lateral alignment aid 108 enables formation of optical interposer assembly 104 having aligned first patterned planar waveguide core 143_{core} of the submount 100 and second patterned planar waveguide core 144_{core} of the optical interposer 101.

In some embodiments, the first alignment aid of the submount 100 is a groove-shaped lateral alignment aid and the second alignment aid of the optical interposer is a tongue-shaped lateral alignment aid. In other embodiments, one or more first alignment aid of the submount 100 is a tongue-shaped lateral alignment aid and one or more first alignment aid of the submount 100 is a groove-shaped lateral alignment aid and one or more second alignment aid of the optical interposer 101 is a groove-shaped lateral alignment aid and one or more second alignment aid of the optical interposer 101 is a tongue-shaped lateral alignment aid. A tongue-shaped lateral alignment aid, as used herein, refers to a lateral alignment aid formed from a protrusion that extends beyond the edge of the submount 100 or optical interposer 101 on which the alignment aid is formed. Conversely, a groove-shaped lateral alignment aid, as used herein, refers to an alignment aid formed from a recess at the edge of a submount 100 or optical interposer 101 that is receptive to a tongue-shaped lateral alignment aid. Tongue and groove lateral alignment features 109, in embodiments, are paired lateral alignment aids formed using lithographic patterning in conjunction with the patterning of planar waveguide cores and other optional alignment features. Self-alignment using a same patterned mask layer for a lateral alignment aid and the patterned planar waveguide core of a patterned planar waveguide enables the use of a lateral alignment aid on submount 100 for aligning of the patterned planar waveguide core 143_{core} of submount 100 with a patterned planar waveguide core 144_{core} of optical interposer 101 using a lateral alignment aid formed self-aligned with a patterned planar waveguide core 144_{core} on the optical interposer 101.

FIG. 2B shows a flowchart for a method 181 of formation of some embodiments of submount assembly 103 wherein the submount 100 of submount assembly 103 is configured having alignment features formed self-aligned with the patterned planar waveguide core 143_{core} of the submount 100 and the method 181 includes a step for obtaining a measurement of an optical or electrical property of the submount assembly 103. Measurement of an optical or electrical property of a submount assembly 103 may be desirable prior to the formation of an optical interposer assembly 104 to enable, for example, the use of submount assemblies 103 having known properties and may, for example, enable the exclusion of submount assemblies 103 having undesirable properties.

Step 181-1 of method 181 is a forming step in which a submount wafer 112s comprising a plurality of submounts 100 is formed each having a cavity 148 receptive to an optical device 102 wherein the submounts 100 of the plurality of submounts 100 of the submount wafer 112s comprise a patterned planar waveguide core 143_{core} formed self-aligned with a first portion of a tongue and groove lateral alignment feature. The tongue-shaped lateral alignment aid 106 configured in the submount 100 shown in FIG. 1A is an example of a first portion of a tongue and groove lateral alignment feature.

Step 181-2 of method 181 is a forming step in which a submount assembly 103 is formed by mounting an optical device 102 in a cavity 148 of a submount 100 of the plurality of submounts 100 on the submount wafer 112s.

Step 181-3 of method 181 is an optional forming step in which one or more additional submount assemblies 103 are formed by mounting one or more additional optical devices 102 into one or more additional cavity 148 of the submount 100 of the plurality of submounts 100 and optionally into one or more cavities 148 of other submounts 100 of the plurality of submounts 100 on the submount wafer 112s to form a plurality of submount assemblies 103 on the submount wafer 112s.

Step 181-4 of method 181 is a measuring step in which one or more of one or more of an optical and an electrical property of one or more submount assembly 103 of the plurality of submount assemblies 103 on submount wafer 112s is measured.

Step 181-5 of method 181 is a singulation step in which the submount assemblies 103 of the submount wafer 112s comprising a plurality of submount assemblies 103 are singulated. Singulation of the submount assemblies 103 from the submount wafer 112s may be performed using a dicing saw, for example. Singulation may be performed using a suitable etch process. These and other methods of die singulation are known in the art of semiconductor fabrication. In some embodiments, singulation step 181-5 may precede the measurement step 181-4.

FIG. 2C shows a flowchart for a method 182 of formation of some embodiments of optical interposer assemblies 104 each comprising an optical interposer 101 and a submount assembly 103 wherein the optical interposer 101 and the submount 100 of the optical interposer assemblies 104 are formed having alignment features self-aligned with a patterned planar waveguide core.

Step 182-1 of method 182 is a forming step in which an optical interposer wafer 112i comprising a plurality of optical interposers 101 is formed.

Step 182-2 of method 182 is a forming step in which an optical interposer assembly 104 is formed by mounting a submount assembly 103 into a cavity 150 of an optical interposer 101 utilizing a first portion of a tongue and groove lateral alignment feature formed on the submount 100 of the submount assembly 103 and a second portion of the tongue and groove lateral alignment feature formed on the optical interposer 101 such that the patterned planar waveguide core 143_{core} of the submount 100 is aligned with the patterned planar waveguide core 144_{core} of the optical interposer 101.

Step 182-3 of method 182 is an optional forming step in which one or more additional optical interposer assemblies 104 are formed by mounting one or more additional submount assemblies 103 into one or more additional cavity 150 of the optical interposer 101 of the plurality of optical interposers 101 on the optical interposer wafer 112i and optionally into one or more cavities 150 of other optical interposers 101 of the plurality of optical interposers 101 to form a plurality of optical interposer assemblies 104 on the optical interposer wafer 112i.

Step 182-4 of method 182 is a singulation step in which the optical interposer assemblies 104 of the optical interposer wafer 112i comprising a plurality of optical interposer assemblies 104 are singulated. Singulation of the optical interposer assemblies 104 from optical interposer wafer substrate 112i comprising the one or more optical interposer assemblies 104 may be performed using a dicing saw, for example. Singulation may be performed using a suitable etch process. These and other methods of die singulation are known in the art of semiconductor fabrication. In some embodiments, singulation step 182-4 may precede one or more of forming steps 182-2 and 182-3.

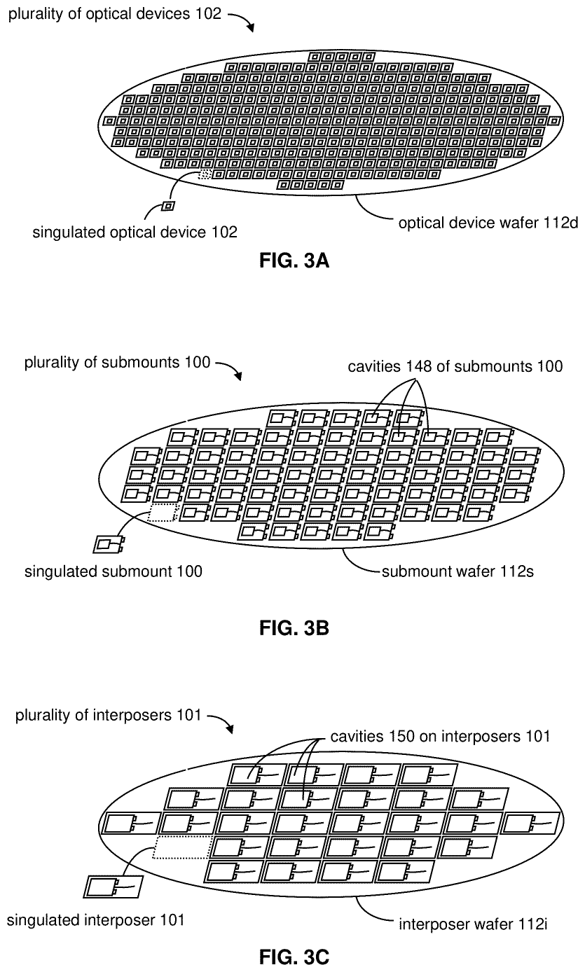

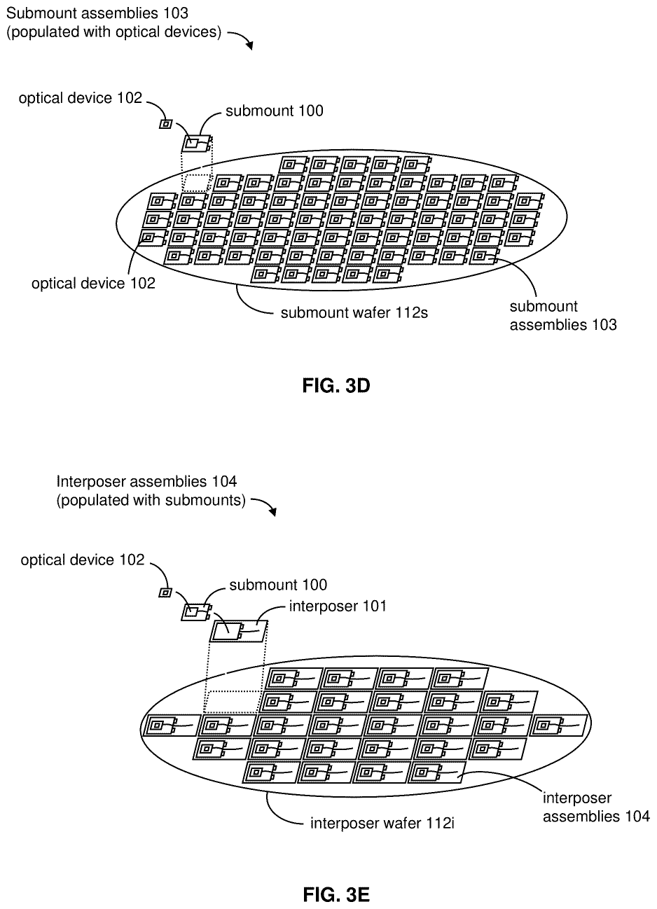

In embodiments, optical interposer assembly 104 comprises optical interposer 101 and submount assembly 103 wherein the submount assembly 103 further comprises submount 100 and optical device 102. FIGS. 3A-3C show optical device wafer 112d, submount wafer 112s, and optical interposer wafer 112i comprising a plurality of optical devices 102, submounts 100, and optical interposers 101, respectively.

Optical device 102, configured as an emitting device such as a laser, may be formed for example, from epitaxial structures formed on compound semiconductor substrates such as InP and GaAs. The epitaxial layering in the formation of laser diode structures enables the fine tuning of optical output from these compound semiconductor alloys that are not currently available with silicon-based materials. The complexity of the processes used in the formation of laser diodes from compound semiconductor materials, coupled with the requirement for operating these laser diodes at high and often continuous current density, renders these devices susceptible to deviations in optical output from the designed output wavelength and to deviations in the power output from the designed output power. Coupling of mounted laser diodes to waveguides formed from silicon and silicon-based dielectrics on optical interposers, and other structures on which the laser diodes may be utilized, can further impact the manufacturing induced variability of these devices.

FIG. 3A shows a schematic perspective drawing of an embodiment of an optical device wafer 112d having a plurality of optical devices 102. The compact size of discrete laser diodes enables the formation of many devices on a wafer such as the embodiment of optical device wafer 112d depicted in the perspective drawing of FIG. 3A. For clarity, a singulated optical device 102 is shown in FIG. 3A to illustrate a discrete optical device 102 removed from the dotted line portion of optical device wafer 112d.

FIG. 3B shows a perspective drawing of an embodiment of submount wafer 112s comprising a plurality of submounts 100. A submount 100 of the plurality of submounts 100 on submount wafer 112s is configured having one or more cavity 148, or other device mounting sites, receptive to an optical device 102. Mounting of optical device 102 onto submount 100 enables the measurement of one or more of an optical and an electrical characteristic of the submount assembly 103 formed from the optical device 102 and the submount 100. A measurement from submount assembly 103 enables the characterization of the combination of the laser diode and the coupling of the laser diode to a waveguide on the submount 100. The measurement of the submount assembly 103 can enable, for example, the use of submount assemblies 103 having specific output properties and ranges of output properties, can enable the elimination of submount assemblies 103 that do not meet specific output criteria, and may enable burn-in processes to be used on the submount assemblies 103, among other potential benefits. For clarity, a singulated submount 100 is shown in FIG. 3B to illustrate a discrete submount 100 removed from the dotted line portion of submount wafer 112s.

FIG. 3C shows a schematic perspective drawing of an embodiment of optical interposer wafer 112i having a plurality of optical interposers 101. An optical interposer 101 of the plurality of optical interposers 101 on optical interposer substrate 112i is configured having one or more cavity 150, or other device mounting sites, receptive to a submount 100 of submount assembly 103. The use of submount assemblies 103 in the formation of optical interposer assemblies 104 enables the use of submount assemblies 103 that may have been one or more of electrically and optically characterized and that may have been exposed to a burn-in process, among other optional processes prior to the formation of the optical interposer assemblies 104. For clarity, a singulated optical interposer 101 is shown in FIG. 3C to illustrate a discrete optical interposer 101 removed from the dotted line portion of optical interposer substrate 112i.

FIG. 3D shows a schematic perspective drawing of submount wafer 112s comprising a plurality of submount assemblies 103. The perspective drawing of FIG. 3D shows the submount wafer 112s of FIG. 3B after mounting of optical devices 102 from singulated optical device wafer 112d of FIG. 3A into device mounting cavities 148 of the plurality of submounts 100. For clarity, a singulated submount assembly 103 is shown in FIG. 3D to illustrate a discrete submount assembly 103 removed from the dotted line portion of submount wafer 112s. The optical device 102 of the removed submount assembly 103 in FIG. 3D is shown removed from the cavity 148 of the submount 100.

FIG. 3E shows a schematic perspective drawing of the optical interposer wafer 112i of FIG. 3C after mounting of submount assemblies 103 comprising submounts 100 of FIG. 3D and optical devices 102 of FIG. 3A into the submount mounting cavities 150 of the plurality of optical interposers 101 on optical interposer wafer 112i. For clarity, a singulated optical interposer assembly 104 is shown in FIG. 3E to illustrate a discrete optical interposer assembly 104 removed from the dotted line portion of optical interposer wafer 112i. The submount assembly 103 of the removed optical interposer assembly 104 is shown removed from the optical interposer 101 and the optical device 102 of the removed submount assembly 103 in FIG. 3E is shown removed from cavity 148 of the submount 100.

In summary, FIGS. 3A-3C show optical device wafer 112d, submount wafer 112s, and optical interposer wafer 112i, respectively. Singulated die from each of the wafers are used in the formation of optical interposer assemblies 104 comprising a singulated optical interposer 101 and a submount assembly 103 further comprising a submount 100 and a mounted device 102 in the embodiment shown. FIG. 3D shows submount wafer 112s populated with optical devices 102 in the embodiment, and FIG. 3E shows optical interposer wafer 112i populated with the submount assemblies 103 to form the optical interposer assemblies 104 in the embodiment. The submounts 100 and the optical interposers 101 of the optical interposer assemblies 104 are formed having complementary tongue and groove lateral alignment features that enable alignment of patterned planar waveguide core 143_{core} of the submount 100 with the patterned planar waveguide core 144_{core} of the optical interposer 101.

### Formation of Submount and Submount Assembly

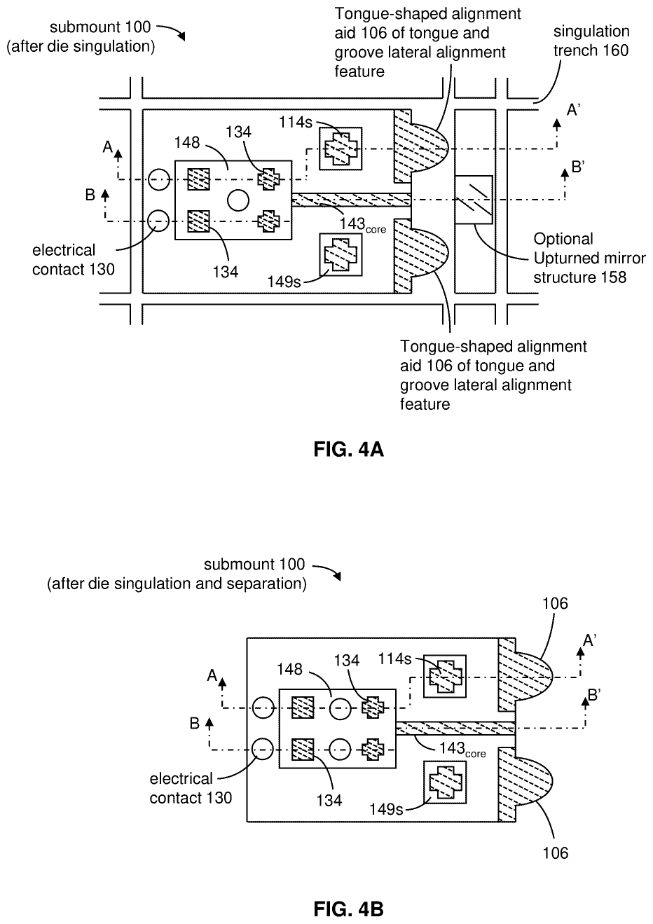

FIG. 4A shows a top view schematic drawing of a portion of a submount wafer 112s as shown, for example, in FIG. 3B comprising a submount 100 and further comprising an upturned mirror structure 158 wherein the portion of the submount wafer 112s further shows singulation trenches 160 that may be used to singulate the submounts 100 of submount wafer 112s.

FIG. 4B shows a top view schematic drawing of the submount 100 of FIG. 4A in isolation after singulation from submount wafer 112s.

The embodiment of the submount 100 of FIG. 4A and FIG. 4B comprises self-aligned features that include patterned planar waveguide core 143_{core}, alignment pillars 134 formed in a device mounting cavity 148, fiducials 114s formed in fiducial cavities 149s, and tongue-shaped lateral alignment aids 106 that form a portion of a tongue and groove lateral alignment feature. Electrical contacts 130 may be formed on the submount 100 to enable electrical connections to be made, for example, to optical device 102 mounted in cavity 148.

The submount 100 shown in FIGS. 4A and 4B includes alignment pillars 134 formed in cavity 148. The alignment pillars 134, shown cross hatched in FIGS. 4A and 4B, may be formed self-aligned using the same patterned mask layer as used in the formation of the self-aligned tongue-shaped lateral alignment aids 106, fiducials 114s, and patterned planar waveguide core 143_{core}. Inclusion of the self-aligned alignment pillars 134 enables the alignment of an optical device 102 mounted in cavity 148 to the patterned planar waveguide core 143_{core} using alignment features that are formed self-aligned with the patterned planar waveguide core 143_{core}. Alignment aids 134 shown in cavity 148 include square shaped alignment pillars and “+” shaped pillars. Other pillar shapes may be used in other embodiments. The “+” shaped alignment pillars may provide preferred shapes for fiducial structures in some embodiments. Cavity 148 in the embodiment shown in FIGS. 4A and 4B also shows a circular electrical contact 130. One or more electrical contacts may be provided in cavity 148 to facilitate, for example, one or more electrical connections to an optical device 102 mounted in cavity 148. The one or more electrical contacts 130 in cavity 148 may connect to electrical contacts formed outside of the cavity through optional underlying electrical interconnect layer 133s of the submount 100.

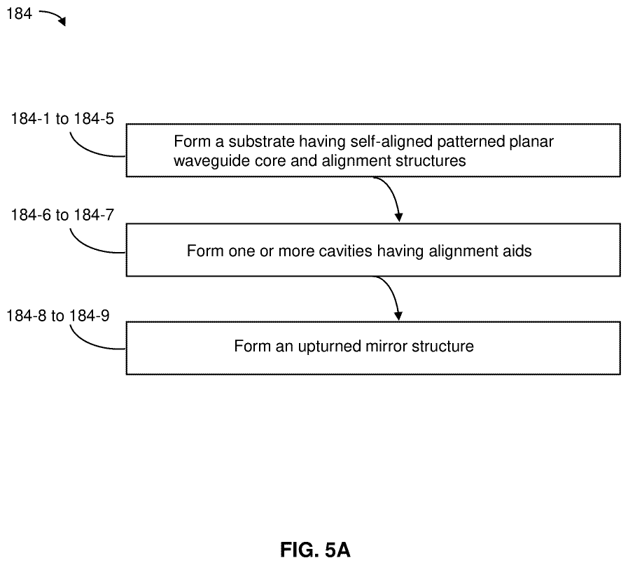

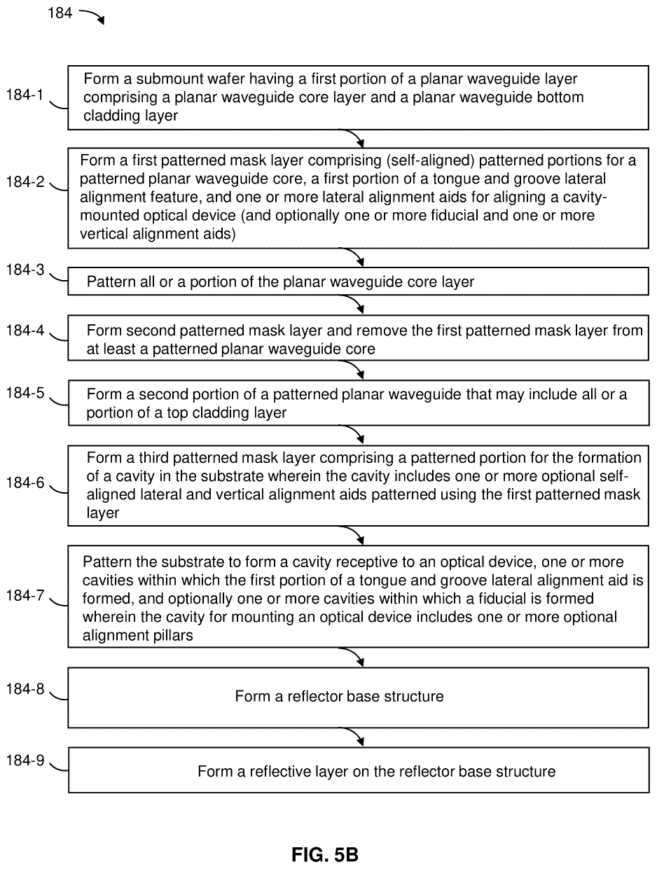

FIG. 5A shows a summary view of a flowchart for a method 184 of forming an embodiment of submount 100 having tongue-shaped lateral alignment aids 106 formed self-aligned with a patterned planar waveguide core 143_{core} and further having self-aligned alignment pillars 134 formed in the device mounting cavity 148. Steps 184-1 to 184-5 of method 184 comprise steps used in the formation of a submount wafer 112s having a plurality of submounts 100 and the formation of self-aligned features on the plurality of submounts 100. In embodiments, self-aligned features formed on the submount 100 comprise one or more patterned planar waveguide core 143_{core} and one or more alignment structures. Steps 184-6 and 184-7 comprise steps in the formation of one or more cavities 148 that may be used for mounting of optical device 102, for the formation of one or more cavities 149 having fiducials 114s, and for the formation of one or more cavities 147 having a portion of a tongue and groove lateral alignment feature 109. Steps 184-8 to 184-9 comprise steps in the formation of one or more upturned mirror structures 158 in the submounts 100 of the plurality of submounts 100 formed on submount wafer 112s. Upturned mirror structures 158 may be used, for example, to reflect an optical signal to or from an optical device 102 mounted in cavity 148 of a submount 100. Optical signals reflected from an upturned mirror structure 158, in embodiments of submount wafers 112s configured having a plurality of submounts 100, may be used to measure one or more of an electrical and optical property of a submount 100 to which an upturned mirror structure 158 is coupled. In some embodiments described herein, upturned mirror structures 158 are separated from the submounts 100 to which they are coupled.

FIG. 5B shows a more detailed flowchart, in comparison to the summary flowchart of FIG. 5A, for a method 184 of forming an embodiment of submount 100 having tongue-shaped lateral alignment aids 106 formed self-aligned with a patterned planar waveguide core 143_{core} and further having self-aligned alignment pillars 134 formed in the device mounting cavity 148.

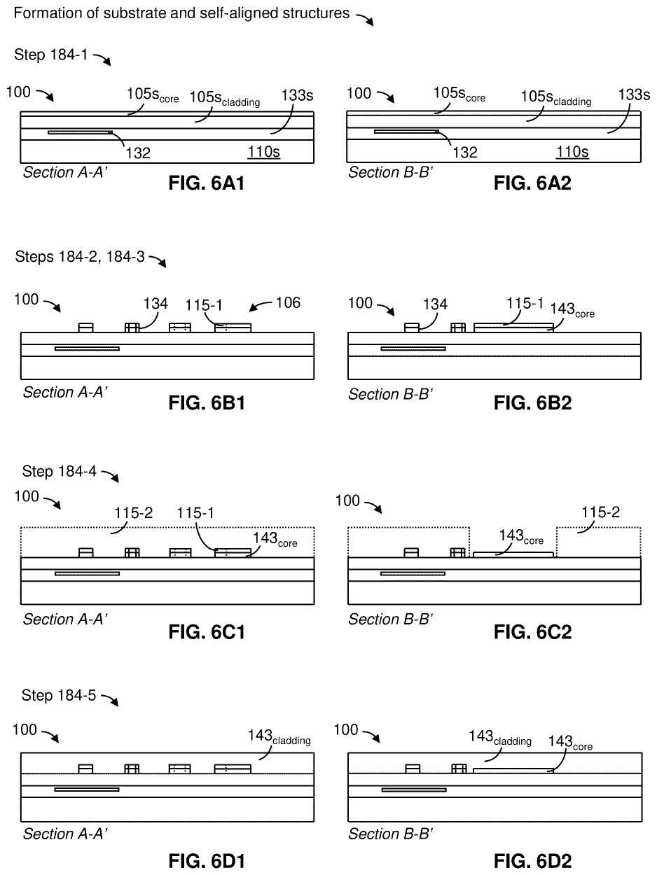

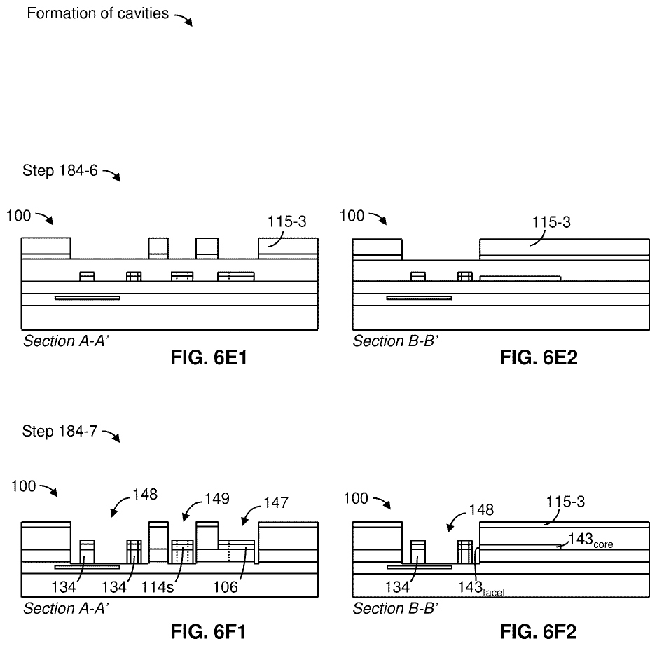

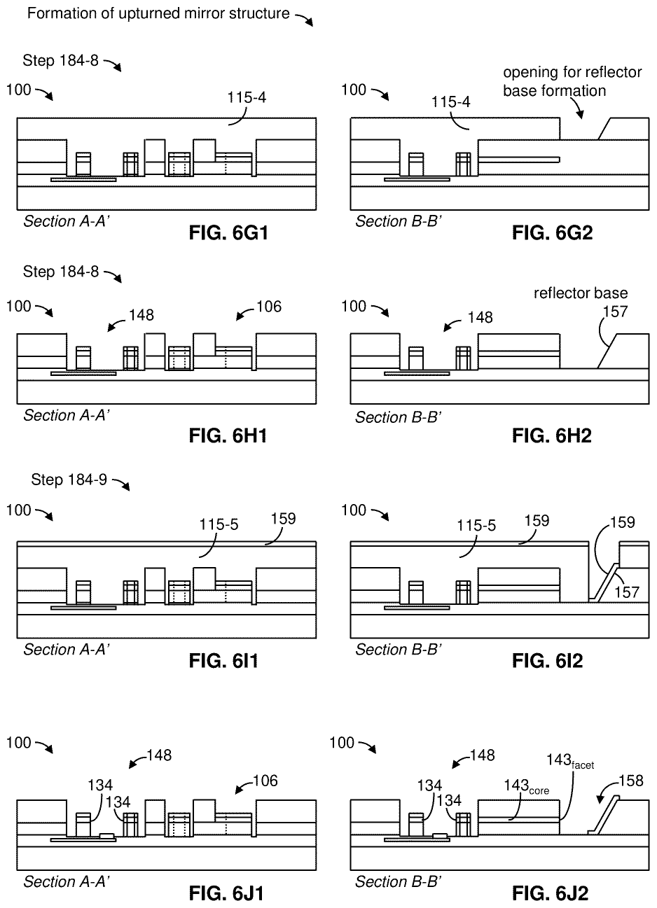

The method 184 of FIGS. 5A and 5B is described in conjunction with the schematic cross-sectional drawings in FIG. 6A1 to 6J1 and FIG. 6A2 to 6J2.

FIG. 6A1-6J1 and 6A2-6J2 show a sequence of cross-sectional drawings that illustrate steps in the formation of embodiments of a submount 100 having self-aligned features that include the patterned planar waveguide core 143_{core}, alignment pillars 134 formed in cavity 148, fiducials 114s, and tongue-shaped lateral alignment aids 106 that form a first portion of a tongue and groove lateral alignment feature 109. FIG. 6A1 to 6J1 show section drawings corresponding to Section A-A′ of FIG. 4A prior to the formation of the singulation trenches. And FIG. 6A2 to 6J2 show section drawings corresponding to Section B-B′ of FIG. 4A prior to the formation of singulation trenches 160.

Step 184-1 of method 184 is a forming step in which a submount wafer 112s is formed wherein the submount wafer 112s comprises all or a portion of a bottom cladding layer 105s_{cladding} and all or a portion of a planar waveguide core layer 105s_{core}. FIG. 6A1 and 6A2 show cross-sections corresponding to the location of Sections A-A′ and B-B′ of FIG. 4A after formation of submount wafer 112s comprising planar waveguide core layer 105s_{core} and bottom planar waveguide cladding layer 105s_{cladding} formed on optional electrical interconnect layer 133s. In some embodiments, electrical interconnect layer 133s may not be present. Optional electrical interconnect layer 133s may include one or more patterned electrically conductive layers 132 encapsulated in insulating dielectric material such as silicon oxide, silicon oxynitride, among other insulating dielectric materials. In the embodiment, electrical interconnect layer 133s enables one or more electrical connections to be made between contacts emerging at the bottom of cavity 148, for example, and other portions of the submount 100. In some embodiments, one or more electrical connections may be made between the top side of a mounted device 102 and electrical contacts formed, for example, on other areas of the submount 100. In embodiments, planar waveguide core layer 105s_{core} may be formed, for example, from one or more of silicon, silicon oxide, silicon oxynitride, silicon nitride, among other materials. In some embodiments, a polymer may be used in the formation of planar waveguide core layer 105s_{core}. Planar waveguide core layer 105s_{core} of submount wafer 112s may be a single layer in some embodiments. In other embodiments, planar waveguide core layer 105s_{core} may be comprised of one or more layers. In some embodiments, bottom cladding layer 105s_{cladding} may be one or more of silicon oxide and silicon oxynitride. In other embodiments, a polymer layer may be used to form bottom cladding layer 105s_{cladding}. In embodiment, the refractive index of the bottom cladding layer 105s_{cladding} is less than that of the planar waveguide core layer 105s_{core}.

Step 184-2 of method 184 is a forming step in which a first patterned mask layer 115-1 is formed comprising patterned portions for a patterned planar waveguide core 143_{core} and tongue-shaped lateral alignment aid 106 comprising a first portion of a tongue and groove lateral alignment feature 109. Step 184-3 of method 184 is a patterning step in which all or a portion of the patterned planar waveguide core layer 105s_{core} is patterned to form patterned planar waveguide core 143_{core} on submount wafer 112s. In some embodiments, the full thickness of the planar waveguide core layer 105s_{core} may be patterned. In other embodiments, a portion of the thickness of the planar waveguide core layer 105s_{core} may be patterned. In embodiments in which a portion of the thickness of the planar waveguide core layer 105s_{core} is patterned to form patterned planar waveguide core 143_{core}, a rib waveguide may be formed from the patterning step.

FIG. 6B1 and 6B2 show cross-sections corresponding to the location of Sections A-A′ and B-B′ of FIG. 4A after formation of first patterned mask layer 115-1 on planar waveguide core layer 143_{core} and the subsequent patterning of the planar waveguide core layer 105s_{core} to form patterned planar waveguide core 143_{core}. In the embodiment, the full thickness of the planar waveguide core layer is shown patterned. In other embodiments, all or a portion of the planar waveguide core layer 105s_{core} may be patterned. And in other embodiments, all of the planar waveguide core layer 105s_{core} may be patterned and all or a portion of the bottom cladding layer 105s_{cladding} may also be patterned to form a portion of patterned planar waveguide 143. Patterned planar waveguide 143 comprises the first portion formed from the patterning of all or a portion of the planar waveguide core layer 105s_{core} and all or a portion of the planar waveguide bottom cladding layer 105s_{cladding}, and further includes the top cladding 143_{cladding} that may be formed on the top and sides of the patterned planar waveguide core 143_{core}.

First patterned mask layer 115-1 may further comprise one or more additional patterned portions comprising one or more lateral alignment aids 134 for aligning an optical device 102 in cavity 148, one or more fiducials 114s, and one or more vertical alignment aids, among other optional patterned portions.

The use of a single patterned layer 115-1 as a mask layer used in the formation of alignment features and the formation of one or more patterned planar waveguides 143 from a patterned planar waveguide core 143_{core} ensures that these features are formed self-aligned. Self-alignment of the various features enables the use of the alignment features to align the patterned planar waveguide core 143_{core} with other waveguide cores, such as is present on the optical interposer 101 to which the submount 100 may be mounted, and also enables the use of alignment aids for aligning optical devices 102 mounted in cavity 148, for example, with a patterned planar waveguide core 143_{core}.

Step 184-4 of method 184 is a forming and removing step in which a second patterned mask layer 115-2 is formed and the first patterned mask layer 115-1 is removed from at least a portion of a patterned planar waveguide core 143_{core}. FIG. 6C1 and 6C2 show cross-sections corresponding to the location of Sections A-A′ and B-B′ of FIG. 4A after formation of second patterned mask layer 115-2 and the subsequent removal of the first patterned mask layer 115-1 from patterned planar waveguide core 143_{core}. The dotted lines in FIG. 6C1 and 6C2 show the outline of second patterned mask layer 115-2 in the embodiment. Solid lines show the submount 100 after removal of the first patterned mask layer 115-1 from the patterned planar waveguide core 143_{core} of Section B-B′.

Step 184-5 of method 184 is a forming step in which a second portion of patterned planar waveguide 143 is formed that may include all or a portion of top cladding layer 143_{cladding}. FIG. 6D1 and 6D2 show cross-sections corresponding to the location of Sections A-A′ and B-B′ of FIG. 4A after formation of a top cladding layer 143_{cladding}. Top cladding layer 143_{cladding} is shown over patterned planar waveguide core 143_{core} in FIG. 6D2 and over other patterned features in FIG. 6D1 and 6D2. Second portion of patterned planar waveguide 143 may include cladding on the top of the patterned planar waveguide core 143_{core} and other features patterned from all or a portion of the planar waveguide core layer 105s_{core}, and may include cladding on the sides of one or more of the patterned planar waveguide core 143_{core} and other features patterned from all or a portion of the planar waveguide core layer 105s_{core}. In some embodiments, top cladding layer 143_{cladding} may be one or more of silicon oxide and silicon oxynitride. Other alloys comprising silicon, oxygen, and other elements may also be used in some embodiments. In other embodiments, a polymer layer may be used to form top cladding layer 143_{cladding}. In embodiment, the refractive index of the top cladding layer 143_{cladding} may have a similar refractive index of the bottom cladding 105s_{cladding}. In other embodiments, the refractive index of the top cladding 143_{cladding} is lower than that of the patterned planar waveguide core layer 143_{core}, but differs from that of the bottom cladding layer 105s_{cladding}.

Steps 184-1 to 184-5 constitute steps of method 184 for the formation of submount wafer 112s having a self-aligned patterned planar waveguide core 143_{core} and alignment features formed using a same patterned mask layer in the formation of embodiments as summarized in the flowchart of FIG. 5A. In some embodiments, one or more patterned planar waveguide cores 143_{core} may be formed in conjunction with the self-aligned alignment aids described herein.

Step 184-6 of method 184 is a forming step in which a third patterned mask layer 115-3 is formed comprising one or more patterned portions for the formation of one or more cavities 148 in submount 100. In embodiments, the one or more cavities 148 formed in submount 100 may include one or more optional alignment aids formed self-aligned with the patterned planar waveguide core 143_{core} and other alignment aids formed on submount 100. FIG. 6E1 and 6E2 show cross-sections corresponding to the location of Sections A-A′ and B-B′ of FIG. 4A after formation of third patterned mask layer 115-3. Third patterned mask layer 115-3 may be, for example, a multilayer mask having a hard mask portion and a photoresist mask portion. The upper layer of the multilayer first patterned mask layer 115-3 may be, for example, a photoresist layer that enables opening of a lower layer that is a hard mask. Hard masks may be used to facilitate the formation of deep cavities such as cavity 148, among others. Openings in the third patterned mask layer 115-3 are shown that enable the formation of cavity 147 within which the tongue-shaped lateral alignment aid 106 is formed; cavity 148 within which the optical device 102 may be mounted and within which the alignment pillars 134 are formed, and cavity 149s within which the fiducials 114s are formed in the embodiment. Cavities 147, 148, 149 are shown in FIG. 6F1.

Step 184-7 of method 184 is a patterning step in which submount 100 is patterned to form one or more cavity 148 each receptive to an optical device 102, one or more cavity 147 within which the first portion of a tongue and groove lateral alignment feature is formed, and optionally one or more cavities 149s within which a fiducial 114s is formed, wherein the cavity 148 for mounting an optical device includes one or more optional alignment pillars 134. FIG. 6F1 and 6F2 show cross-sections corresponding to the location of Sections A-A′ and B-B′ of FIG. 4A after formation of cavities 147,148,149 through cladding layers 143_{cladding}. Alignment pillars 134 formed in cavity 148 may include one or more of one or more of lateral and vertical alignment aids and may include alignment pillars patterned using the first patterned mask layer 115-1. One or more alignment pillars 134 may be a fiducial 114s. Alignment pillars 134 may be formed self-aligned with other alignment features as described in conjunction with FIG. 6B1 and 6B2 herein. In some embodiments, vertical alignment pillars may be formed in cavity 148 that are not formed self-aligned using first patterned mask layer 115-1. Not all vertical alignment pillars require self-alignment since the benefits of self-alignment are primarily to ensure lateral alignment.

Cavities 147,149, among others, may also be formed in some embodiments in addition to the cavity 148 having alignment pillars 134. FIG. 6F1 shows, for example, cavity 147 having tongue-shaped lateral alignment aid 106 and cavity 149 having fiducial 114s.

FIG. 6F2 shows facet 143_{facet} formed from patterned planar waveguide core layer 143_{core} at the intersection with the wall of cavity 148.

Step 184-8 of method 184 is a forming step in which a reflector base structure 157 is formed. In an embodiment, a reflector base structure 157 may be formed, for example, with a forming step in which a fourth patterned mask layer 115-4 is formed, a patterning step in which a substrate is patterned to form a reflector base structure 157, and a removing step in which the fourth patterned mask layer 115-4 is removed after formation of the reflector base structure 157. Fourth patterned mask layer 115-4 comprises a patterned portion for the formation of a reflector base structure 157. FIG. 6G1 and 6G2 show cross-sections corresponding to the location of Sections A-A′ and B-B′ of FIG. 4A after formation of fourth patterned mask layer 115-4. In the embodiment shown, an angled sidewall is provided in the fourth patterned mask layer 115-4 in the opening labeled, “opening for reflector base formation” as may be formed, for example, using a gray scale mask. Other methods of forming an angled sidewall in the fourth patterned mask layer 115-4 may also be used. Subsequent to the formation of the fourth patterned mask layer 115-4, in the embodiment shown, all or a portion of the planar waveguide layer comprising the cladding and core layers, is patterned to form a reflector base structure 157. FIG. 6H1 and 6H2 show cross-sections corresponding to the location of Sections A-A′ and B-B′ of FIG. 4A after patterning of the submount wafer 112s to form a reflector base structure 157. The angled sidewall in the fourth patterned mask layer 115-4 in the embodiment shown in FIG. 6G2 enables the formation of an angled surface for reflector base structure 157 for use in the formation of upturned mirror 158. Other methods of forming a reflector base structure 157 for use in an upturned mirror structure 158 may also be used. In the embodiment shown in FIG. 6H1 and 6H2, submount 100 is shown after removal of fourth patterned mask layer 115-4.

Step 184-9 of method 184 is a forming step in which a reflective layer 159 is formed on the reflector base structure 157. In an embodiment, reflective layer 159 may be formed on the reflector base structure 157, for example, with the use of a forming step in which a fifth patterned mask layer 115-5 is formed, a depositing step in which a reflective layer 159 is deposited or otherwise formed on the reflector base structure 157, and a removing step in which the fifth patterned mask layer 115-5 is removed after formation of the reflector layer 159 on the reflector base structure 157 to form upturned mirror structure 158. FIG. 6I1 and 6I2 show cross-sections corresponding to the location of Sections A-A′ and B-B′ of FIG. 4A after formation of a fifth patterned mask layer 115-5 on submount wafer 112s and after formation of reflector layer 159 on the reflector base structure 157. Fifth patterned mask layer 115-5 is formed comprising a patterned portion to facilitate the formation of a reflective layer 159 on the reflector base structure 157. A photoresist layer may be used, for example, to form fifth patterned mask layer 115-5. Aluminum, silver, gold, among other reflective metal layers may be used, for example, to form reflector layer 159. After formation of the reflector layer 159, excess reflector material is shown to reside on fifth patterned mask layer 115-5 in the embodiment. Subsequent to the formation of reflective layer 159, fifth patterned mask layer 115-5 and excess reflective layer 159 may be removed from the submount wafer 112s, for example, using a lift off process. FIG. 6J1 and 6J2 show cross-sections corresponding to the location of Sections A-A′ and B-B′ of FIG. 4A after removal of the fifth patterned mask layer 115-5 and the removal of excess reflector material from reflector layer 159 residing on the fifth patterned mask layer 115-5. Also shown in FIG. 6J1 and 6J2 are optional electrical contacts at the base of cavity 148 that may be provided to enable the formation of electrical contacts between conductive layers 132 in the electrical interconnect layer 133s and an optical device 102 that may be mounted in cavity 148.

Upturned mirror structure 158, as shown, for example, in FIG. 6J2, enables the receiving of an optical signal from an optical device 102 mounted in cavity 148 by an apparatus positioned to be receptive to the optical signal. An apparatus may be positioned, for example, to receive an optical signal to measure a characteristic of the reflected signal such as one or more of wavelength, frequency, power, amplitude, among other characteristics of the reflected optical signals. In some embodiments having an optical device 102 configured as a receiving device, upturned mirror 158 may be used to receive a signal from an apparatus positioned to provide an optical signal to the upturned mirror 158 that may then be received by the optical device 102 mounted in cavity 148.

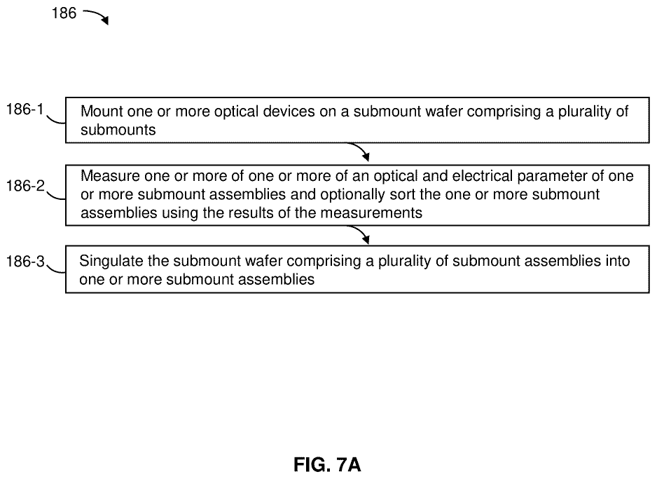

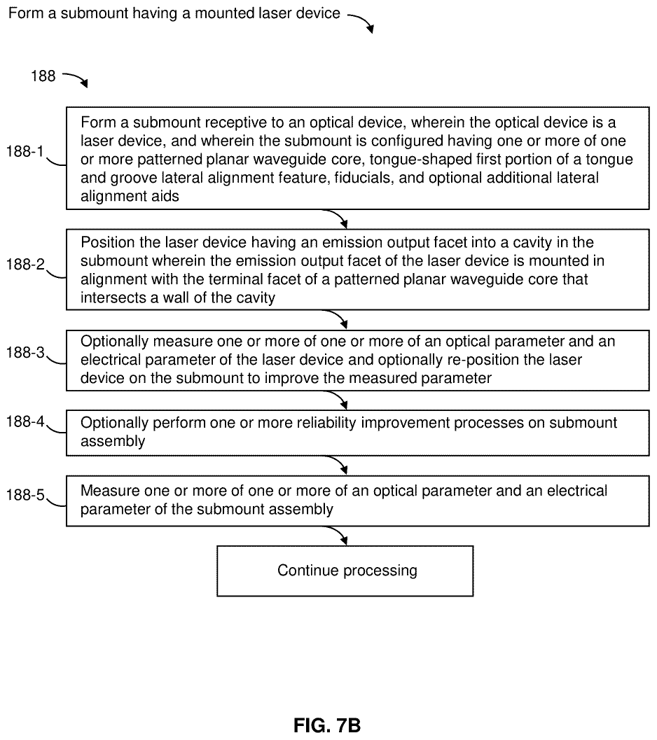

FIG. 7A shows a flowchart for a method 186 of forming embodiments of electrically tested and singulated submount assemblies 103 each comprising an embodiment of a submount 100 as shown, for example, in FIG. 6J1 and 6J2, and an optical device 102 mounted on the submount 100.

Step 186-1 of method 186 is a mounting step in which one or more optical devices 102 is mounted on a submount 100 to form a submount assembly 103. In embodiments, optical device 102 may be mounted in cavity 148 of submount 100.

Step 186-2 of method 186 is a measuring step in which one or more of one or more of an optical and electrical parameter of one or more submount assembly 103 is measured. Following the acquisition of a measurement of a parameter from one or more submount assemblies 103, the one or more submount assemblies 103 may be sorted or otherwise identified as having the measured parameter, and using the results of the measurements to enable, for example, the use of sorted or otherwise identified submount assemblies 103. Submount assemblies 103, may be sorted, for example, by the output power, for example, among other properties, to facilitate the formation of optical interposer assemblies 104 that utilize the submount assemblies 103 having a specific range of output power. Submount assemblies 103 that do not meet the output power requirements may not be used in the formation of optical interposer assemblies, for example, that do not meet the output power requirements specified for a particular application. The measurement of a characteristic parameter of the submount assemblies 103, may further enable burn-in, for example, of the submount assembly 103, and other treatment methods for testing, characterizing, improving, and otherwise qualifying submount assemblies 103 prior to their use in larger assemblies, such as optical interposer assemblies 104.

Step 186-3 of method 186 is a singulation step in which submount wafer 112s comprising one or more submount assemblies 103 is singulated into discrete die. Singulation of submount wafer 112s enables the separation of the individual submount assemblies 103 into die that can be mounted into larger assemblies such as optical interposer assembly 104, for example.

FIG. 7B shows a flowchart for a method 188 of forming other embodiments of electrically tested and singulated submount assemblies 103 each comprising an embodiment of a submount 100 as shown, for example, in FIG. 6J1 and 6J2 and an optical device 102 mounted on the submount 100, wherein the optical device is configured as a laser device.

Step 188-1 of method 188 is a forming step in which a submount 100, receptive to an optical device 102, is formed wherein the optical device 102 is configured as a laser device 102ₗₐₛₑᵣ, and wherein the submount 100 is configured having one or more of one or more patterned planar waveguide core 143_{core}, tongue-shaped first portion of a tongue and groove lateral alignment feature 109, fiducial 114s, and optional additional lateral alignment aids. Electrical contacts and vertical alignment aids may also be provided in some embodiments.

Step 188-2 of method 188 is a positioning step in which a laser device 102ₗₐₛₑᵣ having an emission facet is positioned within a cavity 148 of a submount 100 wherein the output facet of the laser device 102ₗₐₛₑᵣ is mounted in alignment with the terminal facet 143_{facet} of a patterned planar waveguide core 143_{core} of the patterned planar waveguide 143 that intersects the wall of the cavity 148 of the submount 100.

Step 188-3 of method 188 is an optional measuring step in which one or more of one or more of an electrical and an optical parameter of the laser device 102ₗₐₛₑᵣ is measured and wherein the laser device 102ₗₐₛₑᵣ is optionally repositioned on the submount 100. Laser device 102ₗₐₛₑᵣ may be repositioned, for example, after measurement, in an attempt to improve the outcome of the measurement through, for example, improved coupling of the laser device 102ₗₐₛₑᵣ, among other potential improvement that may be achieved with the repositioning of the laser device 102ₗₐₛₑᵣ on the submount 100.

Step 188-4 of method 188 is an optional performing step in which one or more reliability improvement steps are performed on one or more submount assembly 103 of submount wafer 112s. Reliability improvement steps may be, for example, exposure of the one or more submount assemblies 103 to one or more of an annealing step, a voltage applied to the laser device 102ₗₐₛₑᵣ, a current applied to the laser device 102ₗₐₛₑᵣ, an aging test, among other forms of reliability improvements steps that may be used, for example, to identify and eliminate early-life failures and that may be used to improve the reliability of the submount assemblies 103.

Step 188-5 of method 188 is a measuring step in which one or more of one or more of an optical parameter and an electrical parameter of submount assembly 103 is measured. Measurement of one or more electrical and optical parameters of the submount assembly 103 enables sorting of the assembled submount assemblies 103 after burn-in enables sorting of the completed submount assemblies 103 by the measured parameter which then enables these measured submount assemblies 103 to be utilized based on the measured parameter. In some embodiments, submount assemblies 103 having an electrical parameter with a range of values may be required, for example. Measurements of this electrical parameter enable the use of only those devices having an electrical parameter within this range to be used. Other embodiments of submount assemblies 103 may require other electrical and optical parameters to be used.

Step 188-6 of method 188 is a singulation step in which the submount wafer 112s is singulated into one or more discrete submount assemblies 103.

FIG. 8A1 shows the cross-sectional schematic drawings from Section A-A′ of an embodiment of a submount assembly 103 comprising the submount 100 of FIG. 4A and an optical device 102 mounted in the optical device mounting cavity 148 of the submount 100. FIG. 8A2 shows the cross-sectional schematic drawings from Section B-B′ of an embodiment of a submount assembly 103 comprising the submount 100 of FIG. 4A and optical device 102 mounted in the optical device mounting cavity 148 of the submount 100 wherein the path of an optical signal is shown from the optical device 102 mounted in the cavity 148 to the patterned planar waveguide core 143_{core} of the submount 100 and further incident on the upturned mirror 158 in the embodiment.

Singulation trenches 160 are shown that may be used in the embodiment of FIG. 8A1 and 8A2 to form discrete submount assemblies 103. In some embodiments, the submount wafer 112s may be mounted on a polymeric film, for example, or other carrier substrate to facilitate the singulation process. Methods of singulating substrates into discrete devices are known in the art of semiconductor processing and include deep etch singulation processes, may include dicing processes, and may include etching processes coupled with back grinding of the substrate, among other processes.

FIG. 8A1 shows optical device 102 mounted in cavity 148. Placement of optical device 102 may be facilitated using automated pick-and-place apparatus which may use, for example, fiducial 114s as a reference to position optical device 102.

FIG. 8A2 shows a voltage applied to electrical contact 130. Voltage from a first portion of a test apparatus 166a applied to electrical contact 130, in the embodiment of the optical device 102 being an emission device, causes the optical device 102 to output an optical signal that is coupled from the optical device 102 to the patterned planar waveguide core 143_{core} and subsequently to the upturned mirror 158. A spot size converter may be formed at the terminal end of the patterned planar waveguide core to facilitate the transfer of the optical signal from the optical device 102 configured as an emitting device to the patterned planar waveguide core 143_{core}. A secondary contact may also be provided, for example, in the cavity 148 or on the topside of the optical device 102. The reflected signal may be detected using a second portion of a test apparatus 166b. Detection of the optical signal using second portion of test apparatus 166b shows an example configuration for measuring an optical parameter of the submount assembly 103 shown schematically in FIG. 8A2

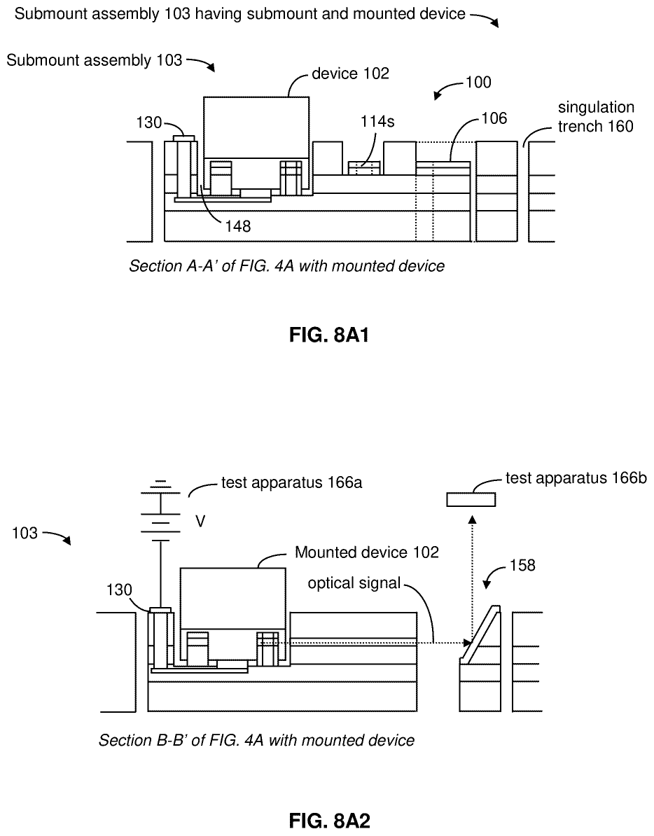

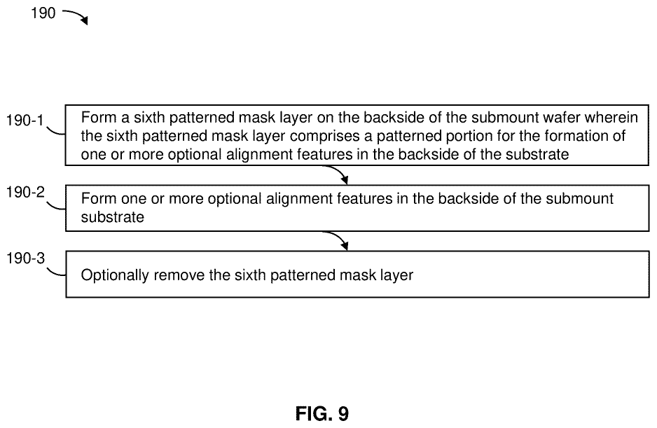

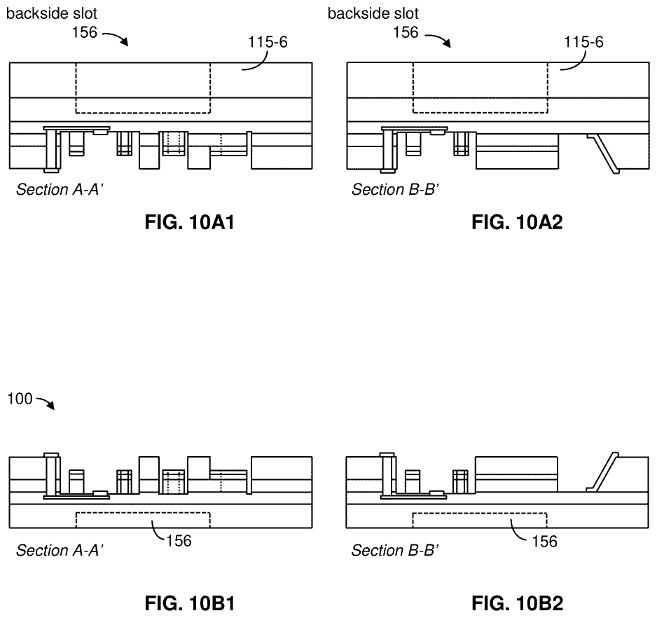

FIG. 9 shows a flowchart for a method 190 of forming embodiments of submount 100 having a backside alignment slot feature 156. Backside alignment slot feature 156 formed on the backside of the submount 100 enables the alignment of the submount 100 in complementary assemblies configured to be receptive to the backside alignment slot feature 156. Method 190 is described in conjunction with FIG. 10A1-10A2 and FIG. 10B1-10B2.

FIG. 10A1-10A2 and 10B1-10B2 show cross-section schematic drawings that illustrate some steps in the formation of an embodiment of a submount assembly 103 having backside alignment slot feature 156.

Step 190-1 of method 190 is a forming step in which a sixth patterned mask layer 115-6 is formed on the backside of the submount wafer 112s wherein the sixth patterned mask layer comprises a patterned portion for the formation of one or more alignment features in the backside of the substrate 110s. Patterned sixth mask layer 115-6 may be formed, for example, on the backside of submount wafer 112s following the formation of a plurality of submounts 100 formed on submount wafer 112s shown in FIG. 6J1 and 6J2. Patterned portions of the sixth patterned mask layer 115-6 facilitate the formation of one or more optional alignment features in the backside of the submount wafer 112s.

Step 190-2 of method 190 is a forming step in which one or more backside alignment slot features 156 are formed in the backside of the submount substrate 110s of the submount wafer 112s. Backside alignment slot features 156 may be formed, for example, using a suitable etching process to remove the substrate material from the openings in the patterned mask layer 115-6.

FIG. 10A1 and 10A2 show cross-section schematic drawings of sixth patterned mask layer 115-6 having patterned portions to facilitate the formation of the backside alignment slot features 156, and further show the formed backside alignment slot features 156 in the submount substrate 110s.

Sections A-A′ and Section B-B′ are shown for reference from the embodiment shown in FIG. 4A prior to singulation of the submount wafer 112s, although the backside alignment slot features are not shown in the embodiment of Sections A-A′ and Section B-B′ of FIG. 4A. Projections of the openings in the sixth patterned mask layer 115-6 to facilitate the formation of the backside alignment slot features and the backside alignment slot features 156 are shown in dashed lines, as these features are out of plane of Sections A-A′ and Section B-B′ of FIG. 4A.)

Step 190-3 of method 190 is a removing step in which the sixth patterned mask layer 115-6 is removed from the submount wafer 112s.

FIG. 10B1-10B2 show cross-sectional schematic drawings of submount 100 after formation of the backside alignment slot features 156 and the removal of the sixth patterned mask layer 115-6. Coupling of the backside alignment slot feature 156 shown in FIG. 10B1-10B2 to complementary rail-shaped alignment features formed in cavity 150 of optical interposer 101 is shown in more detail herein in conjunction with the description of embodiments of optical interposer 101 having complementary rail shaped alignment features formed in cavity 150 and in conjunction with the description of embodiments of optical interposer assemblies 104 that utilize these alignment features.

Submount 100 having tongue-shaped lateral alignment features 106 enables coupling to a substrate having a complementary cavity receptive to the submount 100 such as optical interposer 101 having complementary groove-shaped lateral alignment features 108 in cavity 150. Optical interposer 101, in embodiments, is formed having groove-shaped lateral alignment features 108 formed self-aligned with patterned planar waveguide core 144_{core} to enable alignment of the patterned planar waveguide core 143_{core} of the submount 100 to the patterned planar waveguide core 144_{core} of the optical interposer 101 upon mounting of submount assembly 103 having submount 100 and optical device 102 onto optical interposer 101 to form an optical interposer assembly 104.

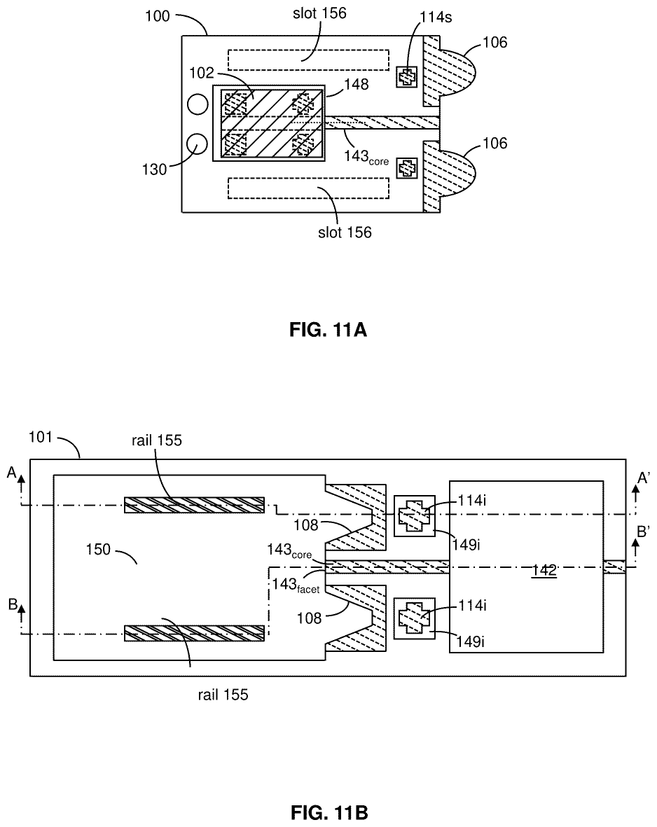

FIG. 11A shows a top view schematic drawing of the embodiment of submount 100 configured having backside alignment slot features 156 formed to be receptive to complementary alignment rail features 155 formed in cavity 150 of optical interposer 101 shown in FIG. 11B. Also shown in FIG. 11A is optical device 102 in cavity 148 of submount 100.

FIG. 11B shows a top view schematic drawing of an embodiment of optical interposer 101 receptive to the embodiment of the submount 100 shown, for example, in FIG. 11A. The embodiment of optical interposer 101 shown in FIG. 11B is configured having groove-shaped lateral alignment features 108 in the wall of cavity 150 and fiducials 114i in cavities 149i formed self-aligned with patterned planar waveguide core 144_{core}. Cavity 150 shown in FIG. 11B is further configured having alignment rail features 155 receptive to backside alignment slot features 156 formed in the embodiment of submount 100 shown, for example, in cross-section views of FIG. 10B1 and 10B2 and in the top view of FIG. 11A. Cavity 150 having groove-shaped lateral alignment features 108 is formed receptive to submount 100 having tongue-shaped lateral alignment features 106.

Optical interposer 101 in FIG. 11B is further shown configured having PIC 142 coupled to patterned planar waveguide core 144_{core}. PIC 142 may be one or more optical devices such as a waveguide, arrayed waveguide, grating, echelle grating, lens, among other optical devices, formed all or in part from planar waveguide layer 105, or other wise formed or mounted on optical interposer 101.

### Formation of Optical Interposer

In the following paragraphs, a method 192 is described for the formation of an embodiment of optical interposer 101.

Methods are then described for the formation of embodiments of optical interposer assemblies 104 comprising the embodiment of submount 100 shown in FIG. 11A and the embodiment of optical interposer 101 shown in FIG. 11B.

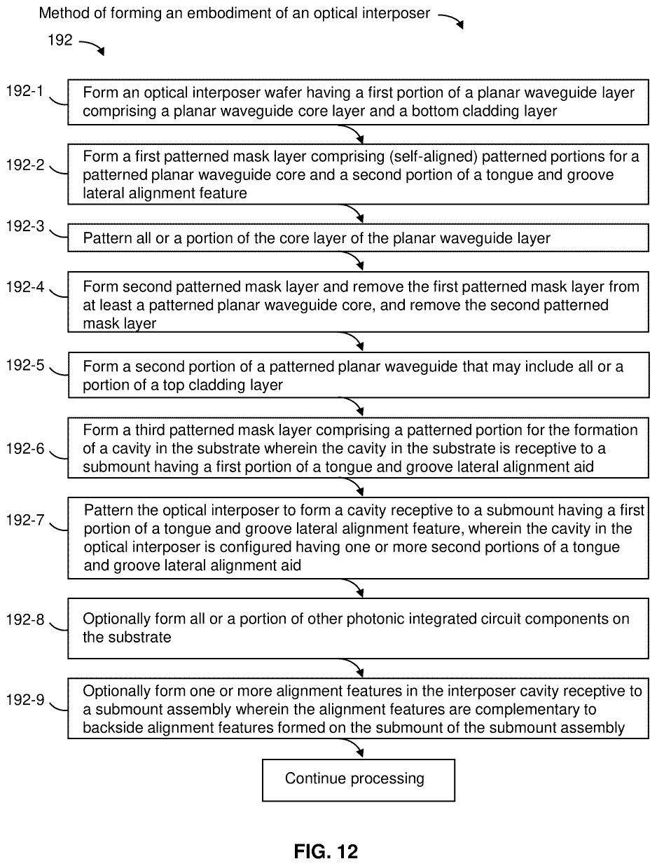

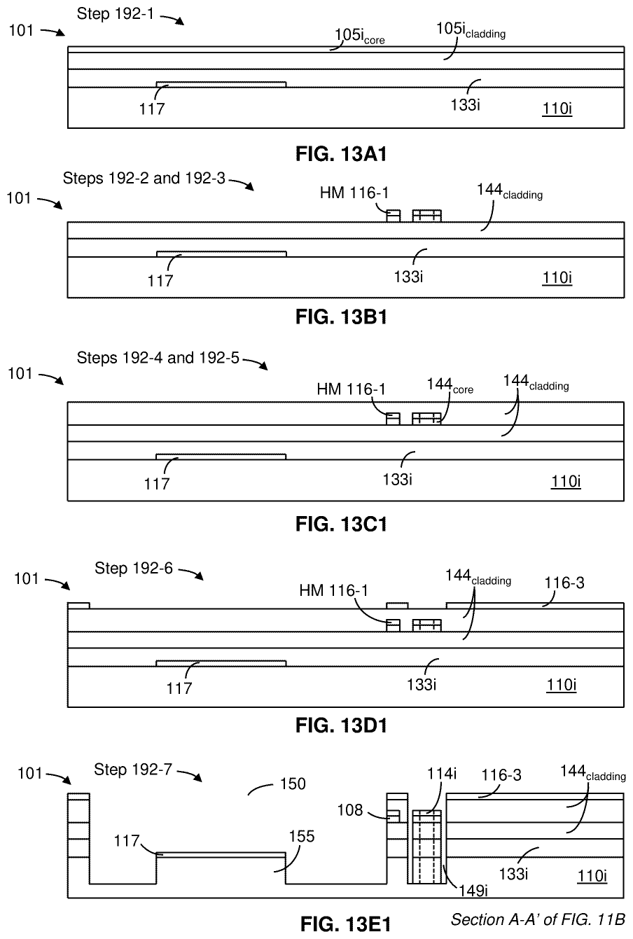

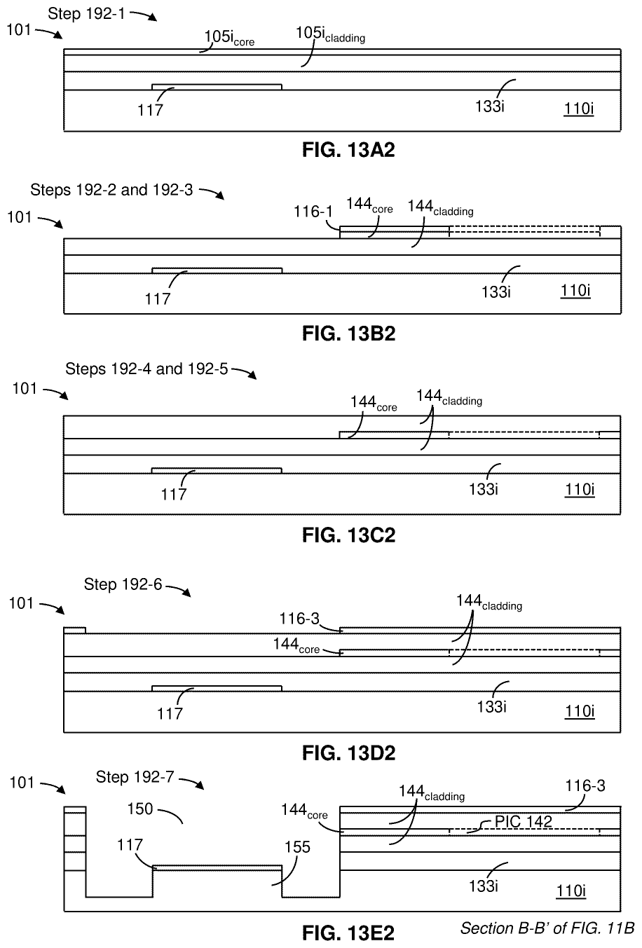

FIG. 12 shows a flowchart for a method 192 of forming an optical interposer 101 receptive to the embodiment of submount 100 shown, for example, in FIG. 10B1-10B2 and in FIG. 11A. The description of the steps in method 192 are described in conjunction with FIG. 13A1-13E1 and 13A2-13E2, that show a sequence of cross-sectional drawings that illustrate steps in the formation of an embodiment of optical interposer 101 receptive to the embodiment of submount 100 of FIG. 11A wherein the optical interposer 101 comprises self-aligned features that include a patterned planar waveguide core 144_{core} and groove-shaped lateral alignment aids 108 that form a second portion of a tongue and groove lateral alignment feature 109. FIG. 13A1-13D1 and 13A2-13D2 are cross-sections from Section A-A′ and Section B-B′, respectively, from FIG. 11B at various steps in the process of forming an embodiment of optical interposer 101. FIG. 13E1 and 13E2 show Section A-A′ and Section B-B′, respectively of the embodiment of optical interposer 101 shown in FIG. 11B.

Step 192-1 of method 192 is a forming step in which an optical interposer wafer 112i is formed having a first portion of a planar waveguide layer 105i comprising at least a planar waveguide core layer 105i_{core} and a planar waveguide bottom cladding layer 105i_{cladding}. FIG. 13A1 and 13A2 show cross-sectional schematic drawings of an embodiment of optical interposer 101 after forming step 192-1. Optical interposer wafer 112i shows unpatterned planar waveguide core layer 105i_{core} and bottom planar waveguide cladding layer 105i_{cladding} formed on an optional electrical interconnect layer 133i further formed on optical interposer substrate 110i. In the embodiment shown in FIG. 13A1 and 13A2, the embodiment includes optional 133i and further includes an optional buried patterned mask layer 117. Buried patterned mask layer 117, in the embodiment, includes patterned portions for the formation of alignment rail features 155 in cavity 150 to accommodate backside alignment slot features 155 as provided in the embodiment of submount 100 shown, for example, in FIG. 11A. In embodiments, planar waveguide core layer 105i_{core} may be formed from one or more of silicon, silicon oxide, silicon oxynitride, silicon nitride, among other materials. In some embodiments, a polymer may be used in the formation of planar waveguide core layer 105i_{core}. Planar waveguide core layer 105i_{core} may be a single layer in some embodiments. In other embodiments, planar waveguide core layer 105i_{core} may be comprised of one or more layers. In some embodiments, bottom cladding layer 105i_{cladding} may be one or more of silicon oxide and silicon oxynitride. Other alloys comprising silicon, oxygen, and other elements may also be used in some embodiments to form all or a portion of bottom cladding layer 105i_{cladding}. In other embodiments, a polymer layer may be used to form bottom cladding layer 105i_{cladding}. In embodiment, the refractive index of the bottom cladding layer 105i_{cladding} is less than that of the planar waveguide core layer 105i_{core}.

Step 192-2 of method 192 is a forming step in which a first patterned mask layer 116-1 is formed having patterned portions to facilitate formation of a patterned planar waveguide core 144_{core} and a second portion of a tongue and groove lateral alignment feature 109. In the embodiment of the optical interposer 101 shown in FIG. 13B1 and 13B2, the second portion is a groove-shaped lateral alignment feature 108 of tongue and groove lateral alignment feature 109. The groove-shaped lateral alignment aid 108 is formed complementary to the tongue-shaped lateral alignment feature 106 of submount 100 in embodiments of optical interposer assemblies 104 having complementary submount 100 and optical interposer 101. First patterned mask layer 116-1 may include patterned portions for other device features and alignment features, among other features, in addition to the patterned portions for a patterned planar waveguide core 144_{core} and a groove-shaped lateral alignment feature 108 of tongue and groove lateral alignment feature 109. Other alignment features may include, for example, one or more fiducials formed self-aligned with the patterned planar waveguide cores 144_{core} using first patterned mask layer 116-1. Other lateral alignment features may also be formed in self-alignment using first patterned mask layer 116-1.

Step 192-3 of method 192 is a patterning step in which all or a portion of the planar waveguide core layer 105i_{core} is patterned to form patterned planar waveguide core 144_{core} and, in the embodiment shown in FIG. 13C1 and 13C2, groove-shaped lateral alignment aid 108. The groove-shaped lateral alignment aid 108 is formed self-aligned (from the same patterned mask layer) with the patterned planar waveguide core 144_{core}. Optionally all or a portion of the planar waveguide bottom cladding layer 105 may also be patterned in step 192-3.

Step 192-4 of method 192 is a forming and removing step in which a second patterned mask layer 116-2 is formed on the optical interposer 101 and the first patterned mask layer 116-1 is removed from at least a patterned planar waveguide core 144_{core}. Removal of the first patterned mask layer 116-1 from the patterned planar waveguide core 144_{core} enables the formation of a top cladding layer directly on the patterned core layer. In some embodiments, a metal hard mask may be used to form the first patterned mask layer 116-1 and the presence of a metal layer on the patterned planar waveguide core 144_{core} may interfere with the propagation of optical signals in waveguides formed using the patterned planar waveguide core 144_{core} after the addition of the top cladding layer 144_{cladding}. After removal of the first patterned mask layer 116-1 from the patterned planar waveguide core 144_{core}, the second patterned mask layer 116-2 may also be removed.

Step 192-5 of method 192 is a forming step in which a second portion of a patterned planar waveguide layer is formed on the patterned first portion of planar waveguide layer 105 wherein the second portion comprises all or a portion of a top cladding layer 144_{cladding}. The patterned first portion of planar waveguide layer 105 forms patterned planar waveguide core 144_{core} and the second portion of planar waveguide layer together form patterned planar waveguide 144 having patterned planar waveguide core 144_{core}, bottom cladding layer 144_{cladding}, and top cladding layer 144_{cladding}. FIG. 13C1 and 13C2 show an embodiment of optical interposer 101 after Step 192-5 of method 192. In some embodiments, top cladding layer 144_{cladding} may be one or more of silicon oxide and silicon oxynitride. Other alloys comprising silicon, oxygen, and other elements may also be used in some embodiments. In other embodiments, a polymer layer may be used to form top cladding layer 144_{cladding}. In embodiment, the refractive index of the top cladding layer 144_{cladding} may have a similar refractive index of the bottom cladding 105i_{cladding}. In other embodiments, the refractive index of the top cladding 144_{cladding} is lower than that of the patterned planar waveguide core layer 144_{core} but differs from that of the bottom cladding layer 105i_{cladding}.

Step 192-6 of method 192 is a forming step in which a third patterned mask layer 116-3 is formed on the optical interposer wafer 112i wherein the third patterned mask layer 116-3 comprises a patterned portion for the formation of cavity 150 in the optical interposers 101, and wherein cavity 150 in the optical interposers 101 using third patterned mask layer 116-3 is receptive to the mounting of an embodiment of submount 100 having a first portion of a tongue and groove lateral alignment feature 109. Third patterned mask layer 116-3 in shown in the cross-sectional schematic drawings in FIG. 13D1 and 13D2.

Step 192-7 of method 192 is a patterning step in which the optical interposer 101 is patterned to form a cavity 150 in the optical interposer 101 that is receptive to a submount 100 having a first portion of a tongue and groove lateral alignment feature 109, wherein the cavity 150 in the optical interposer 101 is configured having one or more second portions of the tongue and groove lateral alignment feature 109. Patterning of the optical interposer 101 to form cavity 150 may include the patterning of one or more of the top cladding layer 144_{cladding} and bottom cladding layer 144_{cladding}, the optional electrical interconnect layer 133i, if present, and the optical interposer substrate 110i. One or more cavities 149i within which a fiducial 114i is provided may also be formed. Other cavities may also be formed. Cavity 150 having optional alignment rail structures 155 are shown in the cross-sectional schematic drawings in FIG. 13E1 and 13E2. Fiducial 114i formed in cavity 149i is also shown. Cavity 150, having groove-shaped lateral alignment aids 108, is receptive to the embodiment of the submount 100 having tongue-shaped lateral alignment aid 106 shown in FIG. 11A.

Step 192-8 of method 192 is an optional forming step in which all or a portion of other photonic integrated circuit components are formed on optical interposer 101. In some embodiments, PIC 142 may include one or more of one or more optical and electrical devices such as waveguides, lenses, gratings, arrayed waveguides, echelle gratings, among other devices, that may be made wholly or in part from a portion of the planar waveguide layer 105. PIC 142 is shown, for example, in the top view of the embodiment of optical interposer 101 in FIG. 11B.

Step 192-9 of method 192 is an optional forming step in which one or more alignment features are formed in the optical interposer cavity 150 that are receptive to a submount assembly 103 wherein the alignment features in the cavity 150 are complementary to backside alignment features formed on the submount 100 of the complementary submount assembly 103. In the embodiment shown in FIG. 13E1 and 13E2, alignment rail features 155 are shown in cavity 150 that are complementary to the backside alignment slot features 156 for the embodiment of the submount 100 shown in FIG. 11A, for example. Other complementary alignment features may be formed in cavity 150 to accommodate other embodiments of backside alignment features formed in other embodiments of submounts 100.

Embodiments of optical interposer 101 having second portions of lateral alignment aid 109 may be used in the formation of optical interposer assemblies 104 having optical interposer 101 and submount assemblies 103. Some embodiments of optical interposer assembly 104 are provided in the following section with some example methods of formation.

### Formation of Embodiments of Optical Interposer Assembly

In the following paragraphs, method 194 for the formation of embodiments of an optical interposer assembly 104 comprising submount assembly 103 and optical interposer 101 having groove-shaped lateral alignment features 108 formed self-aligned with the patterned planar waveguide core 144_{core} is described.

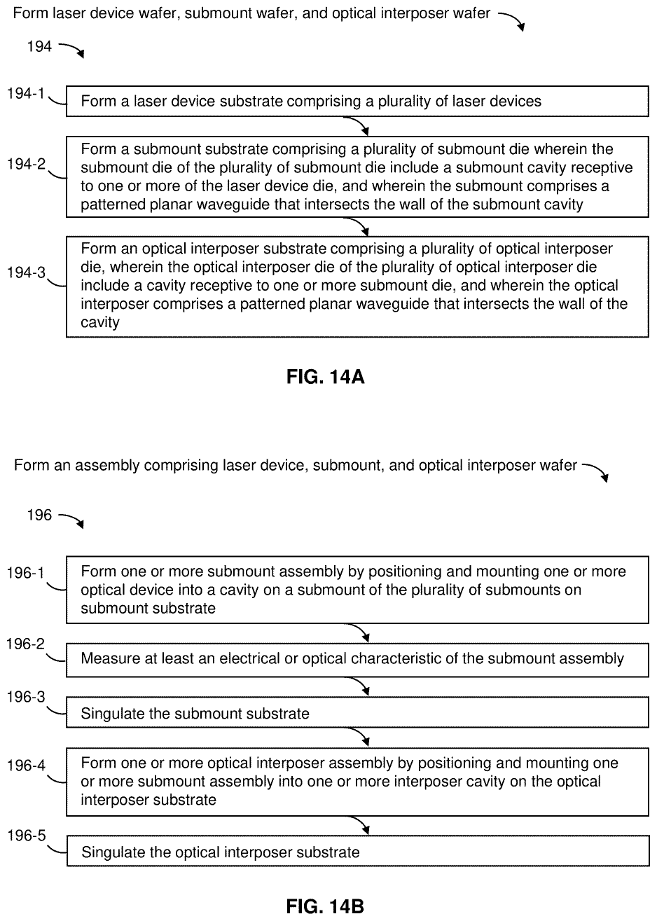

FIG. 14A shows a flowchart for a method 194 for the formation of an optical device wafer 112d comprising a plurality of laser devices, a submount wafer 112s comprising a plurality of submounts 100, and an optical interposer wafer 112i comprising a plurality of optical interposers.

Step 194-1 of method 194 is a forming step in which an optical device wafer 112d is formed comprising a plurality of optical devices 102. An embodiment of optical device wafer 112d is shown in FIG. 3A.

Step 194-2 of method 194 is a forming step in which a submount wafer 112s is formed comprising a plurality of submounts 100. An embodiment of submount wafer 112s is shown in FIG. 3B.

Step 194-3 of method 194 is a forming step in which an optical interposer wafer 112i is formed comprising a plurality of optical interposers 101. An embodiment of optical interposer wafer 112i is shown in FIG. 3C.

Optical device wafer 112d, submount wafer 112s, and optical interposer wafer 112i may be used in embodiments to form optical interposer assemblies 104.

FIG. 14B shows a flowchart for a method 196 for the formation of an embodiment of an optical interposer assembly 104 comprising optical interposer 101 and submount assembly 103 further comprising submount 100 and optical device 102.

Step 196-1 of method 196 is a forming step in which a submount assembly 103 is formed by positioning and mounting one or more optical devices 102 into one or more cavities 148 on a submount 100. In embodiments, the optical axis of each optical device 102 is mounted in alignment with the optical axis of a terminal end of a patterned planar waveguide core 144_{core} that intersects the wall of the cavity 148 within with the optical device 102 is mounted. In some embodiments for which the optical device is configured having an emission facet, the emission facet of an optical device 102 mounted in a cavity 148 may be positioned in alignment with facet 143_{facet} of a patterned planar waveguide core 143_{core} that intersects the wall of the cavity 148 within which the optical device 102 is mounted.

Step 196-2 of method 196 is a measuring step in which at least an electrical or optical characteristic of the submount assembly 103 is measured. Measurement of at least an electrical or optical characteristic of the submount assembly 103 enables sorting of the submount assemblies 103 from a plurality of submount assemblies 103 that may then be utilized, for example, based on the outcome of the measured characteristic. In an embodiment, the output power may be measured, for example, from a submount assembly 103 wherein the optical device 102 of the submount assembly 103 is configured as a laser diode, and the utilization of the submount assembly 103 may be limited to optical interposer assemblies 104 for which the measured output power is deemed to fall within a range of acceptable power levels. Other measured characteristics of submount assemblies 103 may also be used to enable sorting of the measured submount assemblies 103 for utilization after measurement.

Step 196-3 of method 196 is a singulation step in which the submount wafer 112s is singulated. Singulation of the submount wafer 112s into a plurality of discrete submount assemblies 103 enables the submounts 100 to be mounted into optical interposer 101 to form optical interposer assemblies 104.

Step 196-4 of method 196 is a forming step in which one or more optical interposer assemblies 104 are formed by positioning and mounting one or more submount assembly 103 into one or more optical interposer cavity 150 on an optical interposer wafer 112i.

Step 196-5 of method 196 is a singulation step in which the optical interposer wafer 112i is singulated into discrete optical interposer assemblies 104.

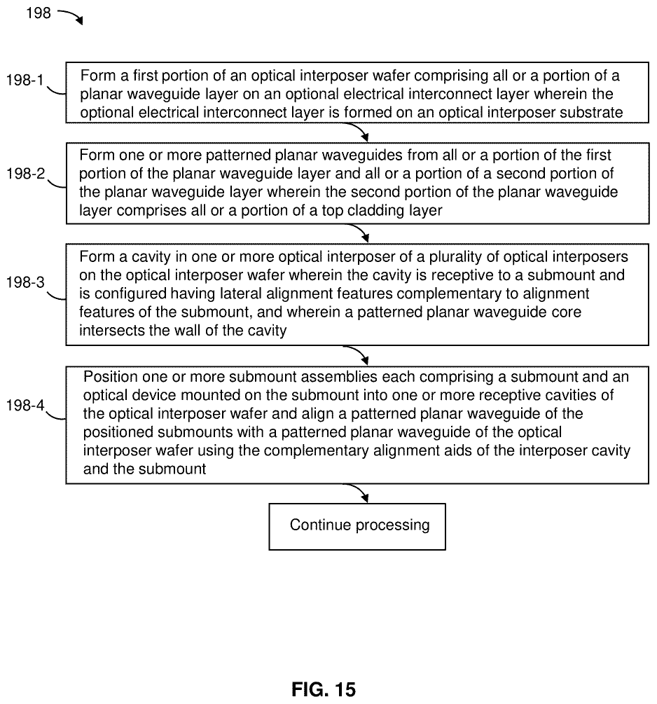

FIG. 15 shows a flowchart for a method 198 of forming embodiments of optical interposer assembly 104 comprising submount assembly 103 and optical interposer 101 receptive to embodiments of submount 100.

Step 198-1 of method 198 is a forming step in which an optical interposer substrate 110i of an optical interposer wafer 112i is formed. Optical interposer substrate 110i comprises at least a planar waveguide core layer 105i_{core} and a planar waveguide bottom cladding layer 105i_{cladding} of a planar waveguide layer 105 on a base structure wherein the base structure comprises an optional electrical interconnect layer 133i and an optical interposer substrate 110i.

Step 198-2 of method 198 is a forming step in which one or more patterned planar waveguides 144 are formed from all or a portion of the planar waveguide layer 105 wherein the patterned planar waveguides 144 comprise a patterned planar waveguide core 144_{core} and one or more planar waveguide cladding layers 144_{cladding} on one or more of the top, side, and bottom of the patterned planar waveguide core layer 144_{core}.

Step 198-3 of method 198 is a forming step in which a cavity 150 is formed in one or more optical interposer 101 of a plurality of optical interposers 101 on the optical interposer wafer 112i wherein the cavity 150 is receptive to submount 100 and wherein the cavity 150 is configured having lateral alignment features complementary to lateral alignment features of the submount 100, and wherein a patterned planar waveguide core 144_{core} intersects the wall of the cavity 150.

In an embodiment, cavity 150 may be formed having groove-shaped lateral alignment features 108 complementary to tongue-shaped lateral alignment features 106 of submount 100. The coupling of the groove-shaped lateral alignment features 108 of the cavity with the complementary tongue-shaped lateral alignment features 106 of submount 100, enables alignment of the patterned planar waveguide core 144_{core} that intersects the wall of the cavity 150 formed on the optical interposer 101 with a patterned planar waveguide core 143_{core} formed on the submount 100.

Step 198-4 of method 198 is a positioning and aligning step in which a submount assembly 103 comprising submount 100 and an optical device 102 mounted on the submount 100 is positioned into the receptive cavity 150 of an optical interposer 101 of the plurality of optical interposers 101 on the optical interposer wafer 112i and after positioning, a patterned planar waveguide core 143_{core} of the submount 100 in the submount assembly 103 is aligned with the patterned planar waveguide core 144_{core} of the optical interposer 101 using the complementary groove-shaped lateral alignment aids 108 of the optical interposer cavity 150 and the tongue-shaped lateral alignment aids 106 of the submount 100.

Continued processing of the optical interposer assemblies 104 on optical interposer wafer 112i may follow step 198-4 of method 198. Continued processing may include, for example, the formation of electrical interconnections between electrical contacts 130 formed on optical interposer 101 and electrical contacts 130 formed on submount 100. Continued processing may also include, for example, the formation of thermal connections between optical interposer 101 and submount 100. Continued processing may include, for example, the measurement of an electrical property to assess the performance of all or a portion of the optical interposer assembly 104. Other forms of continued processing may also be performed on one or more of the optical interposer assembly 104 and submount assemblies 103 provided therein.

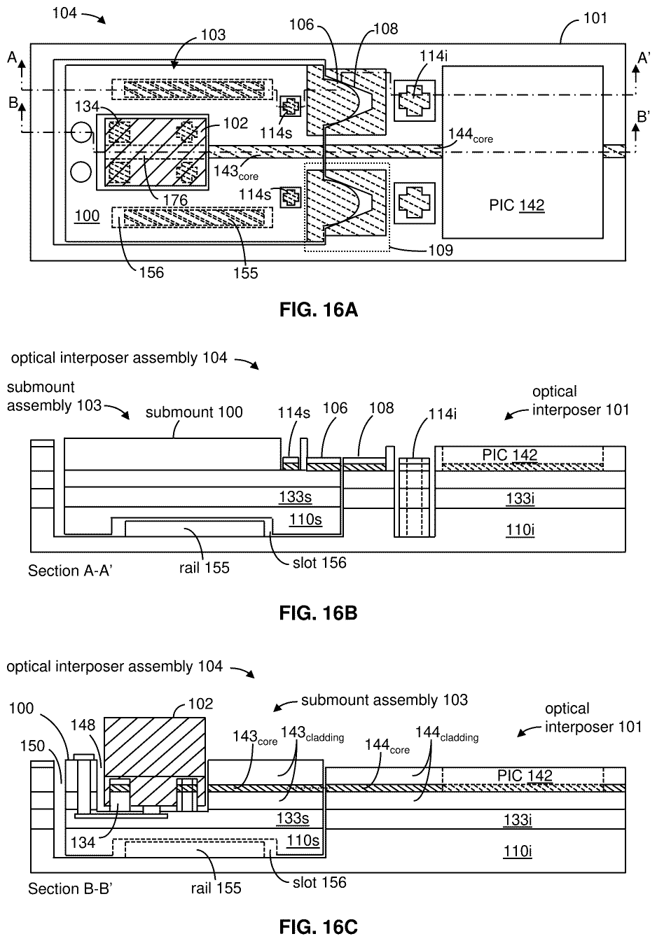

Embodiments of optical interposer assembly 104 are shown in FIGS. 16A-16C.

FIG. 16A shows a schematic top view of an embodiment of optical interposer assembly 104 comprising optical interposer 101 and submount assembly 103. FIGS. 16B and 16C show cross-sectional drawings through Section A-A′ and Section B-B′, respectively, of FIG. 16A.

FIGS. 16A and 16C show the alignment of a waveguide 176 of optical device 102 of submount assembly 103 with the patterned planar waveguide core 143_{core} of the submount 100. Submount 100 in the embodiment, is configured having tongue-shaped lateral alignment aids 106 that form a contact with groove-shaped lateral alignment aids 108 to align the patterned planar waveguide core 143_{core} of the submount 100 with the patterned planar waveguide core 144_{core} of the optical interposer 101. FIGS. 16A and 16B show the combined tongue and groove lateral alignment feature 109 comprising the tongue-shaped lateral alignment aid 106 of the submount 100 and the groove-shaped lateral alignment aid 108 of the optical interposer 101. Tongue and groove lateral alignment feature 109 is shown enclosed in a rectangular dotted line enclosure labeled “109”. Fiducials 114s on the embodiment of submount 100, shown in FIGS. 16A and 16B, are formed self-aligned with the tongue-shaped lateral alignment aids 106 and the patterned planar waveguide core 143_{core} of the submount 100, and in the embodiment, are formed self-aligned with the alignment pillars 134 in cavity 148. Fiducials 114i on the optical interposer 101, formed self-aligned with the groove-shaped lateral alignment aids 108 and the patterned planar waveguide core 144_{core} of the optical interposer 101, are also shown in FIGS. 16A and 16B. Cavity 150, the cavity on the optical interposer 101 that is receptive to the submount 100, is shown in the embodiment configured having alignment rail features 155. Alignment rail features 155 of the cavity 150 of optical interposer 101 are receptive to backside alignment slot features 156 formed in the submount 100. Alignment rail features 155 and backside alignment slot features 156 enable the guided movement of the submount 100 into an aligned position as the tongue-shaped lateral alignment aid 106 is moved into position within the groove-shaped lateral alignment aid 108 of the optical interposer 101.

### Multiple Die Submounts

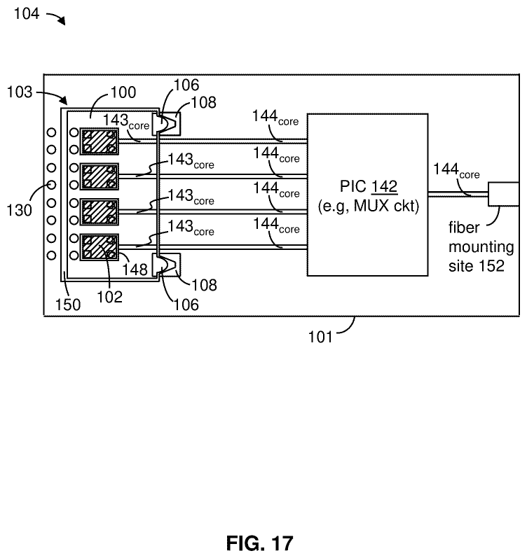

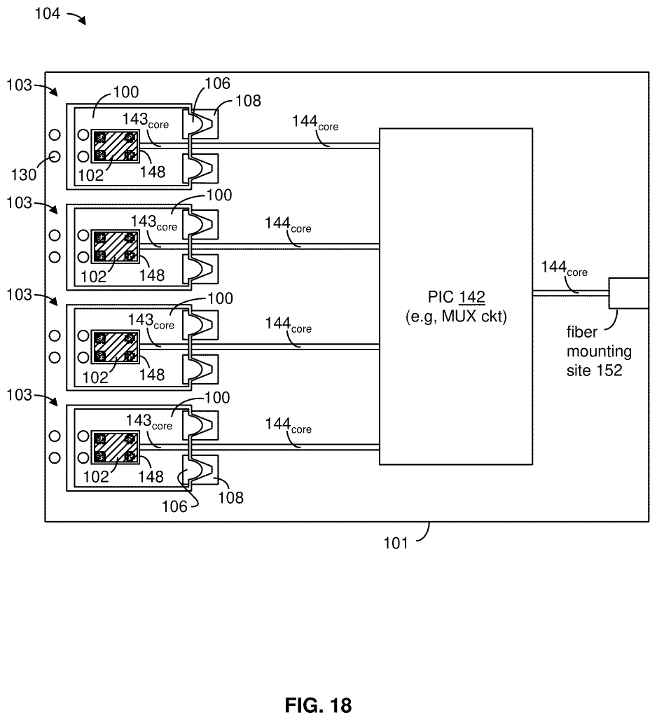

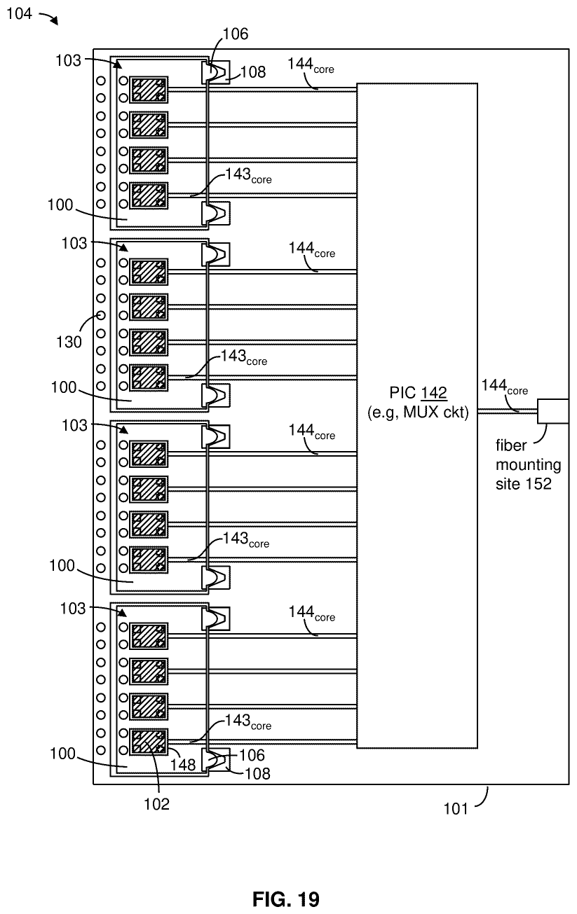

The embodiment of the optical interposer assembly 104 shown in FIGS. 16A-16C is configured having a single optical device 102 and a single patterned planar waveguide core 143_{core} coupled to a single patterned planar waveguide core 144_{core} of optical interposer 101. In other embodiments, submount 100 may be configured having a plurality of optical devices 102 as shown, for example in FIG. 17. In yet other embodiments, optical interposer 101 may be configured having a plurality of submount assemblies 103 as shown, for example, in FIGS. 18 and 19. And in yet other embodiments, submount 100 may be configured having a plurality of optical device types such as, for example, an isolator, a modulator, a lens, a waveguide, among other types of optical devices that may be used in combination with optical device 102 mounted in cavity 148 of submount 100.

FIG. 17 shows a top view schematic drawing of an embodiment of optical interposer assembly 104 comprising optical interposer 101 and a submount assembly 103 wherein the submount assembly 103 further comprises submount 100 and a plurality of mounted devices 102. The embodiment of optical interposer assembly 101 in FIG. 17, is shown configured having four optical devices 102 each mounted in a cavity 148. Optical devices 102 are mounted in alignment with a patterned planar waveguide core 143_{core} formed on the submount 100. Submount 100, shown configured having a tongue-shaped lateral alignment aid 106, is mounted in cavity 150 of optical interposer 101 having complementary groove-shaped lateral alignment aid 108. Coupling of tongue-shaped lateral alignment aid 106 of the submount 100 to the groove-shaped lateral alignment aid 108 of the optical interposer 101 facilitates the alignment of the patterned planar waveguide cores 143_{core} of the submount 100 with the patterned planar waveguide cores 144_{core} of the optical interposer 101. In the embodiment shown in FIG. 17, four patterned planar waveguide cores 144_{core} are shown in the embodiment, coupled to PIC 142. All or a portion of PIC 142 may be configured, for example, as a multiplexing circuit configured to receive optical signals from optical devices 102, configured as emitting devices, and to combine the optical signals from two or more of the optical devices into an outgoing optical signal that is output to a fiber mounting site 152 wherein an optical fiber may be mounted to receive the optical signal from the PIC 142 configured as a multiplexing device through an optional patterned planar waveguide core 144_{core}.

In embodiments of optical interposer assemblies 104 configured as shown in FIG. 17, one or more of one or more of an electrical and optical property of each of the plurality of optical devices 102 of submount assembly 103 may be obtained prior to mounting of the submount assembly 103 into cavity 150 of the optical interposer 101 to form optical interposer assembly 104. Measurement of one or more of one or more of an electrical and an optical property of the submount assembly 103 enables the use of prequalified submount assemblies 103 that may, for example, meet a predetermined criterion for inclusion into the optical interposer assembly 104. Use of pre-sorted submount assemblies 103 that have been evaluated prior to mounting in cavity 150 on optical interposer 101 to form optical interposer assemblies 104 can reduce waste and improve the yield of completed optical interposer assemblies 104 in comparison to optical interposer assemblies formed with optical devices 102 mounted onto the optical interposer 101 that have not been measured prior to mounting.

The embodiment of the optical interposer 101 shown in FIG. 17 is configured having four optical devices 102 mounted on submount 100. Other embodiments of submount 100 may be configured having two or more optical devices 102. In some embodiments, submount 100 may be configured, for example, having eight mounted devices 102. And in yet other embodiments, submount 100 may be configured having sixteen mounted devices 102.

FIG. 18 shows a top view schematic drawing of an embodiment of an optical interposer assembly 104 comprising optical interposer 101 and a plurality of submount assemblies 103 wherein each of the submount assemblies 103 further comprises a submount 100 and a mounted device 102.

The embodiment of optical interposer assembly 101 in FIG. 18, is shown configured having four submount assemblies 103 configured having a submount 100 and an optical device 102. Optical devices 102 are each mounted in a cavity 148 formed on a submount 100 in alignment with a patterned planar waveguide core 143_{core} that intersects the wall of the cavity 148. Each submount 100, shown configured having a tongue-shaped lateral alignment aid 106, is mounted in one of the four cavities 150 of optical interposer 101 having complementary groove-shaped lateral alignment aid 108 in the embodiment. Coupling of tongue-shaped lateral alignment aids 106 of the submounts 100 to the groove-shaped lateral alignment aids 108 of the cavities 150 of the optical interposer 101 facilitates the alignment of the patterned planar waveguide cores 143_{core} of the submounts 100 with one of the patterned planar waveguide cores 144_{core} of the optical interposer 101. In the embodiment shown in FIG. 18, four patterned planar waveguide cores 144_{core} are shown in the embodiment, coupled to PIC 142. All or a portion of PIC 142 may be configured, for example, as a multiplexing circuit configured to receive optical signals from optical devices 102, configured as emitting devices, and to combine the optical signals from two or more of the optical devices 102 into an outgoing optical signal that is output to a fiber mounting site wherein an optical fiber may be mounted to receive the optical signal from the PIC 142 configured as a multiplexing device through an optional patterned planar waveguide core 144_{core}. PIC 142 configured as a multiplexing device may be used in the formation of a transmitting device. PIC 142 may also be configured in other ways that benefit from coupling of submount assemblies 103 to one or more circuit element of PIC 142.

The embodiment of the optical interposer assembly 104 shown in FIG. 18 is configured having four submount assemblies 103 each comprising a submount 100 and an optical device 102. Other embodiments of optical interposer assembly 104 may be configured having two or more submount assemblies 103. In some embodiments, optical interposer assembly 104 may be configured, for example, having eight submount assemblies 103. And in yet other embodiments, optical interposer assembly 104 may be configured, for example, having sixteen submount assemblies 103.

FIG. 19 shows a top view schematic drawing of an embodiment of an optical interposer assembly 104 comprising an embodiment of optical interposer 101 and a plurality of submount assemblies 103 wherein each of the submount assemblies 103 in the embodiment further comprises an embodiment of submount 100 and a plurality of optical devices 102.

The embodiment of optical interposer assembly 101 in FIG. 19, is shown configured having four submount assemblies 103 each configured having a submount 100 and four optical devices 102. Optical devices 102 are each mounted in a cavity 148 formed on the embodiment of the submount 100 in alignment with a patterned planar waveguide core 143_{core} that intersects the wall of one of the cavities 148 formed on the submount 100. Each submount 100, shown configured having a tongue-shaped lateral alignment aid 106, is mounted in one of the four cavities 150 of optical interposer 101 having complementary groove-shaped lateral alignment aid 108 in the embodiment. Coupling of tongue-shaped lateral alignment aids 106 of the submounts 100 to the groove-shaped lateral alignment aids 108 of the cavities 150 of the optical interposer 101 facilitates the alignment of the four patterned planar waveguide cores 143_{core} of the submounts 100 with patterned planar waveguide cores 144_{core} on the optical interposer 101. In the embodiment shown in FIG. 19, sixteen patterned planar waveguide cores 144_{core} are shown coupled to PIC 142. All or a portion of PIC 142 may be configured, for example, as a multiplexing circuit configured to receive optical signals emitted all or in part from optical devices 102, configured as emitting devices, and to combine the optical signals from two or more of the optical devices 102 into an outgoing optical signal that is output to a fiber mounting site wherein an optical fiber may be mounted to receive the optical signal from the PIC 142 configured as a multiplexing device through an optional patterned planar waveguide core 144_{core}. Other configurations of PIC 142 may also be used in conjunction with embodiments of submount assemblies 103 to form other configurations of embodiments of optical interposer assemblies 104.

The embodiment of the optical interposer assemblies 104 shown in FIG. 19 is configured having four submount assemblies 103 each comprising a submount 100 and four optical devices 102. Other embodiments of optical interposer assembly 104 may be configured having two or more submount assemblies 103 wherein each submount assembly 103 may comprise two or more optical devices 102. In some embodiments, optical interposer assembly 104 may be configured, for example, having eight submount assemblies 103 each having two or more optical devices 102.

FIG. 17 shows an embodiment of an optical interposer assembly 104 comprising a submount 100 and a plurality of optical devices 102 mounted on the submount 100. FIG. 18 shows an embodiment of an optical interposer assembly 104 comprising a plurality of submount assemblies 103 wherein the plurality of submount assemblies 103 comprise a submount 100 and an optical device 102. FIG. 19 shows an embodiment of optical interposer assembly 104 comprising a plurality of submount assemblies 103 wherein each of submount assemblies 103 of the plurality of submount assemblies 103 comprise a submount 100 and a plurality of optical devices 102. The embodiments of the optical interposer assemblies 104 described in conjunction with FIGS. 17-19 provide example configurations of embodiments of optical interposer assemblies 104 having two or more submounts 100 wherein the submount assemblies 103 formed having submounts 100 further include one or more optical devices 102. Other embodiments of optical interposer assemblies 104 not specifically described in conjunction with the descriptions of FIGS. 17-19 are within the scope of embodiments described herein. Other embodiments of optical interposer assemblies 104 may be configured, for example, having two or more submounts 100 wherein the submount assemblies 103 formed from the submounts 100 comprise one or more optical devices 102.

Other embodiments of optical interposer assemblies 104 comprising submount assemblies 103 configured having a plurality of optical device types such as, for example, an isolator, a modulator, a lens, a waveguide, among other types of optical devices may be used in combination with optical device 102 mounted in cavity 148 of submount 100.

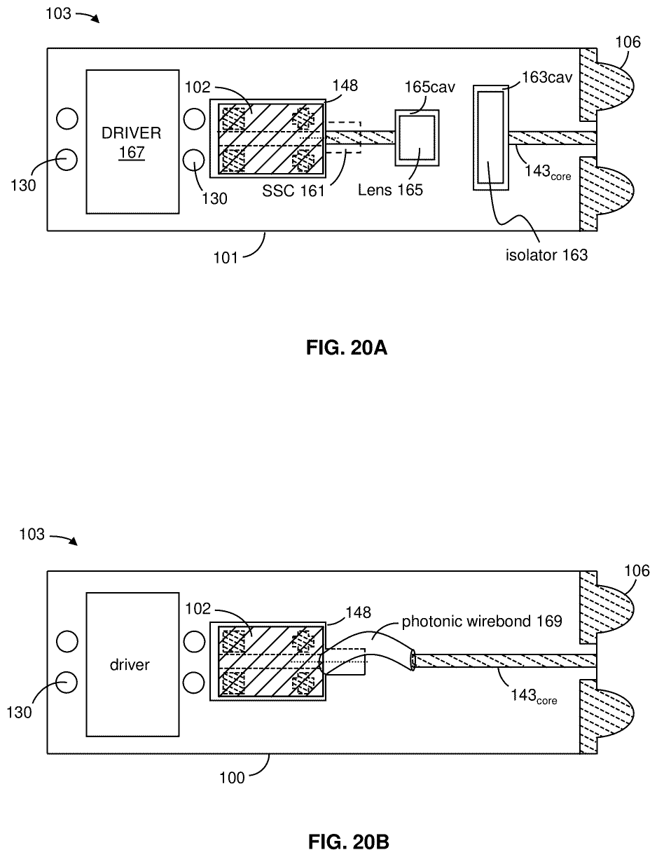

FIG. 20A shows a top view schematic drawing of an embodiment of a submount assembly 103 comprising an optical device 102 and an embodiment of a submount 100 and further comprising a plurality of other optical devices that include driver 167 for the optical device 102, spot size converter 161, lens 165, and optical isolator device 163. Embodiments of submount assemblies 103 described herein, may be configured having one or more other optical device in addition to optical device 102. Other types of other optical devices may also be used in other embodiments of submount assemblies 103 such as transimpedance amplifiers, modulators, gratings, waveguides, lens arrays, among other optical and electrical devices that may be used in the formation of photonic integrated circuits.

FIG. 20B shows a top view schematic drawing of an embodiment of a submount assembly 103 comprising an optical device 102 and an embodiment of submount 100 wherein the submount assembly further comprises a photonic wirebond 169 formed between the optical device 102 and a patterned planar waveguide core 143_{core} formed on the submount 100. Photonic wirebond 169, formed for example using 3D printing, may be used to facilitate coupling of optical signals from the optical device 102 and the patterned planar waveguide core 143_{core}. In an embodiment of submount assembly 103, wherein the mounted device is configured as a laser diode, photonic wirebond 169 may be formed, for example, between an output facet of the laser diode and a terminal facet 143_{facet} of the patterned planar waveguide core 143_{core} of the submount 100 to facilitate coupling of the optical signal from the laser diode to the patterned planar waveguide core 143_{core}.

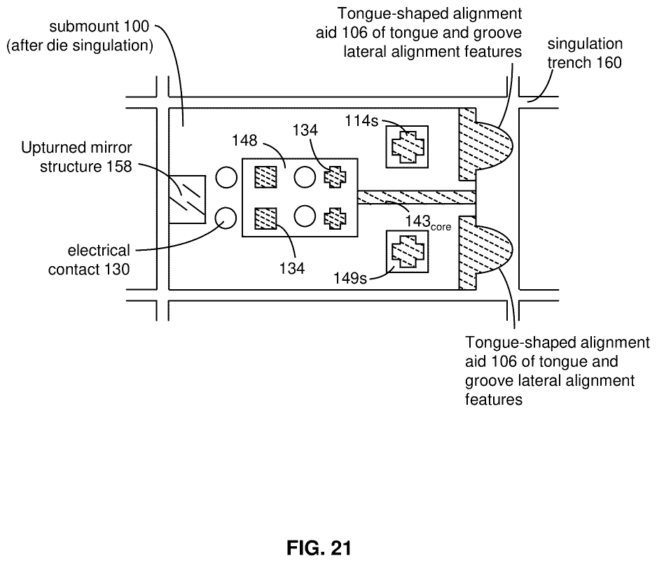

FIG. 21 shows an embodiment of a submount 100 of a submount wafer 112s after formation of singulation trenches 160 wherein an upturned mirror 158 is configured for the testing of a neighboring submount assembly 103 of the plurality of submount assemblies 103 formed from the plurality of submounts 100 of submount wafer 112s. The upturned mirror 158 shown in the embodiment of submount 100 in FIG. 21 remains on the submount 100 after fabrication.

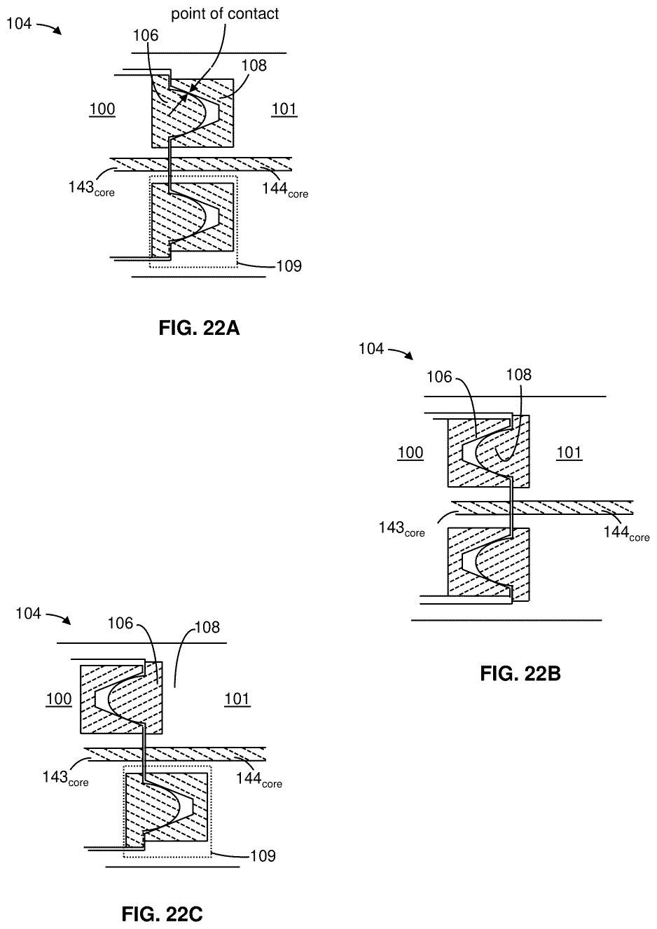

Described herein are embodiments in which a first portion of a tongue and groove lateral alignment feature 109 is a tongue-shaped lateral alignment aid 106 formed on submount 100 and a second portion of a tongue and groove lateral alignment feature 109 is a groove-shaped lateral alignment aid 108 formed in cavity 150 of optical interposer 101. A portion of optical interposer assembly 104 having such a configuration is shown in FIG. 22A.

In other embodiments, one or more first portion of a tongue and groove lateral alignment feature 109 may be a tongue-shaped lateral alignment aid 106 formed on submount 100 and one or more second portion of a tongue and groove lateral alignment feature 109 may be a groove-shaped lateral alignment aid 108 formed in cavity 150 of optical interposer 101.

In other embodiments, first portion of a tongue and groove lateral alignment feature 109 may be a groove-shaped lateral alignment aid 106 formed on submount 100 and second portion of a tongue and groove lateral alignment feature 109 may be a tongue-shaped lateral alignment aid 108 formed in cavity 150 of optical interposer 101 as shown, for example, in the embodiment in FIG. 22B.

In other embodiments, one or more first portion of a tongue and groove lateral alignment feature 109 may be a groove-shaped lateral alignment aid 106 formed on submount 100 and one or more second portion of a tongue and groove lateral alignment feature 109 may be a tongue-shaped lateral alignment aid 108 formed in cavity 150 of optical interposer 101.

And in yet other embodiments, one first portion of a tongue and groove lateral alignment feature 109 may be a tongue-shaped lateral alignment aid 106 formed on submount 100 and one second portion of a tongue and groove lateral alignment feature 109 may be a second portion of a tongue and groove lateral alignment feature 109 formed in cavity 150 of optical interposer 101 and one first portion of a tongue and groove lateral alignment feature 109 may be a groove-shaped lateral alignment aid 106 formed on submount 100 and one second portion of a tongue and groove lateral alignment feature 109 may be a tongue-shaped lateral alignment aid 108 formed in cavity 150 of optical interposer 101 as shown, for example, in the embodiment in FIG. 22C. In other embodiments, one or more first portion of a tongue and groove lateral alignment feature 109 may be a tongue-shaped lateral alignment aid 106 formed on submount 100 and one or more second portion of a tongue and groove lateral alignment feature 109 may be a second portion of a tongue and groove lateral alignment feature 109 formed in cavity 150 on optical interposer 101 and one or more first portion of a tongue and groove lateral alignment feature 109 may be a groove-shaped lateral alignment aid 106 formed on submount 100 and one or more second portion of a tongue and groove lateral alignment feature 109 may be a tongue-shaped lateral alignment aid 108 formed in cavity 150 of optical interposer 101.

In some embodiments, first portion of tongue and groove lateral alignment feature 109 on submount 100 may be shaped differently than second portion of a tongue and groove lateral alignment feature 109 formed in cavity 150 of optical interposer 101 as in the embodiment shown in FIG. 22A wherein the first portion of tongue and groove lateral alignment feature 109 on submount 100 is shown having a curved surface on the tongue-shaped lateral alignment aid 106 on submount 100 that makes a contact with the second portion of a tongue and groove lateral alignment feature 109 formed in cavity 150 of optical interposer 101 having a non-curved truncated-triangle groove-shaped lateral alignment aid 108. Differently shaped first portion of tongue and groove lateral alignment feature 109 on submount 100 and second portion of a tongue and groove lateral alignment feature 109 formed in cavity 150 of optical interposer 101, such as the embodiment shown in FIG. 22A, enables single points of contact between contacting surfaces of the first portion of tongue and groove lateral alignment feature 109 on submount 100 and second portion of a tongue and groove lateral alignment feature 109 formed in cavity 150 of optical interposer 101. Four contacting surfaces are shown in the embodiment in FIG. 22A wherein each contacting surface may provide a theoretical single point of contact. In practice, surface irregularities on small scales may broaden the single point of contact.

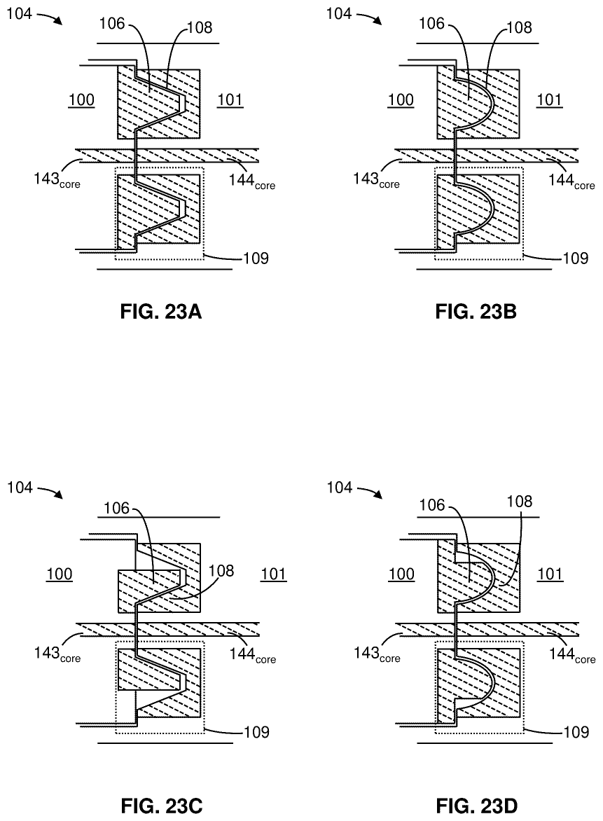

In other embodiments, such as the configuration shown in FIG. 23A, first portion of tongue and groove lateral alignment feature 109 on submount 100 may be shaped similarly to the second portion of a tongue and groove lateral alignment feature 109 formed in cavity 150 of optical interposer 101 as in the embodiments shown in FIGS. 23A and 23B wherein the first portion of tongue and groove lateral alignment feature 109 on submount 100 and the tongue-shaped lateral alignment aid 106 on submount 100 are shown having truncated triangle-shaped lateral alignment aids in the embodiment shown in FIG. 23A, and are shown having the shape of a truncated ellipse in the embodiment shown in FIG. 23B. The extent of the contact that is formed in embodiments having similarly shaped first and second portions of a tongue and groove lateral alignment feature 109 may extend over a much larger distance than mating surfaces having one or more curved surfaces that form a contact with a non-curved surface as in the embodiment shown in FIG. 22A.

In other embodiments, one or more of the first portion of tongue and groove lateral alignment feature 109 on submount 100 and the second portion of a tongue and groove lateral alignment feature 109 formed in cavity 150 of optical interposer 101 may have an extended surface contact as in the embodiments shown in FIG. 23A but only on one side of a similarly shaped lateral alignment aid. The embodiments shown in FIGS. 23C and 23D show a first portion of tongue and groove lateral alignment feature 109 on submount 100 wherein the contact area with the second portion of the tongue and groove lateral alignment feature 109 is limited to a portion of the overall tongue-shaped lateral alignment aid 106.

Embodiments of first portion of lateral alignment aid configured as a tongue-shaped lateral alignment aid 106 may be formed having contact surfaces that couple to mating groove-shaped lateral alignment aid wherein the contact surfaces may be a point, a line, or a curve.

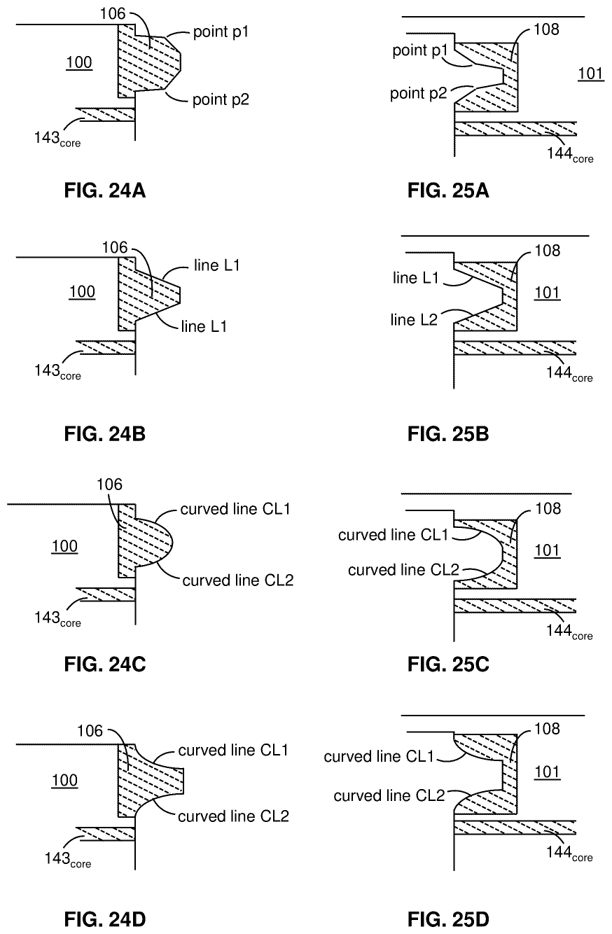

FIG. 24A shows an embodiment of a single tongue-shaped lateral alignment aid 106 configured having a contact point p1 on an upper edge of the tongue-shaped lateral alignment aid 106 (as shown in the top view of FIG. 24A) and a contact point p2 on the lower edge of the tongue-shaped lateral alignment aid 106 (as shown in the top view of FIG. 24A). The two contact points, p1 and p2, enable contacts to be formed with suitably configured groove-shaped lateral alignment aids 108. FIG. 25A shows an embodiment of a single groove-shaped lateral alignment aid 108 configured having a contact point, p1, on an upper edge of the groove-shaped lateral alignment aid 108 (as shown in the top view of FIG. 25A) and a contact point p2 on the lower edge of the groove-shaped lateral alignment aid 108 (as shown in the top view of FIG. 25A). The two contact points, p1 and p2, enable contacts to be formed with suitably configured tongue-shaped lateral alignment aids 106.

FIG. 24B shows an embodiment of a single tongue-shaped lateral alignment aid 106 configured having a line L1 on an upper edge of the tongue-shaped lateral alignment aid 106 (as shown in the top view of FIG. 24B) and a line L2 on the lower edge of the tongue-shaped lateral alignment aid 106 (as shown in the top view of FIG. 24B). The two lines, L1 and L2, enable contacts to be formed with suitably configured groove-shaped lateral alignment aids 108. FIG. 25B shows an embodiment of a single groove-shaped lateral alignment aid 108 configured having a line, L1, on an upper edge of the groove-shaped lateral alignment aid 108 (as shown in the top view of FIG. 25B) and a line, L2, on the lower edge of the groove-shaped lateral alignment aid 108 (as shown in the top view of FIG. 25B). The two lines, L1 and L2, enable contacts to be formed with suitably configured tongue-shaped lateral alignment aids 106.

FIG. 24C shows an embodiment of a single tongue-shaped lateral alignment aid 106 configured having a curved line CL1 on an upper edge of the tongue-shaped lateral alignment aid 106 (as shown in the top view of FIG. 24C) and a curved line CL2 on the lower edge of the tongue-shaped lateral alignment aid 106 (as shown in the top view of FIG. 24C). The two curved lines, CL1 and CL2, enable contacts to be formed with suitably configured groove-shaped lateral alignment aids 108. FIG. 25C shows an embodiment of a single groove-shaped lateral alignment aid 108 configured having a curved line, CL1, on an upper edge of the groove-shaped lateral alignment aid 108 (as shown in the top view of FIG. 25C) and a curved line, CL2, on the lower edge of the groove-shaped lateral alignment aid 108 (as shown in the top view of FIG. 25C). The two curved lines, CL1 and CL2, enable contacts to be formed with suitably configured tongue-shaped lateral alignment aids 106.

FIG. 24D shows another embodiment of a single tongue-shaped lateral alignment aid 106 configured having a curved line CL1 on an upper edge of the tongue-shaped lateral alignment aid 106 (as shown in the top view of FIG. 24D) and a curved line CL2 on the lower edge of the tongue-shaped lateral alignment aid 106 (as shown in the top view of FIG. 24D). The two curved lines, CL1 and CL2, enable contacts to be formed with suitably configured groove-shaped lateral alignment aids 108. FIG. 25D shows another embodiment of a single groove-shaped lateral alignment aid 108 configured having a curved line, CL1, on an upper edge of the groove-shaped lateral alignment aid 108 (as shown in the top view of FIG. 25D) and a curved line, CL2, on the lower edge of the groove-shaped lateral alignment aid 108 (as shown in the top view of FIG. 25D). The two curved lines, CL1 and CL2, enable contacts to be formed with suitably configured tongue-shaped lateral alignment aids 106.

The embodiments of the tongue-shaped lateral alignment aids 106 in FIGS. 24A-24D may be configured for coupling to suitably configured groove-shaped lateral alignment aids 108. And embodiments of the groove-shaped lateral alignment aids 108 in FIGS. 25A-25D may be configured for coupling to suitably configured tongue-shaped lateral alignment aids 108. Embodiments of tongue-shaped lateral alignment aids 106 suitably configured for groove-shaped lateral alignment aids 108 are shown in the following figures.

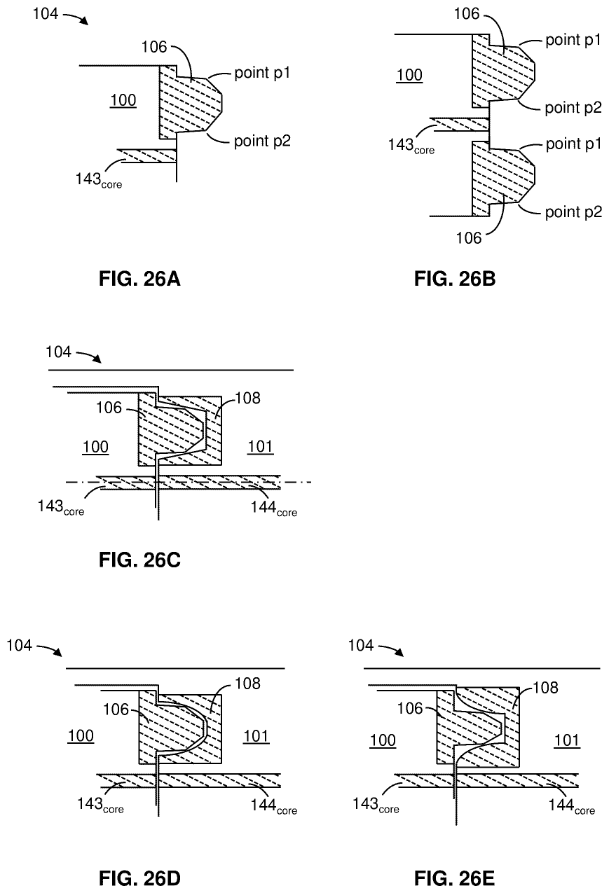

Some embodiments of tongue-shaped lateral alignment aids 106 suitably configured for groove-shaped lateral alignment aids 108 are shown in FIGS. 26A-26E for tongue-shaped lateral alignment aids 106 having two contact points on the tongue of the tongue-shaped lateral alignment aid 106. FIG. 26A shows the portion of the embodiment of the submount 100 shown in FIG. 24A configured having a tongue-shaped lateral alignment aid 106 having two contact points. FIG. 26B shows a portion of an embodiment of a submount 100 comprising two tongue-shaped lateral alignment aids 106 each configured having two contact points. Patterned planar waveguide core 143_{core}, formed self-aligned to the tongue-shaped lateral alignment aids 106 is also shown.

FIGS. 26C-26E each show a portion of an embodiment of a submount 100 comprising a tongue-shaped lateral alignment aid 106 configured having two contact points wherein the tongue-shaped lateral alignment aid 106 is coupled to optical interposer 101 to form optical interposer assembly 104. The tongue-shaped lateral alignment aids 106 on submount 100, in the embodiments, are coupled to suitably configured groove-shaped lateral alignment aids 108 on optical interposer 101.

FIG. 26C shows a portion of an embodiment of a submount 100 comprising a tongue-shaped lateral alignment aid 106 configured having two contact points wherein the tongue-shaped lateral alignment aid 106 is coupled to a groove-shaped lateral alignment aid 108 configured having two straight-line portions as described, for example, in conjunction with the embodiment of the groove-shaped lateral alignment aid 108 shown in FIG. 25B.

FIG. 26D shows a portion of another embodiment of a submount 100 comprising a tongue-shaped lateral alignment aid 106 configured having two contact points wherein the tongue-shaped lateral alignment aid 106 is coupled to a groove-shaped lateral alignment aid 108 configured having two curved line portions as described, for example, in conjunction with the embodiment of the groove-shaped lateral alignment aid 108 shown in FIG. 25C.

FIG. 26E shows a portion of another embodiment of a submount 100 comprising a tongue-shaped lateral alignment aid 106 configured having two contact points wherein the tongue-shaped lateral alignment aid 106 is coupled to a groove-shaped lateral alignment aid 108 configured having two curved line portions as described, for example, in conjunction with the embodiment of the groove-shaped lateral alignment aid 108 shown in FIG. 25D.

Two points on the tongue-shaped lateral alignment aid 106 are shown in contact with the straight-line edges of the groove-shaped lateral alignment aid 108 of FIG. 26C and the curved line edges of the groove-shaped lateral alignment aids 108 shown in FIGS. 26D and 26E.

In the embodiment of optical interposer assembly 104 shown in FIG. 26C, points of contact are formed between the two points on the tongue-shaped lateral alignment aid 106, identified as p1 and p2 in FIG. 26A, and the straight-line portions, L1 and L2 of the groove-shaped lateral alignment aid 108 shown in FIG. 26C.

In the embodiment of optical interposer assembly 104 shown in FIG. 26D, points of contact are formed between the two points on the tongue-shaped lateral alignment aid 106, identified as p1 and p2 in FIG. 26A, and the curved-line portions, CL1 and CL2 of the groove-shaped lateral alignment aid 108 shown in FIG. 26D.

And in the embodiment of optical interposer assembly 104 shown in FIG. 26E, points of contact are formed between the two points on the tongue-shaped lateral alignment aid 106, identified as p1 and p2 in FIG. 26A, and the curved-line portions, CL1 and CL2 of the groove-shaped lateral alignment aid 108 shown in FIG. 26E.

For the embodiments of the optical interposer assemblies 104 shown in FIGS. 26C-26E, contact is made between the embodiment of the tongue-shaped lateral alignment aid 106 having two contact points and the groove-shaped lateral alignment aid 108, in the embodiments, to provide lateral alignment in the x-direction (as noted in the reference coordinate system), and optionally in the y-direction. Alignment in the x-direction enables the alignment of, for example, the centerline at the terminal ends of the patterned planar waveguide core 143_{core} on the submount 100 with the centerline of the patterned planar waveguide core 144_{core} on the optical interposer 101. Alignment in the y-direction enables the facet 143_{facet} of the patterned planar waveguide core 143_{core} on the submount 100 to be positioned in relation to the facet 144_{facet} of the patterned planar waveguide core 144_{core} on the optical interposer 101. In some embodiments, a fixed facet-to-facet distance may be preferred, for example. Use of the tongue-shaped lateral alignment aid 106 coupled to the groove-shaped lateral alignment aid 108 enables the positioning of the submount 100 in the y-direction to be determined by the points of contact between the tongue-shaped lateral alignment aid 106 of the submount and the groove-shaped lateral alignment aid 108 of the optical interposer 101.

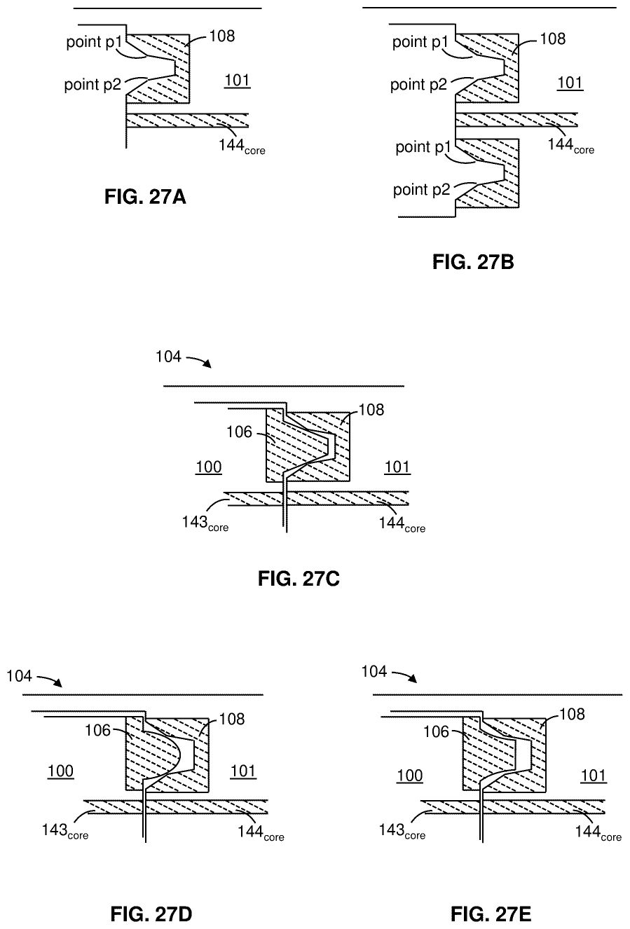

Some embodiments of groove-shaped lateral alignment aids 108 suitably configured for tongue-shaped lateral alignment aids 106 are shown in FIGS. 27A-27E for groove-shaped lateral alignment aids 108 having two points on the walls of the groove-shaped lateral alignment aid 108. FIG. 27A shows the portion of the embodiment of the submount 100 shown in FIG. 25A configured having a groove-shaped lateral alignment aid 108 having two contact points. FIG. 27B shows a portion of an embodiment of a submount 100 comprising two groove-shaped lateral alignment aids 108 each configured having two contact points. Patterned planar waveguide core 144_{core}, formed self-aligned to the groove-shaped lateral alignment aids 108 is also shown.

FIGS. 27C-27E each show a portion of an embodiment of an optical interposer 101 comprising a groove-shaped lateral alignment aid 108 configured having two contact points wherein the groove-shaped lateral alignment aid 108 is coupled to submount 100 to form optical interposer assembly 104. The groove-shaped lateral alignment aids 108 on optical interposer 101, in the embodiments, are coupled to suitably configured tongue-shaped lateral alignment aids 106 on submount 100.

FIG. 27C shows a portion of an embodiment of an optical interposer 101 comprising a groove-shaped lateral alignment aid 108 configured having two contact points wherein the groove-shaped lateral alignment aid 108 is coupled to a tongue-shaped lateral alignment aid 106 configured having two straight-line portions as described, for example, in conjunction with the embodiment of the tongue-shaped lateral alignment aid 106 shown in FIG. 24B.

FIG. 27D shows a portion of another embodiment of an optical interposer 101 comprising a groove-shaped lateral alignment aid 108 configured having two contact points wherein the groove-shaped lateral alignment aid 108 is coupled to a tongue-shaped lateral alignment aid 106 configured having two curved-line portions as described, for example, in conjunction with the embodiment of the tongue-shaped lateral alignment aid 106 shown in FIG. 24C.

FIG. 27E shows a portion of another embodiment of an optical interposer 101 comprising a groove-shaped lateral alignment aid 108 configured having two contact points wherein the groove-shaped lateral alignment aid 108 is coupled to tongue-shaped lateral alignment aid 106 configured having two curved-line portions as described, for example, in conjunction with the embodiment of the tongue-shaped lateral alignment aid 106 shown in FIG. 24D.

Two points on the groove-shaped lateral alignment aid 108 are shown in contact with the straight-line edges of the tongue-shaped lateral alignment aid 106 of FIG. 27C and the curved line edges of the tongue-shaped lateral alignment aids 106 shown in FIGS. 27D and 27E.

In the embodiment of optical interposer assembly 104 shown in FIG. 27C, points of contact are formed between the two points on the groove-shaped lateral alignment aid 108, identified as p1 and p2 in FIG. 27A, and the two straight-line portions, L1 and L2, for the tongue-shaped lateral alignment aid 106, in the embodiment of FIG. 27C.

In the embodiment of optical interposer assembly 104 shown in FIG. 27D, points of contact are formed between the two points on the groove-shaped lateral alignment aid 108, identified as p1 and p2 in FIG. 27A, and the two curved-line portions, CL1 and CL2, for the tongue-shaped lateral alignment aid 106, in the embodiment of FIG. 27D.

In the embodiment of optical interposer assembly 104 shown in FIG. 27E, points of contact are formed between the two points on the groove-shaped lateral alignment aid 108, identified as p1 and p2 in FIG. 27A, and the two curved-line portions, CL1 and CL2, for the tongue-shaped lateral alignment aid 106, in the embodiment of FIG. 27E.

For the embodiments of the optical interposer assemblies 104 shown in FIGS. 27C-27E, contact is made between the embodiment of the groove-shaped lateral alignment aid 108 having two contact points and the tongue-shaped lateral alignment aids 108 in the embodiments, to provide lateral alignment in the x-direction (as noted in the reference coordinate system), and optionally in the y-direction. Alignment in the x-direction enables the alignment of, for example, the centerline at the terminal ends of the patterned planar waveguide core 143_{core} on the submount 100 with the centerline of the patterned planar waveguide core 144_{core} on the optical interposer 101. Alignment in the y-direction enables the facet 143_{facet} of the patterned planar waveguide core 143_{core} on the submount 100 to be positioned in relation to the facet 144_{facet} of the patterned planar waveguide core 144_{core} on the optical interposer 101. In some embodiments, a fixed facet-to-facet distance may be preferred, for example. Use of the tongue-shaped lateral alignment aid 106 coupled to the groove-shaped lateral alignment aid 108 enables the positioning of the submount 100 in the y-direction to be determined by the points of contact between the tongue-shaped lateral alignment aid 106 of the submount and the groove-shaped lateral alignment aid 108 of the optical interposer 101.

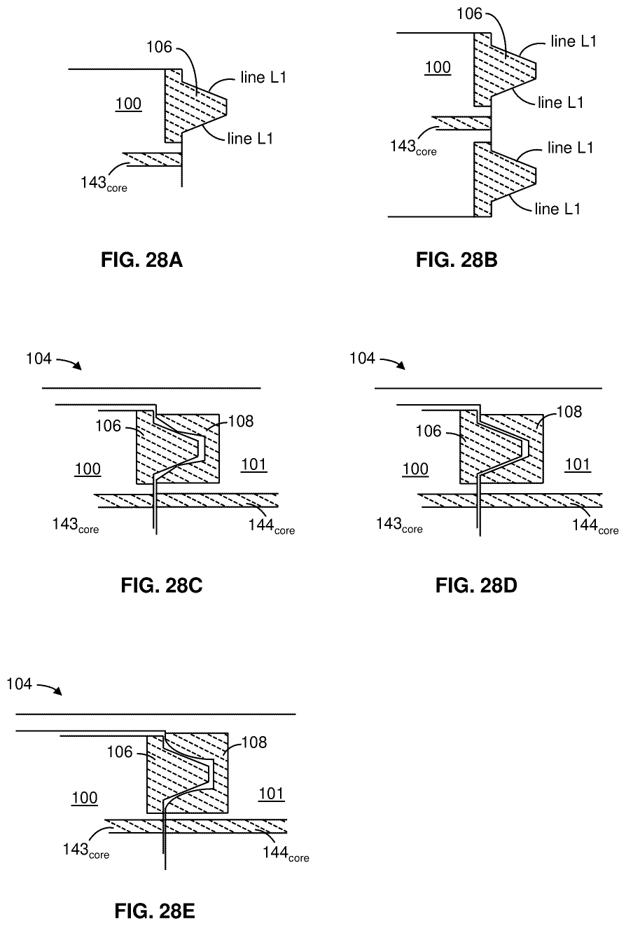

Some embodiments of tongue-shaped lateral alignment aids 106 suitably configured for groove-shaped lateral alignment aids 108 are shown in FIGS. 28A-28E for tongue-shaped lateral alignment aids 106 having two straight-line portion on the tongue of the tongue-shaped lateral alignment aid 106. FIG. 28A shows the portion of the embodiment of the submount 100 shown in FIG. 24B configured having tongue-shaped lateral alignment aid 106 having two straight-line portions. FIG. 28B shows a portion of an embodiment of submount 100 comprising two tongue-shaped lateral alignment aids 106 each configured having two straight-line portions. Patterned planar waveguide core 143_{core}, formed self-aligned to the tongue-shaped lateral alignment aids 106 is also shown.

FIGS. 28C-28E each show a portion of an embodiment of a submount 100 comprising a tongue-shaped lateral alignment aid 106 configured having two straight-line portions along which one or more contact points may be formed in coupling the tongue-shaped lateral alignment aid 106 to a groove-shaped lateral alignment aid 108 on optical interposer 101 to form optical interposer assembly 104. The tongue-shaped lateral alignment aids 106 on submount 100, in the embodiments, are coupled to suitably configured groove-shaped lateral alignment aids 108 on optical interposer 101.

FIG. 28C shows a portion of an embodiment of submount 100 comprising a tongue-shaped lateral alignment aid 106 configured having two straight-line portions wherein the tongue-shaped lateral alignment aid 106 is coupled to a groove-shaped lateral alignment aid 108 configured having two contact points as described, for example, in conjunction with the embodiment of the groove-shaped lateral alignment aid 108 shown in FIG. 25A.

FIG. 28D shows a portion of another embodiment of submount 100 comprising a tongue-shaped lateral alignment aid 106 configured having two straight-line portions wherein the tongue-shaped lateral alignment aid 106 is coupled to groove-shaped lateral alignment aid 108 configured having two straight-line portions as described, for example, in conjunction with the embodiment of the groove-shaped lateral alignment aid 108 shown in FIG. 25B.

FIG. 28E shows a portion of another embodiment of a submount 100 comprising a tongue-shaped lateral alignment aid 106 configured having two straight-line portions wherein the tongue-shaped lateral alignment aid 106 is coupled to groove-shaped lateral alignment aid 108 configured having two curved-line portions as described, for example, in conjunction with the embodiment of the groove-shaped lateral alignment aid 108 shown in FIG. 25D.

The two straight-line portions on the tongue-shaped lateral alignment aid 106 are shown in contact with the two contact points, p1 and p2, of the groove-shaped lateral alignment aid 108 of FIG. 28C, the straight-line portions of the groove-shaped lateral alignment aids 108 shown in FIG. 28D, and the curved line edges of the groove-shaped lateral alignment aids 108 shown in FIG. 28E.

In the embodiment of optical interposer assembly 104 shown in FIG. 28C, the straight-line portions on the tongue-shaped lateral alignment aid 106, identified as L1 and L2 in FIG. 28A, contact the points, p1 and p2, of the groove-shaped lateral alignment aid 108 shown in FIG. 28C.

In the embodiment of optical interposer assembly 104 shown in FIG. 28D, the straight-line portions on the tongue-shaped lateral alignment aid 106, identified as L1 and L2 in FIG. 28A, contact the straight-line portions on the groove-shaped lateral alignment aid 108 shown in FIG. 28D.

In the embodiment of optical interposer assembly 104 shown in FIG. 28E, the straight-line portions on the tongue-shaped lateral alignment aid 106, identified as L1 and L2, in FIG. 28A, contact the curved line portions of the groove-shaped lateral alignment aid 108 shown in FIG. 28D.

For the embodiments of the optical interposer assemblies 104 shown in FIGS. 28C-28E, contact is made between the embodiment of the tongue-shaped lateral alignment aid 106 having straight-line portions and the groove-shaped lateral alignment aids 108 to provide lateral alignment in the x-direction (as noted in the reference coordinate system), and optionally in the y-direction. Alignment in the x-direction enables the alignment of, for example, the centerline at the terminal ends of the patterned planar waveguide core 143_{core} on the submount 100 with the centerline of the patterned planar waveguide core 144_{core} on the optical interposer 101. Alignment in the y-direction enables the facet 143_{facet} of the patterned planar waveguide core 143_{core} on the submount 100 to be positioned in relation to the facet 144_{facet} of the patterned planar waveguide core 144_{core} on the optical interposer 101. In some embodiments, a fixed facet-to-facet distance may be preferred, for example. Use of the tongue-shaped lateral alignment aid 106 coupled to the groove-shaped lateral alignment aid 108 enables the positioning of the submount 100 in the y-direction to be determined by the points of contact between the tongue-shaped lateral alignment aid 106 of the submount and the groove-shaped lateral alignment aid 108 of the optical interposer 101.

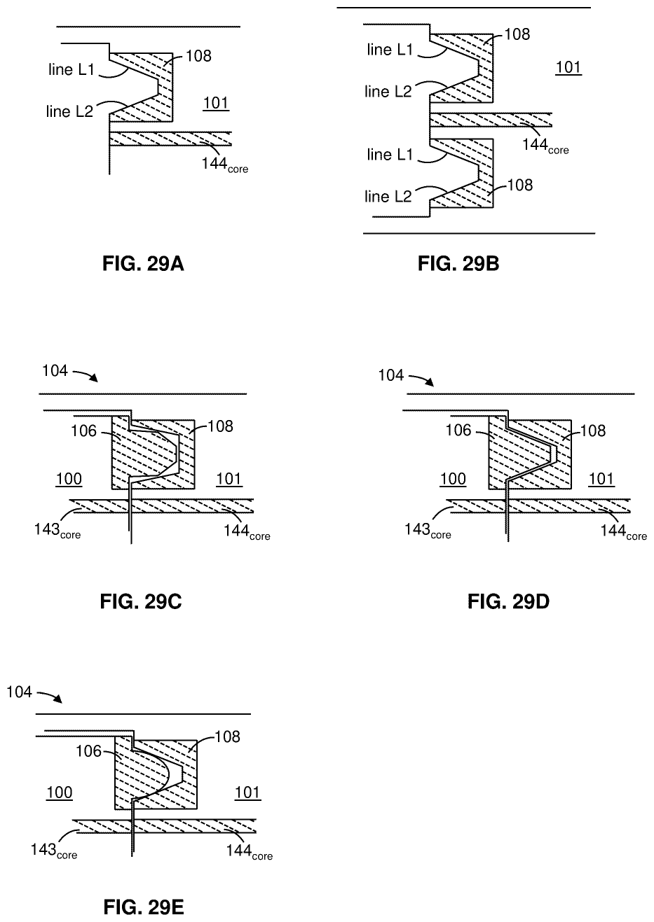

Some embodiments of groove-shaped lateral alignment aids 108 suitably configured for tongue-shaped lateral alignment aids 106 are shown in FIGS. 29A-29E for groove-shaped lateral alignment aids 108 having two straight-line portions on the walls of the groove-shaped lateral alignment aid 108.

FIG. 29A shows the portion of the embodiment of the submount 100 shown in FIG. 25B configured having a groove-shaped lateral alignment aid 108 having two straight-line portions to which the tongue-shaped lateral alignment aids 106 can be suitably configured to facilitate alignment of submount 100 onto optical interposer 101. FIG. 29B shows a portion of an embodiment of a submount 100 comprising two groove-shaped lateral alignment aids 108 each configured having two straight-line portions. Patterned planar waveguide core 144_{core}, formed self-aligned to the groove-shaped lateral alignment aids 108 is also shown.

FIGS. 29C-29E each show a portion of an embodiment of an optical interposer 101 comprising a groove-shaped lateral alignment aid 108 configured having two straight-line portions along which one or more contact points may be formed in coupling the groove-shaped lateral alignment aid 108 to a tongue-shaped lateral alignment aid 106 on submount 100 to form optical interposer assembly 104. The groove-shaped lateral alignment aids 108 on optical interposer 101, in the embodiments, are coupled to suitably configured tongue-shaped lateral alignment aids 106 on submount 100.

FIG. 29C shows a portion of an embodiment of an optical interposer 101 comprising a groove-shaped lateral alignment aid 108 configured having two straight-line portions wherein the groove-shaped lateral alignment aid 108 is coupled to a tongue-shaped lateral alignment aid 106 configured having two contact points as described, for example, in conjunction with the embodiment of the tongue-shaped lateral alignment aid 106 shown in FIG. 24A.

FIG. 29D shows a portion of another embodiment of an optical interposer 101 comprising a groove-shaped lateral alignment aid 108 configured having two straight-line portions wherein the groove-shaped lateral alignment aid 108 is coupled to a tongue-shaped lateral alignment aid 106 configured having two straight-line portions as described, for example, in conjunction with the embodiment of the tongue-shaped lateral alignment aid 106 shown in FIG. 24B.

FIG. 29E shows a portion of another embodiment of an optical interposer 101 comprising a groove-shaped lateral alignment aid 108 configured having two straight-line portions wherein the groove-shaped lateral alignment aid 108 is coupled to tongue-shaped lateral alignment aid 106 configured having two curved lines as described, for example, in conjunction with the embodiment of the tongue-shaped lateral alignment aid 106 shown in FIG. 24C.

The two straight-line portions of the groove-shaped lateral alignment aid 108 are shown in contact with the two points, p1 and p2, of the tongue-shaped lateral alignment aid 106 of FIG. 29C, the two straight-line portions of the of the tongue-shaped lateral alignment aids 106 shown in FIG. 29D, and the two curved line edges of the tongue-shaped lateral alignment aids 106 shown in FIG. 29E.

In the embodiment of optical interposer assembly 104 shown in FIG. 29C, points of contact are formed between the two straight-line portions on the groove-shaped lateral alignment aid 108, identified as L1 and L2 in FIG. 29A, and the two points, p1 and p2, for the tongue-shaped lateral alignment aid 106, in the embodiments of FIG. 29C.

In the embodiment of optical interposer assembly 104 shown in FIG. 29D, lines of contact are formed between the two straight-line portions on the groove-shaped lateral alignment aid 108, identified as L1 and L2 in FIG. 29A, and the two straight-line portions, L1 and L2, for the tongue-shaped lateral alignment aid 106, in the embodiment of FIG. 29D.

In the embodiment of optical interposer assembly 104 shown in FIG. 29E, points of contact are formed between the two straight-line portions on the groove-shaped lateral alignment aid 108, identified as L1 and L2 in FIG. 29A, and the two curved-line portions, CL1 and CL2, for the tongue-shaped lateral alignment aid 106, in the embodiment of FIG. 29E.

For the embodiments of the optical interposer assemblies 104 shown in FIGS. 29C-29E, contact is made between the embodiment of the groove-shaped lateral alignment aid 108 having straight-line portions and the tongue-shaped lateral alignment aids 108 to provide lateral alignment in the x-direction (as noted in the reference coordinate system), and optionally in the y-direction. Alignment in the x-direction enables the alignment of, for example, the centerline at the terminal ends of the patterned planar waveguide core 143_{core} on the submount 100 with the centerline of the patterned planar waveguide core 144_{core} on the optical interposer 101. Alignment in the y-direction enables the facet 143_{facet} of the patterned planar waveguide core 143_{core} on the submount 100 to be positioned in relation to the facet 144_{facet} of the patterned planar waveguide core 144_{core} on the optical interposer 101. In some embodiments, a fixed facet-to-facet distance may be preferred, for example. Use of the tongue-shaped lateral alignment aid 106 coupled to the groove-shaped lateral alignment aid 108 enables the positioning of the submount 100 in the y-direction to be determined by the points of contact between the tongue-shaped lateral alignment aid 106 of the submount and the groove-shaped lateral alignment aid 108 of the optical interposer 101.

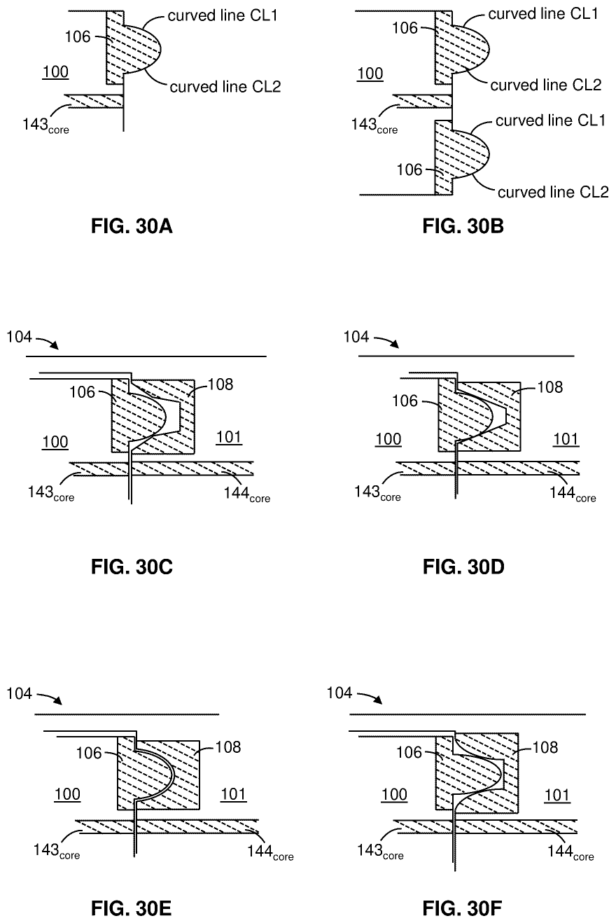

Some embodiments of tongue-shaped lateral alignment aids 106 suitably configured for groove-shaped lateral alignment aids 108 are shown in FIGS. 30A-30F for tongue-shaped lateral alignment aids 106 having two curved-line portions on the tongue of the tongue-shaped lateral alignment aid 106. FIG. 30A shows the portion of the embodiment of the submount 100 shown in FIG. 24C configured having tongue-shaped lateral alignment aid 106 having two curved-line portions. FIG. 30B shows a portion of an embodiment of submount 100 comprising two tongue-shaped lateral alignment aids 106 each configured having two curved-line portions. Patterned planar waveguide core 143_{core}, formed self-aligned to the tongue-shaped lateral alignment aids 106 is also shown.

FIGS. 30C-30F each show a portion of an embodiment of a submount 100 comprising a tongue-shaped lateral alignment aid 106 configured having two curved-line portions along which one or more contact points may be formed in coupling the tongue-shaped lateral alignment aid 106 to a groove-shaped lateral alignment aid 108 on optical interposer 101 to form optical interposer assembly 104. The tongue-shaped lateral alignment aids 106 on submount 100, in the embodiments, are coupled to suitably configured groove-shaped lateral alignment aids 108 on optical interposer 101.

FIG. 30C shows a portion of an embodiment of submount 100 comprising a tongue-shaped lateral alignment aid 106 configured having two curved-line portions wherein the tongue-shaped lateral alignment aid 106 is coupled to groove-shaped lateral alignment aid 108 configured having two contact points as described, for example, in conjunction with the embodiment of the groove-shaped lateral alignment aid 108 shown in FIG. 25A.

FIG. 30D shows a portion of another embodiment of submount 100 comprising a tongue-shaped lateral alignment aid 106 configured having two curved-line portions wherein the tongue-shaped lateral alignment aid 106 is coupled to groove-shaped lateral alignment aid 108 configured having two straight-line portions as described, for example, in conjunction with the embodiment of the groove-shaped lateral alignment aid 108 shown in FIG. 25B.

FIG. 30E shows a portion of another embodiment of a submount 100 comprising a tongue-shaped lateral alignment aid 106 configured having two curved-line portions wherein the tongue-shaped lateral alignment aid 106 is coupled to groove-shaped lateral alignment aid 108 configured having two curved lines as described, for example, in conjunction with the embodiment of the groove-shaped lateral alignment aid 108 shown in FIG. 25C.

FIG. 30F shows a portion of another embodiment of a submount 100 comprising a tongue-shaped lateral alignment aid 106 configured having two curved-line portions wherein the tongue-shaped lateral alignment aid 106 is coupled to groove-shaped lateral alignment aid 108 configured having two curved lines as described, for example, in conjunction with the embodiment of the groove-shaped lateral alignment aid 108 shown in FIG. 25D.

The two curved-line portions on the tongue-shaped lateral alignment aid 106 are shown in contact with the two contact points, p1 and p2, of the groove-shaped lateral alignment aid 108 of FIG. 30C, the straight-line portions of the groove-shaped lateral alignment aids 108 shown in FIG. 30D, and the curved line edges of the groove-shaped lateral alignment aids 108 shown in FIGS. 30E and 30F.

In the embodiment of optical interposer assembly 104 shown in FIG. 30C, the curved-line portions on the tongue-shaped lateral alignment aid 106, identified as CL1 and CL2 in FIG. 30A, contact the points, p1 and p2, of the groove-shaped lateral alignment aid 108 shown in FIG. 30C.

In the embodiment of optical interposer assembly 104 shown in FIG. 30D, the curved-line portions on the tongue-shaped lateral alignment aid 106, identified as CL1 and CL2 in FIG. 30A, contact the straight-line portions, L1 and L2, on the groove-shaped lateral alignment aid 108 shown in FIG. 30D.

In the embodiment of optical interposer assembly 104 shown in FIG. 30E, the curved-line portions on the tongue-shaped lateral alignment aid 106, identified as CL1 and CL2, in FIG. 30A, contact the curved line portions of the groove-shaped lateral alignment aid 108 shown in FIG. 30E.

In the embodiment of optical interposer assembly 104 shown in FIG. 30F, the curved-line portions on the tongue-shaped lateral alignment aid 106, identified as CL1 and CL2, in FIG. 30A, contact the curved line portions of the groove-shaped lateral alignment aid 108 shown in FIG. 30F.

For the embodiments of the optical interposer assemblies 104 shown in FIGS. 30C-30F, contact is made between the embodiment of the tongue-shaped lateral alignment aid 106 having curved-line portions and the groove-shaped lateral alignment aids 108 to provide lateral alignment in the x-direction (as noted in the reference coordinate system), and optionally in the y-direction. Alignment in the x-direction enables the alignment of, for example, the centerline at the terminal ends of the patterned planar waveguide core 143_{core} on the submount 100 with the centerline of the patterned planar waveguide core 144_{core} on the optical interposer 101. Alignment in the y-direction enables the facet 143_{facet} of the patterned planar waveguide core 143_{core} on the submount 100 to be positioned in relation to the facet 144_{facet} of the patterned planar waveguide core 144_{core} on the optical interposer 101. In some embodiments, a fixed facet-to-facet distance may be preferred, for example. Use of the tongue-shaped lateral alignment aid 106 coupled to the groove-shaped lateral alignment aid 108 enables the positioning of the submount 100 in the y-direction to be determined by the points of contact between the tongue-shaped lateral alignment aid 106 of the submount and the groove-shaped lateral alignment aid 108 of the optical interposer 101.

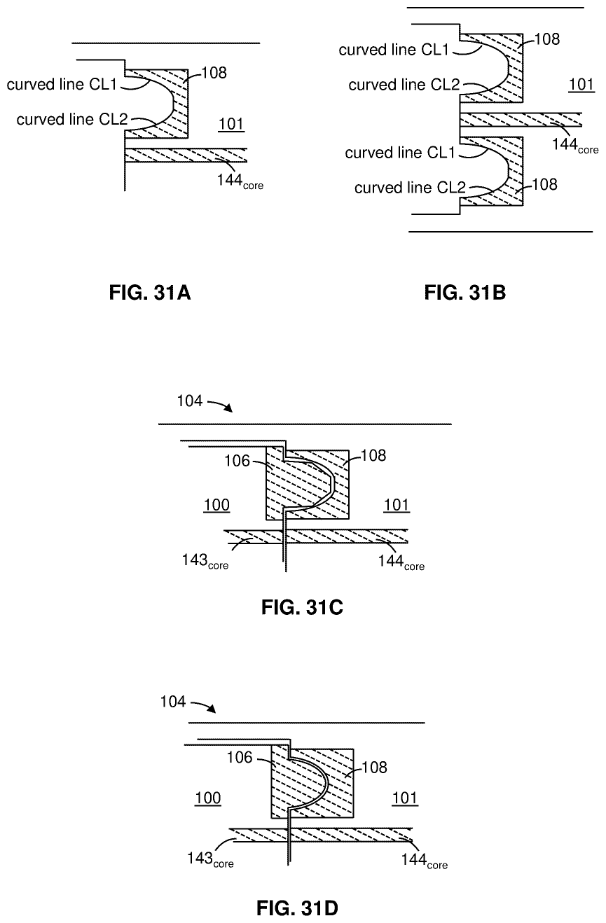

Some embodiments of groove-shaped lateral alignment aids 108 suitably configured for tongue-shaped lateral alignment aids 106 are shown in FIGS. 31A-31D for groove-shaped lateral alignment aids 108 having two curved-line portions on the walls of the groove-shaped lateral alignment aid 108.

FIG. 31A shows the portion of the embodiment of the submount 100 shown in FIG. 25C configured having a groove-shaped lateral alignment aid 108 having two curved-line portions to which the tongue-shaped lateral alignment aids 106 can be suitably configured to facilitate alignment of submount 100 onto optical interposer 101. FIG. 31B shows a portion of an embodiment of a submount 100 comprising two groove-shaped lateral alignment aids 108 each configured having two curved-line portions. Patterned planar waveguide core 144_{core}, formed self-aligned to the groove-shaped lateral alignment aids 108 is also shown.

FIGS. 31C-31D each show a portion of an embodiment of an optical interposer 101 comprising a groove-shaped lateral alignment aid 108 configured having curved-line portions along which one or more contact points may be formed in coupling the groove-shaped lateral alignment aid 108 to a tongue-shaped lateral alignment aid 106 on submount 100 to form optical interposer assembly 104. The groove-shaped lateral alignment aids 108 on optical interposer 101, in the embodiments, are coupled to suitably configured tongue-shaped lateral alignment aids 106 on submount 100.

FIG. 31C shows a portion of an embodiment of an optical interposer 101 comprising a groove-shaped lateral alignment aid 108 configured having two curved-line portions wherein the groove-shaped lateral alignment aid 108 is coupled to a tongue-shaped lateral alignment aid 106 configured having two contact points as described, for example, in conjunction with the embodiment of the tongue-shaped lateral alignment aid 106 shown in FIG. 24A.

FIG. 31D shows a portion of another embodiment of an optical interposer 101 comprising a groove-shaped lateral alignment aid 108 configured having two curved-line portions wherein the groove-shaped lateral alignment aid 108 is coupled to a tongue-shaped lateral alignment aid 106 configured having curved-line portions as described, for example, in conjunction with the embodiment of the tongue-shaped lateral alignment aid 106 shown in FIG. 24C.

The two curved-line portions of the groove-shaped lateral alignment aid 108 are shown in contact with the two points, p1 and p2, of the tongue-shaped lateral alignment aid 106 of FIG. 31C and the two curved line edges of the tongue-shaped lateral alignment aids 106 shown in FIG. 31D.

In the embodiment of optical interposer assembly 104 shown in FIG. 31C, points of contact are formed between the two curved-line portions on the groove-shaped lateral alignment aid 108, identified as CL1 and CL2 in FIG. 31A, and the two points, p1 and p2, for the tongue-shaped lateral alignment aid 106, in the embodiments of FIG. 31C.

In the embodiment of optical interposer assembly 104 shown in FIG. 31D, lines of contact are formed between the two curved-line portions on the groove-shaped lateral alignment aid 108, identified as CL1 and CL2 in FIG. 31A, and the two curved-line portions, CL1 and CL2, for the tongue-shaped lateral alignment aid 106, in the embodiment of FIG. 31D.

For the embodiments of the optical interposer assemblies 104 shown in FIGS. 31C-31D, contact is made between the embodiment of the groove-shaped lateral alignment aid 108 having curved-line portions and the tongue-shaped lateral alignment aids 108 to provide lateral alignment in the x-direction (as noted in the reference coordinate system), and optionally in the y-direction. Alignment in the x-direction enables the alignment of, for example, the centerline at the terminal ends of the patterned planar waveguide core 143_{core} on the submount 100 with the centerline of the patterned planar waveguide core 144_{core} on the optical interposer 101. Alignment in the y-direction enables the facet 143_{facet} of the patterned planar waveguide core 143_{core} on the submount 100 to be positioned in relation to the facet 144_{facet} of the patterned planar waveguide core 144_{core} on the optical interposer 101. In some embodiments, a fixed facet-to-facet distance may be preferred, for example. Use of the tongue-shaped lateral alignment aid 106 coupled to the groove-shaped lateral alignment aid 108 enables the positioning of the submount 100 in the y-direction to be determined by the points of contact between the tongue-shaped lateral alignment aid 106 of the submount and the groove-shaped lateral alignment aid 108 of the optical interposer 101.

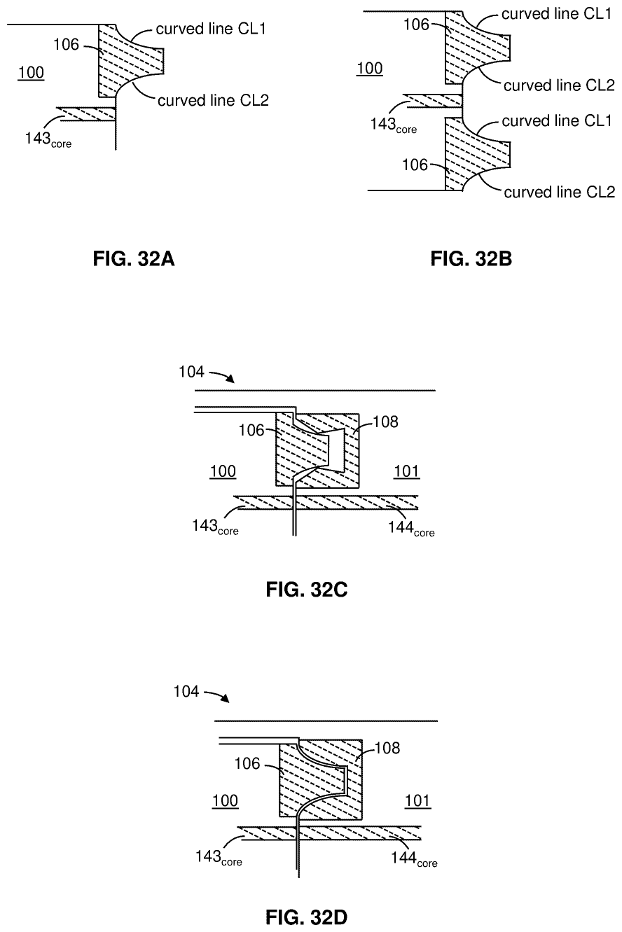

Some embodiments of tongue-shaped lateral alignment aids 106 suitably configured for groove-shaped lateral alignment aids 108 are shown in FIGS. 32A-32D for tongue-shaped lateral alignment aids 106 having two curved-line portions on the tongue of the tongue-shaped lateral alignment aid 106. FIG. 32A shows the portion of the embodiment of the submount 100 shown in FIG. 24D configured having tongue-shaped lateral alignment aid 106 having two curved-line portions. FIG. 32B shows a portion of an embodiment of submount 100 comprising two tongue-shaped lateral alignment aids 106 each configured having two curved-line portions. Patterned planar waveguide core 143_{core}, formed self-aligned to the tongue-shaped lateral alignment aids 106 is also shown.

FIGS. 32C-32D each show a portion of an embodiment of a submount 100 comprising a tongue-shaped lateral alignment aid 106 configured having two curved-line portions along which one or more contact points may be formed in coupling the tongue-shaped lateral alignment aid 106 to a groove-shaped lateral alignment aid 108 on optical interposer 101 to form optical interposer assembly 104. The tongue-shaped lateral alignment aids 106 on submount 100, in the embodiments, are coupled to suitably configured groove-shaped lateral alignment aids 108 on optical interposer 101.

FIG. 32C shows a portion of an embodiment of submount 100 comprising a tongue-shaped lateral alignment aid 106 configured having two curved-line portions wherein the tongue-shaped lateral alignment aid 106 is coupled to groove-shaped lateral alignment aid 108 configured having two contact points as described, for example, in conjunction with the embodiment of the groove-shaped lateral alignment aid 108 shown in FIG. 25A.

FIG. 32D shows a portion of another embodiment of submount 100 comprising a tongue-shaped lateral alignment aid 106 configured having two curved-line portions wherein the tongue-shaped lateral alignment aid 106 is coupled to groove-shaped lateral alignment aid 108 configured having two curved-line portions as described, for example, in conjunction with the embodiment of the groove-shaped lateral alignment aid 108 shown in FIG. 25D.

The two curved-line portions on the tongue-shaped lateral alignment aid 106 are shown in contact with the two contact points, p1 and p2, of the groove-shaped lateral alignment aid 108 of FIG. 32C and the curved line edges of the groove-shaped lateral alignment aids 108 shown in FIG. 32D.

In the embodiment of optical interposer assembly 104 shown in FIG. 32C, the curved-line portions on the tongue-shaped lateral alignment aid 106, identified as CL1 and CL2 in FIG. 32A, contact the points, p1 and p2, of the groove-shaped lateral alignment aid 108 shown in FIG. 32C.

In the embodiment of optical interposer assembly 104 shown in FIG. 32D, the curved-line portions on the tongue-shaped lateral alignment aid 106, identified as CL1 and CL2 in FIG. 32A, contact the curved-line portions, CL1 and CL2, on the groove-shaped lateral alignment aid 108 shown in FIG. 32D.

For the embodiments of the optical interposer assemblies 104 shown in FIGS. 32C-32D, contact is made between the embodiment of the tongue-shaped lateral alignment aid 106 having curved-line portions and the groove-shaped lateral alignment aids 108 to provide lateral alignment in the x-direction (as noted in the reference coordinate system), and optionally in the y-direction. Alignment in the x-direction enables the alignment of, for example, the centerline at the terminal ends of the patterned planar waveguide core 143_{core} on the submount 100 with the centerline of the patterned planar waveguide core 144_{core} on the optical interposer 101. Alignment in the y-direction enables the facet 143_{facet} of the patterned planar waveguide core 143_{core} on the submount 100 to be positioned in relation to the facet 144_{facet} of the patterned planar waveguide core 144_{core} on the optical interposer 101. In some embodiments, a fixed facet-to-facet distance may be preferred, for example. Use of the tongue-shaped lateral alignment aid 106 coupled to the groove-shaped lateral alignment aid 108 enables the positioning of the submount 100 in the y-direction to be determined by the points of contact between the tongue-shaped lateral alignment aid 106 of the submount and the groove-shaped lateral alignment aid 108 of the optical interposer 101.

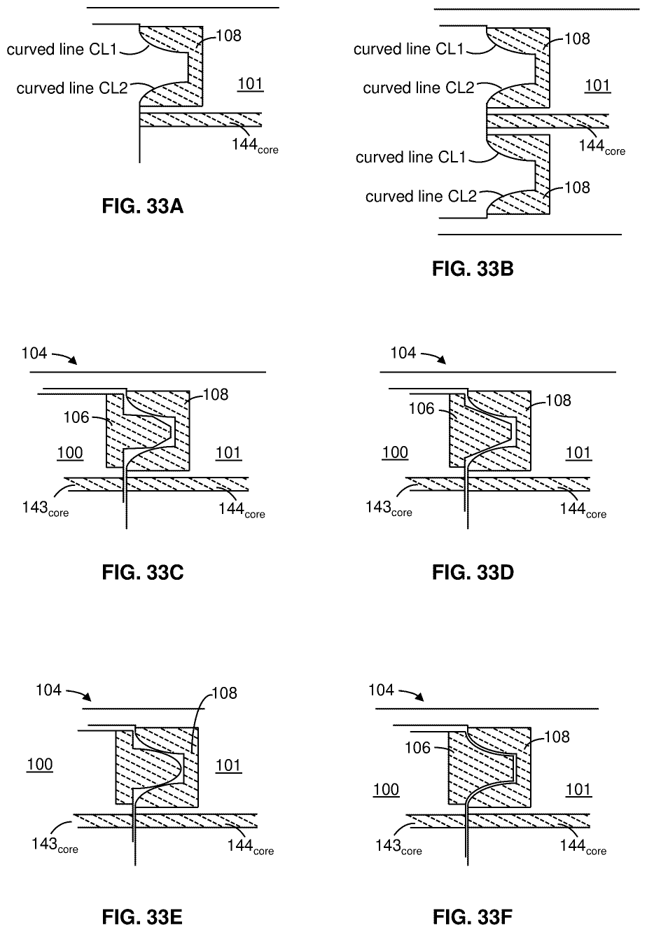

Some embodiments of groove-shaped lateral alignment aids 108 suitably configured for tongue-shaped lateral alignment aids 106 are shown in FIGS. 33A-33F for groove-shaped lateral alignment aids 108 having two curved-line portions on the walls of the groove-shaped lateral alignment aid 108.

FIG. 33A shows the portion of the embodiment of the submount 100 shown in FIG. 25D configured having a groove-shaped lateral alignment aid 108 having two curved-line portions to which the tongue-shaped lateral alignment aids 106 can be suitably configured to facilitate alignment of submount 100 onto optical interposer 101. FIG. 33B shows a portion of an embodiment of a submount 100 comprising two groove-shaped lateral alignment aids 108 each configured having two curved-line portions. Patterned planar waveguide core 144_{core}, formed self-aligned to the groove-shaped lateral alignment aids 108 is also shown.

FIGS. 33C-33F each show a portion of an embodiment of an optical interposer 101 comprising a groove-shaped lateral alignment aid 108 configured having curved-line portions along which one or more contact points may be formed in coupling the groove-shaped lateral alignment aid 108 to a tongue-shaped lateral alignment aid 106 on submount 100 to form optical interposer assembly 104. The groove-shaped lateral alignment aids 108 on optical interposer 101, in the embodiments, are coupled to suitably configured tongue-shaped lateral alignment aids 106 on submount 100.

FIG. 33C shows a portion of an embodiment of an optical interposer 101 comprising a groove-shaped lateral alignment aid 108 configured having two curved-line portions wherein the groove-shaped lateral alignment aid 108 is coupled to a tongue-shaped lateral alignment aid 106 configured having two contact points as described, for example, in conjunction with the embodiment of the tongue-shaped lateral alignment aid 106 shown in FIG. 24A.

FIG. 33D shows a portion of another embodiment of an optical interposer 101 comprising a groove-shaped lateral alignment aid 108 configured having two curved-line portions wherein the groove-shaped lateral alignment aid 108 is coupled to a tongue-shaped lateral alignment aid 106 configured having straight-line portions as described, for example, in conjunction with the embodiment of the tongue-shaped lateral alignment aid 106 shown in FIG. 24B.

FIG. 33E shows a portion of another embodiment of an optical interposer 101 comprising a groove-shaped lateral alignment aid 108 configured having two curved-line portions wherein the groove-shaped lateral alignment aid 108 is coupled to a tongue-shaped lateral alignment aid 106 configured having curved-line portions as described, for example, in conjunction with the embodiment of the tongue-shaped lateral alignment aid 106 shown in FIG. 24C.

FIG. 33F shows a portion of another embodiment of an optical interposer 101 comprising a groove-shaped lateral alignment aid 108 configured having two curved-line portions wherein the groove-shaped lateral alignment aid 108 is coupled to a tongue-shaped lateral alignment aid 106 configured having curved-line portions as described, for example, in conjunction with the embodiment of the tongue-shaped lateral alignment aid 106 shown in FIG. 24D.

In the embodiments, the two curved-line portions of the groove-shaped lateral alignment aid 108 are shown in contact with the two points, p1 and p2, of the tongue-shaped lateral alignment aid 106 of FIG. 33C, are shown in contact with the straight-line portions, L1 and L2, of the tongue-shaped lateral alignment aid 106 of FIG. 33D, and are shown in contact with the two curved line edges, CL1 and CL2, of the tongue-shaped lateral alignment aids 106 shown in FIGS. 33E and 33F.

In the embodiment of optical interposer assembly 104 shown in FIG. 33C, points of contact are formed between the two curved-line portions on the groove-shaped lateral alignment aid 108, identified as CL1 and CL2 in FIG. 33A, and the two points, p1 and p2, for the tongue-shaped lateral alignment aid 106, in the embodiment of FIG. 33C.

In the embodiment of optical interposer assembly 104 shown in FIG. 33D, points of contact are formed between the two curved-line portions on the groove-shaped lateral alignment aid 108, identified as CL1 and CL2 in FIG. 33A, and the two lines, L1 and L2, for the tongue-shaped lateral alignment aid 106, in the embodiment of FIG. 33D.

In the embodiment of optical interposer assembly 104 shown in FIG. 33E, points of contact are formed between the two curved-line portions on the groove-shaped lateral alignment aid 108, identified as CL1 and CL2 in FIG. 33A, and the two curved lines, CL1 and CL2, for the tongue-shaped lateral alignment aid 106, in the embodiment of FIG. 33E.

In the embodiment of optical interposer assembly 104 shown in FIG. 33F, lines of contact are formed between the two curved-line portions on the groove-shaped lateral alignment aid 108, identified as CL1 and CL2 in FIG. 33A, and the two curved-line portions, CL1 and CL2, for the tongue-shaped lateral alignment aid 106, in the embodiment of FIG. 31F.

For the embodiments of the optical interposer assemblies 104 shown in FIGS. 33C-33F, contact is made between the embodiment of the groove-shaped lateral alignment aid 108 having curved-line portions and the tongue-shaped lateral alignment aids 108 to provide lateral alignment in the x-direction (as noted in the reference coordinate system), and optionally in the y-direction. Alignment in the x-direction enables the alignment of, for example, the centerline at the terminal ends of the patterned planar waveguide core 143_{core} on the submount 100 with the centerline of the patterned planar waveguide core 144_{core} on the optical interposer 101. Alignment in the y-direction enables the facet 143_{facet} of the patterned planar waveguide core 143_{core} on the submount 100 to be positioned in relation to the facet 144_{facet} of the patterned planar waveguide core 144_{core} on the optical interposer 101. In some embodiments, a fixed facet-to-facet distance may be preferred, for example. Use of the tongue-shaped lateral alignment aid 106 coupled to the groove-shaped lateral alignment aid 108 enables the positioning of the submount 100 in the y-direction to be determined by the points of contact between the tongue-shaped lateral alignment aid 106 of the submount and the groove-shaped lateral alignment aid 108 of the optical interposer 101.

It should be noted that the contact points, as shown in the top view of the submounts 100, form all or a portion of a linear connection, or approximate linear connection, that extends all or in part from the top surface of the submount to the bottom of the submount 100, as shown in the cross-section, for example, in FIG. 1D.

Other lateral alignment aids may be formed from these basic structures in other embodiments. In some embodiments, one or more groove-shaped lateral alignment aids may be formed on submount 100 and one or more tongue-shaped lateral alignment aids may be formed on optical interposer 101. Combinations of tongue-shaped lateral alignment aids wherein one or more tongue-shaped lateral alignment aids may be formed on submount 100 and one or more tongue-shaped lateral alignment aids may be formed on optical interposer 101 and one or more groove-shaped lateral alignment aids may be formed on submount 100 and one or more groove-shaped lateral alignment aids may be formed on optical interposer 101.

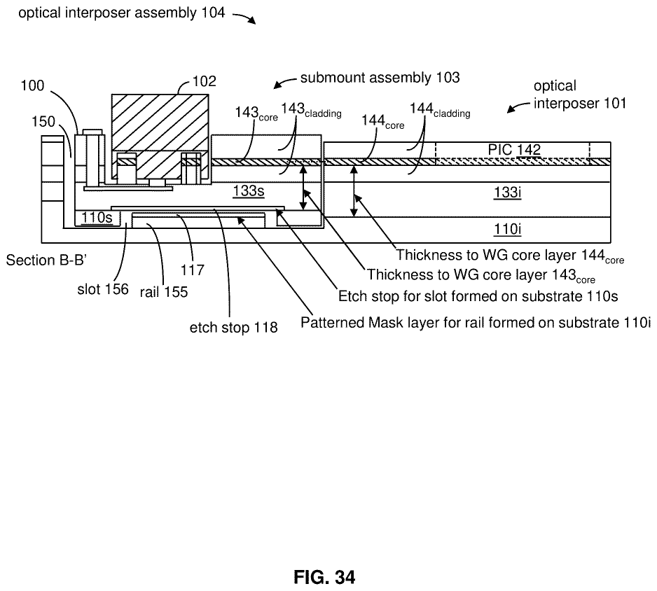

FIG. 34 shows an embodiment of an optical interposer assembly comprising a submount and an optical interposer wherein an etch stop layer is provided in the film structure of the submount. Etch stop layer 118 is shown in the electrical interconnect layer 133s in the embodiment of the submount shown in FIG. 34. An etch stop layer, as shown, may be formed, for example, from one or more of an insulating dielectric layer and a metal layer. Dielectric layers such as aluminum nitride, silicon nitride, among other dielectric layers may be used in embodiments to improve the uniformity of the slot etch, for example. Alternatively, metal layers such as aluminum, copper, titanium, nickel, tungsten, among other metals and alloys of metals may be used as an etch stop layer. In an embodiment, an etch stop layer having a low etch rate in comparison to the material in the submount substrate. In a fluorine-based dry etch process, for example, an aluminum layer, or an alloy of aluminum, may be used as an etch stop layer. Aluminum, and alloys of aluminum, typically have a low etch rate in fluorine-based etch chemistries. Other metal layers may also exhibit low etch rates in comparison to the substrate of the submount, which may be formed, for example, from silicon. Other substrate material may also be used in the formation of the submount substrate.

In addition to forming an etch stop, the etch stop layer may also be used to facilitate improved movability of the submount on the rail 155 of the interposer 101. In an embodiment having an etch stop layer, for example, an etch stop layer that forms a smoother surface than that of the substrate or that of the dielectric layer of the electrical interconnect layer may be preferable as a means of reducing the friction between the submount and the rails 155 of the interposer 101. After a placement step in which the submount is placed into the cavity 150, the submount would typically require movement into an aligned position as shown for example, in FIG. 1K.

In the embodiment shown in FIG. 34, a thicker electrical interconnect layer 133i is provided on the interposer 101 to accommodate the thickness of the patterned mask layer formed on the rails 155 in the embodiment, and to maintain the alignment of the waveguide cores 143_{core} of the submount assembly 103 and the waveguide core 144_{core} of the optical interposer 101. In other embodiments, other means for maintaining the alignment of the waveguide core layers in the optical interposer assembly 104 may be used. In another embodiment, an increased thickness of the bottom cladding layer on the optical interposer 101 may be used to accommodate the patterning mask layer 117 on the rails 155 while maintaining the alignment of the waveguide cores of the submount assembly 103 and the optical interposer 101.

In the embodiment shown in FIG. 35, the patterned mask layer 117 may be formed on the optical interposer substrate 110i prior to formation of the electrical interconnect layer 133i. FIG. 35 shows the patterned layer 117 formed on the substrate 110i. The etch stop layer 118 is similarly formed on the substrate 110s of the submount 100 and patterned, prior to the formation of the electrical interconnect layer 133s on all of a portion of the etch stop layer 118. The thickness of the layer between the core layer 144_{core} of the optical interposer 101 and the substrate 110i, labeled “Thickness to WG core layer 144_{core}”, in the embodiment shown, is equal to, or approximately equal to the sum of the thicknesses between the core layer 143_{core} of the submount 100 and the substrate 110s, labeled in FIG. 35 as “Thickness to WG core layer 143_{core}” and the mask thickness. The matching, or approximate matching, of these thicknesses will enable the waveguide cores to be in alignment in embodiments configured having an etch stop layer 118 in the submount 100.

The foregoing descriptions of embodiments have been presented for purposes of illustration and description and are not intended to be exhaustive or to limit embodiments to the forms disclosed. Modifications to, and variations of, the disclosed embodiments will be readily apparent to those skilled in the art, and the general principles defined herein may be applied to other embodiments without departing from the spirit and scope of the embodiments disclosed herein. Thus, embodiments should not be limited to those specifically described herein but rather are to be accorded the widest scope consistent with the principles and features disclosed herein. What is claimed is,

1. An assembly comprising
a first component comprising a first alignment aid and a first waveguide,
a second component comprising a second alignment aid and a second waveguide,
wherein the first and second alignment aids are configured to be mated to each other,
wherein the first and second alignment aids, when mated, are configured to provide an alignment between the first and second waveguide,
wherein the second component is assembled on the first component with the second alignment aid mated to the first alignment aid.

2. An assembly as in claim 1,
wherein at least one of a first distance or a first orientation between the first alignment aid and the first waveguide and at least one of a second distance or a second orientation between the second alignment aid and the second waveguide each is within an alignment accuracy value or within less than 0.2 micron difference to a design value to enable the alignment of the first and second waveguides when the first and second alignment aids are mated,
wherein the alignment accuracy value is characterized by an optical loss of less than 20% or less than 1dB through the alignment between the first and the second waveguides.

3. An assembly as in claim 1,
wherein the first and second alignment aids each comprises at least a three-dimensional structure comprising a lateral top surface and a side surface running along at least a portion of a periphery of the lateral top surface,
wherein the mating between the first and second alignment aids comprises at least two contacts,
wherein a contact of the two contacts comprises a contact point, a contact line, a contact curve, or a contact surface on the side surface,
wherein a first distance between each contact of the two contacts on the first alignment aid and a first location on the first waveguide and a second distance between a contact of the two contacts on the second alignment and a second location on the second waveguide each is within an alignment accuracy value or within less than 0.2 micron difference to enable the alignment of the first and second waveguides when the first and second alignment aids are mated,
wherein the alignment accuracy value is characterized by an optical loss of less than 20% or less than 1 dB through the alignment between the first and the second waveguides,
wherein the first location on the first waveguide comprises a facet of the first waveguide or a point on the facet of the first waveguide,
wherein the second location on the second waveguide comprises a facet of the second waveguide or a corresponding point on the facet of the first waveguide.

4. An assembly as in claim 1,
wherein the first component comprises a hard mask layer, with the hard mask layer and the first waveguide separated the z-distance in a direction perpendicular to a lateral surface of the first substrate,
wherein the first component comprises a protrusion, with the protrusion comprising a first layer comprising a portion of the hard mask layer,
wherein the second component comprises an etch stop layer, with the etch stop layer and the second waveguide separated a z-distance in a direction perpendicular to a lateral surface of the second substrate,
wherein the second component comprises a recess at a back side, with the recess comprising a second layer comprising a portion of the etch stop layer,
wherein the protrusion is configured to be mated to the recess with the first layer of the protrusion contacting the second layer of the recess when the second component is assembled in the first component.

5. An assembly comprising
a first component comprising a first alignment aid and a first waveguide,
wherein the first component comprises a first cavity with the first alignment aid disposed on a side of the cavity,
a second component comprising a second alignment aid and a second waveguide,
wherein the second alignment aid is disposed on a side of the second component,
wherein the first and second alignment aids are configured to be mated to each other,
wherein the first and second alignment aids, when mated, are configured to provide an alignment between the first and second waveguide,
wherein at least one of a first distance or a first orientation between the first alignment aid and the first waveguide is within a lithography accuracy to at least one of a second distance or a second orientation between the second alignment aid and the second waveguide, respectively, to enable the alignment of the first and second waveguides when the first and second alignment aids are mated,
wherein the lithography accuracy of the first and second distance is configured to be provided by forming the first alignment aid and the first waveguide using a first lithography mask, and by forming the second alignment aid and the second waveguide using a second lithography mask, with the first lithography mask related to the second lithography mask to provide the first and second distances or the first and second orientations,
wherein the second component is assembled in the first cavity of the first component with the second alignment aid mates to the first alignment aid.

6. An assembly as in claim 5,
wherein the first alignment aid has a shape of a first tongue or a first groove,
wherein the second alignment aid has a shape of a second groove configured to match the shape of the first tongue or a second tongue configured to match the shape of the first groove, respectively.

7. An assembly as in claim 5,
wherein the first alignment aid comprises one or more first protrusions,
wherein the second alignment aid comprises one or more second protrusions,
wherein two sides of the one or more first protrusions each is configured to match a side of two sides of the one or more second protrusions.

8. An assembly as in claim 5,
wherein the first alignment aid comprises one or more first protrusions or one or more first recesses,
wherein the second alignment aid comprises one or more second recesses each comprising a first shape configured to match a second shape of the one or more first protrusions or one or more second protrusions each comprising a third shape configured to match a fourth shape of the one or more first recess, respectively.

9. An assembly as in claim 5,
wherein the first component comprises a hard mask layer, with the hard mask layer and the first waveguide separated the z-distance in a direction perpendicular to a lateral surface of the first substrate,
wherein the first component comprises a protrusion, with the protrusion comprising a first layer comprising a portion of the hard mask layer,
wherein the second component comprises an etch stop layer, with the etch stop layer and the second waveguide separated a z-distance in a direction perpendicular to a lateral surface of the second substrate,
wherein the second component comprises a recess at a back side, with the recess comprising a second layer comprising a portion of the etch stop layer,
wherein the protrusion is configured to be mated to the recess with the first layer of the protrusion contacting the second layer of the recess when the second component is assembled in the first component.

10. An assembly as in claim 5,
wherein the first component comprises a rail,
wherein the second component comprises a recess, configured to accept the rail when the second component is assembled on the first component,
wherein an exposed surface of the rail and the first waveguide is separated a z-distance in a direction perpendicular to a lateral surface of the first substrate,
wherein an exposed surface of the recess and the second waveguide is separated the z-distance in a direction perpendicular to a lateral surface of the second substrate.

12. An assembly as in claim 5,
wherein the second component is configured to receive an optoelectronic device,
wherein the second component comprises a fiducial configured to assist in the placement of the optoelectronic device on the second component,
wherein the fiducial is disposed at a same elevation as the second alignment aid.

13. An assembly as in claim 5,
wherein the first component comprises an electrical interconnect layer disposed under the first waveguide,
wherein the electrical interconnect layer comprises at least an electrical interconnect line configured to be coupled to an optoelectronic device disposed on the first or on the second component.

14. An assembly as in claim 5,
wherein the first component and the second component comprise mismatched solder pads,
wherein the mismatched solder pads are configured to move the second component relative to the first component, when heating, so that the second alignment aid contacts the first alignment aid.

15. An assembly as in claim 5,
wherein the first component comprises a fiducial configured to assist in the assembling of the second component on the first component,
wherein the fiducial is disposed at a same elevation as the first alignment aid.

16. An assembly as in claim 5,
wherein a first substrate comprises the first component together with one or more other first components each comprising a same structure,
wherein a second component is assembled on each first component of the first component and the one or more other first components,
wherein each first component of the first component and the one or more other first components is configured to be operational due to a testing of each of the second components before the assembling.

17. An assembly as in claim 5,
wherein a second substrate comprises the second component together with one or more other second components each comprising a same structure.
wherein an optoelectronic device is mounted on each second component of the second component and the one or more other second components,
wherein the second component and the one or more other second components each comprises an upturn mirror structure, with the upturn mirror structure configured to allow the second component and the one or more other second components each to be tested in the second substrate.

18. An assembly comprising
a first substrate comprising multiple first components,
wherein each first component comprises a first alignment aid and a first waveguide,
multiple second components,
wherein each second component comprising a second alignment aid and a second waveguide,
wherein the first and second alignment aids are configured to be mated to each other,
wherein the first and second alignment aids, when mated, are configured to provide an alignment between the first and second waveguide,
wherein at least one of a first distance or a first orientation between the first alignment aid and the first waveguide is within a lithography accuracy to at least one of a second distance or a second orientation between the second alignment aid and the second waveguide, respectively, to enable the alignment of the first and second waveguides when the first and second alignment aids are mated,
wherein the lithography accuracy of the first and second distance is configured to be provided by forming the first alignment aid and the first waveguide using a first lithography mask, and by forming the second alignment aid and the second waveguide using a second lithography mask, with the first lithography mask related to the second lithography mask to provide the first and second distances or the first and second orientations,
wherein the second component is assembled on the first component with the second alignment aid mates to the first alignment aid,
wherein each first component of the first component and the one or more other first components is configured to be operational due to a testing of each of the second components before the assembling.

19. An assembly as in claim 18,
wherein the first component comprises a hard mask layer, with the hard mask layer and the first waveguide separated the z-distance in a direction perpendicular to a lateral surface of the first substrate,
wherein the first component comprises a protrusion, with the protrusion comprising a first layer comprising a portion of the hard mask layer,
wherein the second component comprises an etch stop layer, with the etch stop layer and the second waveguide separated a z-distance in a direction perpendicular to a lateral surface of the second substrate,
wherein the second component comprises a recess at a back side, with the recess comprising a second layer comprising a portion of the etch stop layer,
wherein the protrusion is configured to be mated to the recess with the first layer of the protrusion contacting the second layer of the recess when the second component is assembled in the first component.

20. An assembly as in claim 18,
wherein the multiple second components are formed on a second substrate,
wherein an optoelectronic device is mounted on each second component of the multiple second components,
wherein the multiple second components each comprises an upturn mirror structure, with the upturn mirror structure configured to allow the multiple second components each to be tested in the second substrate.
